SEQUENCE LISTING (129 sequences)

SEQ ID NO: 1 - DNA, 20 bp, Arabidopsis thaliana
tccatctccatgaagctact

SEQ ID NO: 2 - DNA, 20 bp, Arabidopsis thaliana
atgaacgaagaccacaaaac

SEQ ID NO: 3 - DNA, 51 bp, Arabidopsis thaliana
ccatctccatgaagctactgcttctgggtaagttttgtggtcttcgttcat

SEQ ID NO: 4 - DNA, 20 bp, Arabidopsis thaliana
gtgtcaagaaggatttgagc

SEQ ID NO: 5 - DNA, 20 bp, Arabidopsis thaliana
tttctgaagcattttggatt

SEQ ID NO: 6 - DNA, 74 bp, Arabidopsis thaliana
gtgtcaagaaggatttgagccggccttatgggagagttaaccggaaacagctcaaatccaaaatgcttcagaaa

SEQ ID NO: 7 - DNA, 20 bp, Arabidopsis thaliana
tctgaagctggactctctgt

SEQ ID NO: 8 - DNA, 20 bp, Arabidopsis thaliana
aatccatagcctcaaactca

SEQ ID NO: 9 - DNA, 100 bp, Arabidopsis thaliana
tctgaagctggactctctgtttgttccattgatccttctcctaagctcatatggcctaacaattatggagtttgggttgatgagtttgaggctatggatt

SEQ ID NO: 10 - DNA, 20 bp, Arabidopsis thaliana
ggctattgttggtggtggtc

SEQ ID NO: 11 - DNA, 20 bp, Arabidopsis thaliana
tccagcttcagaaacctgct

SEQ ID NO: 12 - DNA, 60 bp, Arabidopsis thaliana
gctattgttggtggtggtcctgctggtttagccgtggctcagcaggtttctgaagctgga

SEQ ID NO: 13 - DNA, 20 bp, Arabidopsis thaliana
caaactccactgtggtctgc

SEQ ID NO: 14 - DNA, 20 bp, Arabidopsis thaliana
aacccagtggcatcaagaac

SEQ ID NO: 15 - DNA, 69 bp, Arabidopsis thaliana
aaactccactgtggtctgcagtgacggtgtaaagattcaggcttccgtggttcttgatgccactgggtt

SEQ ID NO: 16 - DNA, 20 bp, Arabidopsis thaliana
tggtgttcatggattggaga

SEQ ID NO: 17 - DNA, 20 bp, Arabidopsis thaliana
gaacgttgggatcttgctgt

SEQ ID NO: 18 - DNA, 79 bp, Arabidopsis thaliana
tggtgttcatggattggagagacaaacatctggactcatatcctgagctgaagaacggaacagcaagatcccaacgttc

SEQ ID NO: 19 - DNA, 20 bp, Arabidopsis thaliana
ggggatcaatgtgaagagga

SEQ ID NO: 20 - DNA, 20 bp, Arabidopsis thaliana
ccacaacccgttgaggtaag

SEQ ID NO: 21 - DNA, 89 bp, Arabidopsis thaliana
ggggatcaatgtgaagaggattgaggaagacgagcgttgtgtgatcccgatgggcggtcctttaccagtcttacctcaacgggttgtgg

SEQ ID NO: 22 - DNA, 20 bp, Arabidopsis thaliana
gcacccattcaccgagtagt

SEQ ID NO: 23 - DNA, 20 bp, Arabidopsis thaliana
atgttcaacaggtggggaaa

SEQ ID NO: 24 - DNA, 50 bp, Arabidopsis thaliana
gcacccattcaccgagtagtcgaggagacttttccccacctgttgaacat

SEQ ID NO: 25 - DNA, 20 bp, Arabidopsis thaliana
cagtttttgctttgcgttca

SEQ ID NO: 26 - DNA, 20 bp, Arabidopsis thaliana
ctgggcggatttcatctaaa

SEQ ID NO: 27 - DNA, 60 bp, Arabidopsis thaliana
cagtttttgctttgcgttcatttattgaagcctgcaaagatttagatgaaatccgcccag

SEQ ID NO: 28 - DNA, 20 bp, Arabidopsis thaliana
tcaagtgccttctggttgaa

SEQ ID NO: 29 - DNA, 20 bp, Arabidopsis thaliana
agtatgccaagtgccaaagg

SEQ ID NO: 30 - DNA, 70 bp, Arabidopsis thaliana
tcaagtgccttctggttgaagtggttgcaaatgccttttactacaatacccctttggcacttggcatact

SEQ ID NO: 31 - DNA, 20 bp, Arabidopsis thaliana
tcgacactgacaacggtgat

SEQ ID NO: 32 - DNA, 20 bp, Arabidopsis thaliana
ggtactgatggcacggagac

SEQ ID NO: 33 - DNA, 80 bp, Arabidopsis thaliana
tcgacactgacaacggtgatgatgaaactgatgatgctggtgcattggctgcagtgggatgtctccgtgccatcagtacc

SEQ ID NO: 34 - DNA, 20 bp, Arabidopsis thaliana
cgagtctcgtcgatttcctc

SEQ ID NO: 35 - DNA, 20 bp, Arabidopsis thaliana
ttaaagcgaggctaggcaga

SEQ ID NO: 36 - DNA, 91 bp, Arabidopsis thaliana
cgagtctcgtcgatttcctccgggaggagacttgaaattcgtgactttccgattgtgaattccccgatggatctgcctagcctcgctttaa

SEQ ID NO: 37 - DNA, 20 bp, Arabidopsis thaliana
gtctccgtgccatcagtacc

SEQ ID NO: 38 - DNA, 20 bp, Arabidopsis thaliana
agcattttccgcattattgg

SEQ ID NO: 39 - DNA, 100 bp, Arabidopsis thaliana
gtctccgtgccatcagtaccattcttgaatctatcagtagtctccctcatctttatggtcagattgaaccacagttactgccaataatgcggaaaatgct

SEQ ID NO: 40 - DNA, 20 bp, Arabidopsis thaliana
tgtctctgacgacgaggttg

SEQ ID NO: 41 - DNA, 20 bp, Arabidopsis thaliana
cgtcctcttcagcgtcatct

SEQ ID NO: 42 - DNA, 50 bp, Arabidopsis thaliana
tgtctctgacgacgaggttgtccccgtagaagatgacgctgaagaggacg

SEQ ID NO: 43 - DNA, 20 bp, Arabidopsis thaliana
ggagaacgcaaacgtctgtt

SEQ ID NO: 44 - DNA, 20 bp, Arabidopsis thaliana
aagggtgattgcagcatttc

SEQ ID NO: 45 - DNA, 59 bp, Arabidopsis thaliana
ggagaacgcaaacgtctgttgaacatagcaatgcattgcggaaatgctgcaatcaccct

SEQ ID NO: 46 - DNA, 20 bp, Arabidopsis thaliana
aggaaccctcgattcgatct

SEQ ID NO: 47 - DNA, 20 bp, Arabidopsis thaliana
tcgaagctctagccatcgac

SEQ ID NO: 48 - DNA, 69 bp, Arabidopsis thaliana
aggaccctcgattcgatctctcagacgaaatcaggattcgtagaggcgcgtcgatggctagagcttcga

SEQ ID NO: 49 - DNA, 20 bp, Arabidopsis thaliana
ccctcgattcgatctctcag

SEQ ID NO: 50 - DNA, 19 bp, Arabidopsis thaliana
gaagaaacttcccgcttcg

SEQ ID NO: 51 - DNA, 79 bp, Arabidopsis thaliana
cctcgattcgatctctcagacgaaatcaggattcgtagaggcgcgtcgatggctagagctcgaagcgggaagtttcttc

SEQ ID NO: 52 - DNA, 20 bp, Arabidopsis thaliana
cagcaaacgtgagaaggcta

SEQ ID NO: 53 - DNA, 20 bp, Arabidopsis thaliana
tggaagcattttgggagtct

SEQ ID NO: 54 - DNA, 89 bp, Arabidopsis thaliana
cagcaaacgtgagaaggctagactcaaagaaatgcagaagatgaagaagcagaaaattcagcaaatcttagactcccaaaatgcttcca

SEQ ID NO: 55 - DNA, 19 bp, Arabidopsis thaliana
gccgattttgtcctgtcct

SEQ ID NO: 56 - DNA, 20 bp, Arabidopsis thaliana
atgtcgaatttccctgcaac

SEQ ID NO: 57 - DNA, 100 bp, Arabidopsis thaliana
gccgattttgtcctgtcctgcgtgctgtgaaatttctcggtaatcccgaggaaagaagacatattcgtgaagaactgctagttgcagggaaattcgacat

SEQ ID NO: 58 - DNA, 19 bp, Arabidopsis thaliana
agcacagagcctcgccttt

SEQ ID NO: 59 - DNA, 23 bp, Arabidopsis thaliana
ggtgtgcacttttattcaactgg

SEQ ID NO: 60 - DNA, 20 bp, Arabidopsis thaliana
agagaagtggggtggctttt

SEQ ID NO: 61 - DNA, 20 bp, Arabidopsis thaliana
agggcagtgatctccttctg

SEQ ID NO: 62 - DNA, 20 bp, Arabidopsis thaliana
agaggcgtacagggatagca

SEQ ID NO: 63 - DNA, 60 bp, Artificial Sequence
  xMAP bead coding oligonucleotide
tccatctccactttatcaatacatactacaatcactatctttaaactacaaatctaacaa

SEQ ID NO: 64 - DNA, 60 bp, Artificial Sequence
  xMAP bead coding oligonucleotide
tccatctccatacactttatcaaatcttacaatcctatctttaaactacaaatctaacaa

SEQ ID NO: 65 - DNA, 60 bp, Artificial Sequence
  xMAP bead coding oligonucleotide
tccatctccatacattaccaataatcttcaaatcctatctttaaactacaaatctaacaa

SEQ ID NO: 66 - DNA, 60 bp, Artificial Sequence
  xMAP bead coding oligonucleotide
tccatctccatcaacaatcttttacaatcaaatcctatctttaaactacaaatctaacaa

SEQ ID NO: 67 - DNA, 60 bp, Artificial Sequence
  xMAP bead coding oligonucleotide
tccatctccacaattcatttaccaatttaccaatctatctttaaactacaaatctaacaa

SEQ ID NO: 68 - DNA, 60 bp, Artificial Sequence
  xMAP bead coding oligonucleotide
tccatctccaaatccttttacattcattacttacctatctttaaactacaaatctaacaa

SEQ ID NO: 69 - DNA, 60 bp, Artificial Sequence
  xMAP bead coding oligonucleotide
tccatctccataatcttctatatcaacatcttacctatctttaaactacaaatctaacaa

SEQ ID NO: 70 - DNA, 60 bp, Artificial Sequence
  xMAP bead coding oligonucleotide
tccatctccaatcatacatacatacaaatctacactatctttaaactacaaatctaacaa

SEQ ID NO: 71 - DNA, 60 bp, Artificial Sequence
  xMAP bead coding oligonucleotide
tccatctccacaataaactatacttcttcactaactatctttaaactacaaatctaacaa

SEQ ID NO: 72 - DNA, 60 bp, Artificial Sequence
  xMAP bead coding oligonucleotide
tccatctccactactatacatcttactatactttctatctttaaactacaaatctaacaa

SEQ ID NO: 73 - DNA, 60 bp, Artificial Sequence
  xMAP bead coding oligonucleotide
tccatctccaatacttcattcattcatcaattcactatctttaaactacaaatctaacaa

SEQ ID NO: 74 - DNA, 60 bp, Artificial Sequence
  xMAP bead coding oligonucleotide
tccatctccactttaatcctttatcactttatcactatctttaaactacaaatctaacaa

SEQ ID NO: 75 - DNA, 60 bp, Artificial Sequence
  xMAP bead coding oligonucleotide
tccatctccatcaaaatctcaaatactcaaatcactatctttaaactacaaatctaacaa

SEQ ID NO: 76 - DNA, 60 bp, Artificial Sequence
  xMAP bead coding oligonucleotide
tccatctccatcaatcaattacttactcaaatacctatctttaaactacaaatctaacaa

SEQ ID NO: 77 - DNA, 60 bp, Artificial Sequence
  xMAP bead coding oligonucleotide
tccatctccacttttacaatacttcaatacaatcctatctttaaactacaaatctaacaa

SEQ ID NO: 78 - DNA, 60 bp, Artificial Sequence
  xMAP bead coding oligonucleotide
tccatctccaaatcctttctttaatctcaaatcactatctttaaactacaaatctaacaa

SEQ ID NO: 79 - DNA, 60 bp, Artificial Sequence
  xMAP bead coding oligonucleotide
tccatctccaaatcctttttactcaattcaatcactatctttaaactacaaatctaacaa

SEQ ID NO: 80 - DNA, 60 bp, Artificial Sequence
  xMAP bead coding oligonucleotide
tccatctccacttttcaattacttcaaatcttcactatctttaaactacaaatctaacaa

SEQ ID NO: 81 - DNA, 60 bp, Artificial Sequence
  xMAP bead coding oligonucleotide
tccatctccactacaaacaaacaaacattatcaactatctttaaactacaaatctaacaa

SEQ ID NO: 82 - DNA, 60 bp, Artificial Sequence
  xMAP bead coding oligonucleotide
tccatctccatacacaatcttttcattacatcatctatctttaaactacaaatctaacaa

SEQ ID NO: 83 - DNA, 60 bp, Artificial Sequence
  xMAP bead coding oligonucleotide
tccatctccatacatcaacaattcattcaatacactatctttaaactacaaatctaacaa

SEQ ID NO: 84 - DNA, 60 bp, Artificial Sequence
  xMAP bead coding oligonucleotide
tccatctccatcatcaatctttcaatttacttacctatctttaaactacaaatctaacaa

SEQ ID NO: 85 - DNA, 60 bp, Artificial Sequence
  xMAP bead coding oligonucleotide
tccatctccacaatataccaatatcatcatttacctatctttaaactacaaatctaacaa

SEQ ID NO: 86 - DNA, 60 bp, Artificial Sequence
  xMAP bead coding oligonucleotide
tccatctccatcatttcaatcaatcatcaacaatctatctttaaactacaaatctaacaa

SEQ ID NO: 87 - DNA, 60 bp, Artificial Sequence
  xMAP bead coding oligonucleotide
tccatctccactacttcatatactttatactacactatctttaaactacaaatctaacaa

SEQ ID NO: 88 - DNA, 24 bp, Artificial Sequence
  xMAP bead identifier oligonucleotide
tgattgtagtatgtattgataaag

SEQ ID NO: 89 - DNA, 24 bp, Artificial Sequence
  xMAP bead identifier oligonucleotide
gattgtaagatttgataaagtgta

SEQ ID NO: 90 - DNA, 24 bp, Artificial Sequence
  xMAP bead identifier oligonucleotide
gatttgaagattattggtaatgta

SEQ ID NO: 91 - DNA, 24 bp, Artificial Sequence
  xMAP bead identifier oligonucleotide
gatttgattgtaaaagattgttga

SEQ ID NO: 92 - DNA, 24 bp, Artificial Sequence
  xMAP bead identifier oligonucleotide
attggtaaattggtaaatgaattg

SEQ ID NO: 93 - DNA, 24 bp, Artificial Sequence
  xMAP bead identifier oligonucleotide
gtaagtaatgaatgtaaaaggatt

SEQ ID NO: 94 - DNA, 24 bp, Artificial Sequence
  xMAP bead identifier oligonucleotide
gtaagatgttgatatagaagatta

SEQ ID NO: 95 - DNA, 24 bp, Artificial Sequence
  xMAP bead identifier oligonucleotide
tgtagatttgtatgtatgtatgat

SEQ ID NO: 96 - DNA, 24 bp, Artificial Sequence
  xMAP bead identifier oligonucleotide
ttagtgaagaagtatagtttattg

SEQ ID NO: 97 - DNA, 24 bp, Artificial Sequence
  xMAP bead identifier oligonucleotide
aaagtatagtaagatgtatagtag

SEQ ID NO: 98 - DNA, 24 bp, Artificial Sequence
  xMAP bead identifier oligonucleotide
tgaattgatgaatgaatgaagtat

SEQ ID NO: 99 - DNA, 24 bp, Artificial Sequence
  xMAP bead identifier oligonucleotide
tgataaagtgataaaggattaaag

SEQ ID NO: 100 - DNA, 24 bp, Artificial Sequence
  xMAP bead identifier oligonucleotide
tgatttgagtatttgagattttga

SEQ ID NO: 101 - DNA, 24 bp, Artificial Sequence
  xMAP bead identifier oligonucleotide
gtatttgagtaagtaattgattga

SEQ ID NO: 102 - DNA, 24 bp, Artificial Sequence
  xMAP bead identifier oligonucleotide
gattgtattgaagtattgtaaaag

SEQ ID NO: 103 - DNA, 24 bp, Artificial Sequence
  xMAP bead identifier oligonucleotide
tgatttgagattaaagaaaggatt

SEQ ID NO: 104 - DNA, 24 bp, Artificial Sequence
  xMAP bead identifier oligonucleotide
tgattgaattgagtaaaaaggatt

SEQ ID NO: 105 - DNA, 24 bp, Artificial Sequence
  xMAP bead identifier oligonucleotide
tgaagatttgaagtaattgaaaag

SEQ ID NO: 106 - DNA, 24 bp, Artificial Sequence
  xMAP bead identifier oligonucleotide
ttgataatgtttgtttgtttgtag

SEQ ID NO: 107 - DNA, 24 bp, Artificial Sequence
  xMAP bead identifier oligonucleotide
atgatgtaatgaaaagattgtgta

SEQ ID NO: 108 - DNA, 24 bp, Artificial Sequence
  xMAP bead identifier oligonucleotide
tgtattgaatgaattgttgatgta

SEQ ID NO: 109 - DNA, 24 bp, Artificial Sequence
  xMAP bead identifier oligonucleotide
gtaagtaaattgaaagattgatga

SEQ ID NO: 110 - DNA, 24 bp, Artificial Sequence
  xMAP bead identifier oligonucleotide
gtaaatgatgatattggtatattg

SEQ ID NO: 111 - DNA, 24 bp, Artificial Sequence
  xMAP bead identifier oligonucleotide
attgttgatgattgattgaaatga

SEQ ID NO: 112 - DNA, 24 bp, Artificial Sequence
  xMAP bead identifier oligonucleotide
tgtagtataaagtatatgaagtag

SEQ ID NO: 113 - DNA, 24 bp, Artificial Sequence
  xMAP bead detection oligonucleotide
gttagatttgtagtttaaagatag

SEQ ID NO: 114 - DNA, 59 bp, Artificial Sequence
  xMAP bead coding oligonucleotide
tgatgcccctctgctagaatataacatcaacggtactcatcaagaggacgatgttgtca

SEQ ID NO: 115 - DNA, 79 bp, Artificial Sequence
  xMAP bead coding oligonucleotide
ttgatgctgacgaccttgagagacggatgtggaaagatcgtgtcaggcttaaaagaatcaaagagcgacaaaaagctgg

SEQ ID NO: 116 - DNA, 89 bp, Artificial Sequence
  xMAP bead coding oligonucleotide
gtgaaactcggtctgcctaaaagccagagtcctccttaccgaaaacctcatgatctcaagaagatgtggaaggttggagttttaacggc

SEQ ID NO: 117 - DNA, 71 bp, Artificial Sequence
  xMAP bead coding oligonucleotide
actttggatgacgggatttgcagttcaggctttactagcaagtgatccacgcgatgaaacctatgacgtgc

SEQ ID NO: 118 - DNA, 44 bp, Artificial Sequence
  xMAP bead identifier oligonucleotide
tcaacaatcttttacaatcaaatcgaacgttgggatcttgctgt

SEQ ID NO: 119 - DNA, 44 bp, Artificial Sequence
  xMAP bead identifier oligonucleotide
aatccttttacattcattacttacatgttcaacaggtggggaaa

SEQ ID NO: 120 - DNA, 44 bp, Artificial Sequence
  xMAP bead identifier oligonucleotide
ctttaatcctttatcactttatcatcgacaacatcgtcctcttg

SEQ ID NO: 121 - DNA, 44 bp, Artificial Sequence
  xMAP bead identifier oligonucleotide
tcaatcaattacttactcaaatacccagctttttgtcgctcttt

SEQ ID NO: 122 - DNA, 44 bp, Artificial Sequence
  xMAP bead identifier oligonucleotide
cttttacaatacttcaatacaatctgccgttaaaactccaacct

SEQ ID NO: 123 - DNA, 44 bp, Artificial Sequence
  xMAP bead identifier oligonucleotide
cttttcaattacttcaaatcttcagcacgtcataggtttcatcg

SEQ ID NO: 124 - DNA, 52 bp, Artificial Sequence
  xMAP bead detection oligonucleotide
tccgttctttcagctcaggatctcctctatctttaaactacaaatctaacaa

SEQ ID NO: 125 - DNA, 51 bp, Artificial Sequence
  xMAP bead detection oligonucleotide
agtctcctcgactactcggtctcctctatctttaaactacaaatctaacaa

SEQ ID NO: 126 - DNA, 54 bp, Artificial Sequence
  xMAP bead detection oligonucleotide
atgagtaccgttgatgttatattctcctctatctttaaactacaaatctaacaa

SEQ ID NO: 127 - DNA, 52 bp, Artificial Sequence
  xMAP bead detection oligonucleotide
gattcttttaagcctgacacgctcctctatctttaaactacaaatctaacaa

SEQ ID NO: 128 - DNA, 53 bp, Artificial Sequence
  xMAP bead detection oligonucleotide
tccacatcttcttgagatcatgctcctctatctttaaactacaaatctaacaa

SEQ ID NO: 129 - DNA, 52 bp, Artificial Sequence
  xMAP bead detection oligonucleotide
cgtggatcacttgctagtaaactcctctatctttaaactacaaatctaacaa

(19) United States
(12) Patent Application Publication
(10) Pub. No.: US 2010/0075858 A1
(43) Pub. Date: Mar. 25, 2010

(54) BIOLOGICAL BAR CODE

(75) Inventors: James C. DAVIS, Plymouth, MA (US); Mitchell D. EGGERS, Pearland, TX (US); Rafael IBARRA, San Diego, CA (US); John SADLER, Belmont, CA (US); David WONG, San Marcos, CA (US); Syrus M. JAFFE, Carlsbad, CA (US); Michael SAGHBINI, Poway, CA (US); Michael HOGAN, Tucson, AZ (US)

Correspondence Address: COOLEY GODWARD KRONISH LLP;ATTN: Patent Group, Suite 1100, 777 - 6th Street, NW, WASHINGTON, DC, 20001, US

(73) Assignee: GENVAULT CORPORATION, Carlsbad, CA (US)

(21) Appl. No.: 12/471,321

(22) Filed: May 22, 2009

Related U.S. Application Data
(63) Continuation-in-part of application No. 10/836,119, filed on Apr. 29, 2004.
Application No. 10/836,119 is a continuation-in-part of application No. 10/426,940, filed on Apr. 29, 2003, now abandoned.

(51) Int. Cl. C40B 20/04; C40B 40/06; C40B 50/08

(52) U.S. Cl. 506/4; 506/16; 506/27

(57) ABSTRACT

The invention provides coding compositions comprising mixtures of coding oligonucleotides and methods of using such compositions to code samples. The compositions and methods are useful for identifying, verifying, or authenticating any type of sample, whether the sample is biological or non-biological.

This application claims priority to application Ser. No. 10/836,119, filed Apr. 29, 2004, which claims priority to application Ser. No. 10/426,940, filed Apr. 29, 2003, now abandoned, both of which are incorporated by reference in this application.

### TECHNICAL FIELD

The present invention relates to compositions and methods of identifying samples to ensure their validity, authenticity or accuracy, and more particularly to bar-coded samples and archives, methods of bar-coding samples, and methods of identifying, validating, and authenticating bar-coded samples in which the coding may be done with biological molecules, modified forms or derivatives thereof.

### BACKGROUND OF THE INVENTION

Identification of anonymized DNA samples from human patients can be difficult if the samples are in liquid form and are subject to error during handling. Many other biological and non-biological samples can be confused or subject to identification error. Barcode labels on tubes or containers offer only partial solution of the identification problem as they can fall off, be obscured, removed or otherwise rendered unreadable. Furthermore, such barcode labels are easily counterfeited. A nucleic acid sample offers a built in identification code but is only useful if the identity information for that nucleic acid is at hand or can be obtained. Long, unique, oligonucleotide sequences have been added to samples as a means of identification but this requires that a unique sequence be synthesized for each and every sample and costly sequencing analysis to identify the oligonucleotide sequences. Accordingly, there remains a need for relatively inexpensive means for labeling samples that are difficult to counterfeit.

### SUMMARY OF THE INVENTION

The present invention is based, in part, on the discovery that oligonucleotides can be used to code samples (e.g., biological or non-biological samples) and other objects in a manner that is extremely difficult to counterfeit or decode without knowing, a priori, specific structural characteristics of the oligonucleotides used to construct the code.

Accordingly, in one aspect, the present invention provides coding compositions for coding a sample. In certain embodiments, the coding composition comprises a subset of coding oligonucleotides from a predetermined pool of coding oligonucleotides, wherein the combination of coding oligonucleotides in the coding composition represents the presence and absence of oligonucleotides from said pool and such representation constitutes a code.

In certain embodiments, each coding oligonucleotide in a predetermined pool or subset thereof comprises a unique identifier sequence. In certain embodiments, the unique identifier sequence is about 15 to about 30 nucleotides in length. In certain embodiments, the identifier sequences of the coding oligonucleotides in the predetermined pool all have similar annealing temperatures.

In certain embodiments, each coding oligonucleotide in a predetermined pool or subset thereof comprises a unique identifier sequence and a detection sequence different from the unique identifier sequence. In certain embodiments, the coding oligonucleotides of the predetermined pool or a subset thereof comprise the same detection sequence. In certain embodiments, the detection sequence is about 15 to about 30 nucleotides in length. In certain embodiments, the coding oligonucleotides further comprise a linker sequence that physically connects the unique identifier sequence to the detection sequence.

In certain embodiments, each coding oligonucleotide in a predetermined pool or subset thereof further comprises a 5′ leader sequence, wherein the 5′ leader sequence is not part of a unique identifier sequence or a detection sequence. In certain embodiments, the coding oligonucleotides of the predetermined pool or a subset thereof comprise the same 5′ leader sequence. In certain embodiments, each coding oligonucleotide in a predeterminded pool or subset thereof comprises a primer hybridization sequence or a pair of primer hybridization sequences.

In certain embodiments, coding oligonucleotides of the invention have a length of about 20 to about 100 bases, or about 30 to about 70 bases. In certain embodiments, coding oligonucleotides are physically or chemically different from each other. For example, in certain embodiments, coding oligonucleotides within a set, such as a predetermined pool, a subset thereof, a first oligonucleotide set, etc., have the same length but different sequences. In other embodiments, coding oligonucleotides within a set, such as a predetermined pool, a subset thereof, a first oligonucleotide set, etc., are different in length and sequence.

In certain embodiments, coding oligonucleotides of the invention comprise naturally occurring sequences. In certain embodiments, the sequence of each coding oligonucleotide in a predetermined pool or subset thereof is non-naturally occurring. In certain embodiments, coding oligonucleotides of the invention comprise one or more modified bases. For example, in certain embodiments, the bases have been modified to incorporate a detectable label or to increase stability.

In certain embodiments, the number of coding oligonucleotides in the predetermined pool is equal to or greater than 5, 6, 7, 8, 9, 10, 15, 20, 25, 30, 35, 40, 45, 50, 60, 70, 80, 90, or 100. In certain embodiments, the number of coding oligonucleotides in the subset is 1 to 5, 5 to 10, 10 to 15, 15 to 20, 20 to 25, 25 to 30, 30 to 40, 40 to 50, 50 to 75, 75 to 100, or more. In certain embodiments, the number of coding oligonucleotides in the subset is less than the number of coding oligonucleotides in the predetermined pool.

In certain embodiments, a coding composition of the invention comprises two or more coding oligonucleotides from a predetermined pool of coding oligonucleotides, wherein the two or more coding oligonucleotides are denoted a first oligonucleotide set. In certain embodiments, the first oligonucleotide set includes coding oligonucleotides each having a physical or chemical difference from the other coding oligonucleotides of the first oligonucleotide set. In certain embodiments, the difference is in oligonucleotide length. In other embodiments, the difference is in identifier sequences (i.e., each coding oligonucleotide of the first oligonucleotide set has a different identifier sequence). In certain embodiments, the first oligonucleotide set includes coding oligonucleotides each having a physical or chemical similarity to the other coding oligonucleotides of the first oligonucleotide set. In certain embodiments, the similarity is an ability to specifically hybridizing to a unique primer pair denoted a first primer set. In other embodiments, the similarity is an ability to specifically hybridize to the same detection oligonucleotide.

In other embodiments, a coding composition of the invention comprises two or more coding oligonucleotides from a predetermined pool of coding oligonucleotides, wherein the two or more coding oligonucleotides belong to two or more oligonucleotide sets. Accordingly, in certain embodiments, the coding composition comprises one or more coding oligonucleotides denoted a first oligonucleotide set and one or more coding oligonucleotides denoted a second oligonucleotide set. In certain embodiments, the second oligonucleotide set includes coding oligonucleotides each having a physical or chemical difference from the other coding oligonucleotides of the second oligonucleotide set. In certain embodiments, the difference is in oligonucleotide length. In other embodiments, the difference is in identifier sequences (i.e., each coding oligonucleotide of the second oligonucleotide set has a different identifier sequence). In certain embodiments, the second oligonucleotide set includes coding oligonucleotides each having a physical or chemical similarity to the other coding oligonucleotides of the second oligonucleotide set. In certain embodiments, the similarity is an ability to specifically hybridizing to a unique primer pair denoted a second primer set. In other embodiments, the similarity is an ability to specifically hybridize to the same detection oligonucleotide.

In other related embodiments, one or more coding oligonucleotides from additional sets are added to the one or more coding oligonucleotides of the first and second oligonucleotide sets. For example, in certain embodiments, the coding composition comprises one or more coding oligonucleotides denoted a third, fourth, fifth, sixth, etc. oligonucleotide set. In certain embodiments, the coding oligonucleotides of the third, fourth, fifth, sixth, etc. oligonucleotide set each have a physical or chemical difference from the other coding oligonucleotides of the same oligonucleotide set. In certain embodiments, the difference is in oligonucleotide length. In other embodiments, the difference is in identifier sequences (i.e., each coding oligonucleotide of a given set has a different identifier sequence). In certain embodiments, the coding oligonucleotides of the third, fourth, fifth, sixth, etc. oligonucleotide set each have a physical or chemical similarity to the other coding oligonucleotides of the same oligonucleotide set. In certain embodiments, the similarity is an ability to specifically hybridizing to a unique primer pair denoted a third, fourth, fifth, sixth, etc. primer set. In other embodiments, the similarity is an ability to specifically hybridize to the same detection oligonucleotide.

In certain embodiments, an oligonucleotide of the first, second, third, fourth, fifth, sixth, etc., oligonucleotide set has the same length or a different length as compared to an oligonucleotide of another set. In certain embodiments, an oligonucleotide of the first second third, fourth, fifth, sixth, etc. oligonucleotide set has the same or different identifier sequence as compared to an oligonucleotide of another set. In certain embodiments, an oligonucleotide of the first second third, fourth, fifth, sixth, etc. oligonucleotide set has the same or different detection sequence as compared to an oligonucleotide of another set.

In other embodiments, a coding composition of the invention further comprises one or more identifier oligonucleotides. For example, in certain embodiments, a coding composition can comprise all of the identifier oligonucleotides necessary to read the code. In other embodiments, a coding composition of the invention further comprises one or more detection oligonucleotides. For example, in certain embodiments, a coding composition can comprise all of the detection oligonucleotides necessary to read the code. In other embodiments, a coding composition of the invention further comprises one or more identifier oligonucleotides and one or more detection oligonucleotides. For example, in certain embodiments, a coding composition can comprise all of the identifier and detection oligonucleotides necessary to read the code.

In still other embodiments, a coding composition of the invention further comprises one or more unique primer pairs. For example, in certain embodiments, each coding oligonucleotide in a first, second, third, fourth, fifth, sixth, etc. oligonucleotide set comprises sequence capable of specifically hybridizing to a unique primer pair denoted a first, second, third, fourth, fifth, or sixth, etc. primer set, respectively. In certain embodiments, each coding oligonucleotide in a first oligonucleotide set comprises sequence capable of specifically hybridizing to a unique primer pair denoted a first primer set, but does not comprise sequence capable of specifically hybridizing to a second, third, fourth, fifth, or sixth, etc. primer set; each coding oligonucleotide in a second oligonucleotide set comprises sequence capable of specifically hybridizing to a unique primer pair denoted a second primer set, but does not comprise sequence capable of specifically hybridizing to a first, third, fourth, fifth, or sixth, etc. primer set; etc.

In certain embodiments, coding compositions of the invention further comprise a preservative, such as a nuclease inhibitor, EDTA, EGTA, guanidine thiocyanate, uric acid, or nucleic acid binding proteins, such as single-stranded DNA or RNA binding proteins.

In another aspect, the invention provides coded compositions. In certain embodiments, a coded composition of the invention comprises any coding composition described herein. For example, in certain embodiments, a coded composition comprises a subset of coding oligonucleotides (e.g., a subset of coding oligonucleotides from a predetermined pool of coding oligonucleotides) and a sample. In certain embodiments, the sample is a biological sample, such as a nucleic acid and/or protein containing sample. Examples of biological sample include, but are not limited to, tissue samples, forensic samples, or bodily fluids, such as blood, plasma, serum, sputum, semen, urine, mucus, cerebrospinal fluid, stool, mouth swab, mouth rinse, lavage, etc, or a fraction thereof, such as isolated nucleic acid or protein. In other embodiments, the sample is a non-biological sample, such as a document, piece of art, recording medium, electronic device, mechanical or musical instrument, precious stone or metal, or dangerous device, such as a weapon.

In certain embodiments, the coding composition is mixed with, added to, or imbedded within a sample. In certain embodiments, the coding oligonucleotides of the coded composition are physically separable from the sample. In preferred embodiments, the coding oligonucleotides of the coded composition do not specifically hybridize to the sample. For example, in certain embodiments, the coding oligonucleotides do not specifically hybridize to a biological sample with which they are mixed.

In certain embodiments, coded compositions of the invention comprise a preservative, such as a nuclease inhibitor, EDTA, EGTA, guanidine thiocyanate, uric acid, or nucleic acid binding proteins, such as single-stranded DNA binding proteins.

In another aspect, the invention provides containers comprising a coding composition or a coded composition of the invention. In certain embodiments, the container is a tube, bottle, sealable vessel, or well, such as a well in a multi-well plate. In certain embodiments, the container comprises a sample node, wherein the sample node is removably or reversibly attached to the container. In certain embodiments, the sample node comprises a sample support medium. In certain embodiments, the sample support medium is porous. In certain embodiments, the sample support medium comprises paper, an elastomeric foam, nanoparticle matrices, or chemical storage matrices. In certain embodiments, the sample node and/or sample support medium is suitable for dry state storage of biological samples or molecules such as nucleic acids and/or proteins. In certain embodiments, the sample node and/or sample support medium is suitable for long-term storage of biological samples or molecules such as nucleic acids and/or proteins. In certain embodiments, the coding composition or coded composition is carried by (e.g., absorbed into, surrounded by, or bound to the surface of) the sample support medium. In other embodiments, a coding composition or coded composition of the invention is present in an organic or aqueous solution having one or more phases, a slurry, a paracrystalline matrix, or a solid (e.g., a porous solid). In certain embodiments, the solution is compatible with one or more methods of analyzing biological samples, such as polymerase chain reaction (PCR) or a hybridization reaction (e.g., hybridization to a microarray or other type of addressable solid support).

In another aspect, the invention provides coded storage packages. In certain embodiments, the coded storage package comprises a container comprising a coding composition of the invention. In certain embodiments, the coded storage package further comprises an identifying indicia. In certain embodiments, the identifying indicia identifies the code corresponding to the coding composition located in the container. In other embodiments, the identifying indicia provides information that can be used to identify the code corresponding to the coding composition located in the container. In certain embodiments, the identifying indicia is attached to the container.

In certain embodiments, the coded storage package comprises a plurality of containers, wherein each container comprises a coding composition of the invention. For example, in certain embodiments, the coded storage package comprises a multi-well plate and each of said plurality of containers corresponds to a single well in the multi-well plate. In certain embodiments, each container in said plurality comprises the same coding composition. In other embodiments, at least some of the containers in said plurality comprise different coding compositions (i.e., coding compositions corresponding to different codes). For example, in certain embodiments, the plurality of containers is divided into two or more groups, wherein each container within the same group comprises the same coding composition and containers in different groups comprise different coding compositions. In certain embodiments, the coded storage package further comprises an identifying indicia attached to at least one of said plurality of containers. In certain embodiments, the identifying indicia is attached to all of said containers. For example, in certain embodiments, the coded storage package comprises a multi-well plate and the identifying indicia is attached to the multi-well plate (e.g., a side, bottom, or top surface of the multi-well plate). In certain embodiments, the identifying indicia identifies the code corresponding to the coding composition located in one or more of said plurality of containers. In other embodiments, the identifying indicia provides information that can be used to identify the code corresponding to the coding composition located in one or more of said plurality of containers.

In certain embodiments, the coded storage package further comprises a sample. In certain embodiments, the sample is a biological sample. In other embodiments, the sample is a non-biological sample. In certain embodiments, the sample is located in one or more containers of said coded storage package. In certain embodiments, the sample is carried by a sample node removably or reversibly attached to one of said containers. For example, in certain embodiments, the sample node comprises a sample support medium and the sample is carried by (e.g., absorbed into, surrounded by, or bound to the surface of) the sample support medium.

In another aspect, the invention provides kits. In certain embodiments, the kit comprises a container comprising a coding composition of the invention. In certain embodiments, the kit comprises a coded storage package.

In certain embodiments, the kit further comprises an identifying indicia, wherein said identifying indicia identifies the code corresponding to the coding composition located in a container of said kit or in one or more containers of a coded storage package of said kit. In certain embodiments, the kit further comprises a set of identifier oligonucleotides, wherein said set of identifier oligonucleotides can be used in decoding a coding composition of the invention (e.g., a coding composition contained in a container of said kit or in one or more containers of a coded storage package of said kit). In certain embodiments, the kit father comprises at least one detection oligonucleotide, wherein said at least one detection oligonucleotide can be used in decoding a coding composition of the invention (e.g., a coding composition contained in a container of said kit or in one or more containers of a coded storage package of said kit). In certain embodiments, the kit further comprises a set of identifier oligonucleotides and at least one detection oligonucleotide. In certain embodiments, the kit further comprises an instruction that provides how to use the contents of the kit to encode (e.g., biological samples or non-biological samples) using coding compositions of the invention and/or decode samples using, e.g., identifier and detection oligonucleotides.

In another aspect, the invention also provides methods for coding a sample. In certain embodiments, the method comprises adding a sample to a coding composition of the invention, or vice versa. For example, in certain embodiments, the method comprises adding a sample to a subset of coding oligonucleotides from a predetermined pool of coding oligonucleotides, wherein the combination of coding oligonucleotides represents the presence and absence of oligonucleotides from said pool and such representation constitutes a code. In certain embodiments, the coding composition is carried by a sample node (e.g., by a sample support medium) prior to said addition, and the sample is then applied to the sample node (e.g., sample support medium). In certain embodiments, the methods for coding a sample further comprise selecting a subset of coding oligonucleotides from a predetermined pool of coding oligonucleotides and combining the selected coding oligonucleotides to form a coding composition prior to the addition of the sample. For example, in certain embodiments, the selected coding oligonucleotides are applied (e.g., sequentially or as a mixture) to a sample node in a container and, subsequently, the sample is applied to the sample node.

In another aspect, the invention provides samples coded according to the methods of the invention. In certain embodiments, the samples are biological samples. In other embodiments, the samples are non-biological samples. In certain embodiments, the coded samples are stored in an archive. Thus, in certain embodiments, the invention provides archives of samples coded with one or more coding compositions of the invention. In certain embodiments, an archive of the invention comprises one or more containers or coding packages of the invention, wherein the coded samples are stored in the one or more containers or coding packages. In certain embodiments, the sample stored in the archive are in a dry state.

In another aspect, the invention provides methods of decoding a sample coded with a coding composition of the invention. In certain embodiments, the methods of decoding comprise detecting in a coded sample one or more coding oligonucleotides from a predetermined pool of coding nucleotides, wherein the sample is coded with a subset of coding oligonucleotides from said predetermined pool, wherein the coding oligonucleotides of the predetermined pool are distinguishable from one another, and wherein a collective result of the presence and absence of said one or more coding oligonucleotides from said predetermined pool is indicative of the code associated with the sample. In certain embodiments, the methods comprise detecting in the sample the presence or absence of each coding oligonucleotide in the predetermined pool. In certain embodiments, the methods further comprise determining the code associated with the sample based upon said detecting one or more (or each) coding oligonucleotide of the predetermined pool.

In certain embodiments, the detecting step comprises contacting each of said one or more coding oligonucleotides with a corresponding identifier oligonucleotide. In certain embodiments, each of the corresponding identifier oligonucleotides are bound or bindable to an addressable array. In certain embodiments, the addressable array is a microarray. In other embodiments, the addressable array comprises a set of beads, such as fluorescently labeled beads. In certain embodiments, the detecting step further comprises contacting each of said one or more coding oligonucleotides with a detection oligonucleotide. In certain embodiments, the detection oligonucleotide is labeled. In other embodiments, the detection oligonucleotide specifically hybridizes to a labeled oligonucleotide or a signal amplification assembly. Thus, in certain embodiments, the detecting step comprises detecting a label associated with the detection oligonucleotide. In other embodiments, the detection step comprises detecting a label incorporated into each of the one or more coding oligonucleotides.

In certain embodiments, the detecting step comprises contacting each of said one or more coding oligonucleotides with a corresponding primer or primer pair. In certain embodiments, said contacting each of said one or more coding oligonucleotides with a corresponding primer or primer pair is followed by PCR. In certain embodiments, detection of the coding oligonucleotides is based upon their ability to be amplified by a particular primer or primer pair and/or their length.

In yet another aspect, the invention provides addressable arrays suitable for decoding samples coded with a coding composition of the invention. In certain embodiments, an addressable array of the invention comprises a set of identifier oligonucleotides, wherein each identifier oligonucleotide in the set is capable of specifically binding to one coding oligonucleotide in a predetermined pool of coding oligonucleotides. In certain embodiments, the addressable array is a microarray. In certain embodiments, each oligonucleotide in the set of identifier oligonucleotides is located at one or more predetermined positions on said microarray. In other embodiments, the addressable array is a set of beads, such as fluorescently labeled beads. In certain embodiments, each bead in the set of beads comprises identifier oligonucleotides all having the same sequence, such that there is a one-to-one correspondence between beads and identifier oligonucleotides. In certain embodiments, detecting an interaction between an addressable array of the invention and one or more coding oligonucleotide from a coding composition of the invention comprises detecting a signal, such as a fluorescence signal, emitted from a particular portion of the addressable array.

### BRIEF DESCRIPTION OF THE DRAWINGS

FIG. 1 illustrates exemplary codes following size-based fractionation of amplified oligonucleotides. The code in FIG. 1A is 534523151 or, in binary form, 10100 01000 10010 00101 10001; the code in FIG. 1B is 530523151 or, in binary form, 10100 00000 10010 00101 10001. Lanes are as follows: 1, a ladder of 5 oligonucleotides with lengths of 60, 70, 80, 90, and 100 nucleotides; 2, primer set #1 amplified oligonucleotides; 3, primer set #2 amplified oligonucleotides; 4, primer set #3 amplified oligonucleotides; 5, primer set #4 amplified oligonucleotides; 6, primer set #5 amplified oligonucleotides.

FIG. 2 is a simplified diagram illustrating a code generated following size-based fractionation via gel electrophoresis and indicating a convention for reading the code. FIG. 2B illustrates the binary code read in accordance with the convention indicated in FIG. 2A.

FIG. 3 is a simplified diagram illustrating one embodiment of a sample carrier. FIG. 3B illustrates exemplary codes associated with bio-tags maintained at different locations on the sample carrier of FIG. 3A.

FIG. 4 is a simplified flow diagram illustrating the general operation of one embodiment of a method of producing a bio-tag for use in identifying a sample.

FIG. 5 is a simplified flow diagram illustrating the general operation of one embodiment of a method of applying a bio-tag to a sample carrier.

FIG. 6 is photograph of an agarose gel showing size-based separation of coding oligonucleotides following PCR amplification, as described in Example 2 for 50, 75, and 100 by coding oligonucleotides.

FIG. 7 is a photograph of an agarose gel showing size-based separation of coding oligonucleotides following PCR amplification, as described in Example 2 for 50, 60, 70, 80, 90, and 100 by coding oligonucleotides.

FIG. 8 is a photograph of an agarose gel showing size-based separation of coding oligonucleotides following PCR amplification, as described in Example 2 for 50, 75, and 100 by coding oligonucleotides. The template used in the different lanes of FIG. 8 included no template (control), FTA™ paper containing human blood either with or without coding oligonucleotides, and IsoCode™ page containing human blood either with or without coding oligonucleotides.

FIG. 9 is a photograph of a polyacrylamide gel showing size-based separation of coding oligonucleotides following PCR amplification, as described in Example 2 for 50, 60, 70, 80, 90, and 100 by coding oligonucleotides from Set #2.

FIG. 10 is a photograph of a polyacrylamide gel showing size-based separation of coding oligonucleotides following PCR amplification, as described in Example 2 for 50, 60, 70, 80, 90, and 100 by coding oligonucleotides from Set #3.

FIG. 11 is a photograph of an agarose gel showing size-based separation of b-actin sequences PCR amplified from blood samples that had been applied to matrices, as described in Example 4.

FIG. 12 is a series of diagrams showing different ways that coding oligonucleotides having an identifier sequence can be specifically identified and detected. In FIG. 12A, the coding oligonucleotide contains both an identifier sequence and a detection sequence; the identifier sequence hybridizes to an identifier oligonucleotide linked to an addressable array and the detection sequence hybridizes to a detection oligonucleotide. In the embodiment shown, the detection oligonucleotide has a 5′ leader sequence that allows the coding oligonucleotide to be directly labeled via the incorporation of labeled nucleotides in a primer extension reaction. FIG. 12B is an embodiment similar to that of FIG. 12A, except that the detection oligonucleotide is labeled, thereby eliminating the need to label the coding oligonucleotide. In FIG. 12C, the detection oligonucleotide is labeled and also has a 5′ extension that allows it to hybridize with a labeling oligonucleotide, resulting in signal amplification. In FIG. 12 D the identifier sequence hybridizes to an identifier oligonucleotide, which hybridizes in turn to secondary identifier oligonucleotide linked to an addressable array. The detection sequence hybridizes to a detection oligonucleotide, which hybridizes, in turn, to a labeling oligonucleotide. FIG. 12E is an embodiment similar to 12D, except that the detection oligonucleotide is labeled and therefore doesn't require a labeling oligonucleotide.

FIG. 13 shows the results of decoding different coding oligonucleotide combinations, chosen from a set of 25 coding oligonucleotides, using xMAP beads capable of identifying the entire set of coding oligonucleotides. A 5′ biotin labeled detection oligonucleotide was used for detection, as per FIG. 12B. When the identifier oligonucleotide of a particular xMAP bead corresponded (i.e., was complementary) to the identifier sequence of the coding oligonucleotide, strong fluorescence was observed. When the identifier oligonucleotide did not correspond to the identifier sequence of a coding oligonucleotide, background fluorescence was observed. All the coding oligonucleotide combinations were adequately decoded.

FIG. 14 shows the results of decoding a mixture of 6 coding oligonucleotides using xMAP beads capable of identifying the entire set of 25 coding oligonucleotides, as per FIG. 13, by means of identifier oligonucleotides, secondary identifier oligonucleotides, detection oligonucleotides, and labeling oligonucleotides, as per FIG. 12D. Strong fluorescence was observed only for the 6 coding oligonucleotides used to create the coding mixture. xMAP beads corresponding to the rest of the coding oligonucleotides showed background fluorescence.

### DETAILED DESCRIPTION

The invention is based, in part, on compositions comprising oligonucleotides that are physically or chemically different from each other (e.g., in their length and/or sequence), and that are in a unique combination. Adding to or mixing a unique combination of oligonucleotides with a given sample, i.e., coding the sample, allows the sample to be identified based upon the combination of oligonucleotides added or mixed. By determining the oligonucleotide combination (the “code” or “bio-tag”) in a query sample and comparing the oligonucleotide combination to oligonucleotide combinations known to identify particular samples (e.g., a database of known oligonucleotide combinations that identify samples), the query sample is thereby identified. Thus, where it is desired to identify, verify or authenticate a sample, a unique combination of oligonucleotides can be added to or mixed with the sample (to “code” or “tag” the sample), and the sample can subsequently be identified, verified or authenticated based upon the particular unique combination of oligonucleotides present in the sample.

Accordingly, in one aspect, the present invention provides coding compositions for coding a sample. In certain embodiments, the coding compositions comprise a subset of coding oligonucleotides from a predetermined pool of coding oligonucleotides. The combination of coding oligonucleotides in a coding composition represents the presence and absence of oligonucleotides from the predetermined pool of coding oligonucleotides and such representation constitutes a code.

Oligonucleotides suitable for use as coding oligonucleotides of the invention can have a wide range of different sequences. In general, though, coding oligonucleotides of the invention are (i) physically or chemically different from other coding oligonucleotides in the relevant predetermined pool, and (ii) specifically detectable when mixed with or applied to a relevant sample. Because oligonucleotide may interact with different samples in different ways, oligonucleotides suitable for use as coding oligonucleotides will depend upon the nature of the sample being coded. Likewise, the set of coding oligonucleotides that make up a predetermined pool will depend upon the nature of the sample being coded, as well as the other coding oligonucleotides in the pool, and should be selected accordingly.

As used herein, the term “physically or chemically different,” and grammatical variations thereof, when used in reference to coding oligonucleotides, means that the coding oligonucleotides have physical or chemical characteristic that allow them to be distinguished from other coding oligonucleotides in the relevant predetermined pool of coding oligonucleotides or subset thereof. In other words, the coding oligonucleotides each have a physical and/or chemical characteristic that allows them to be specifically identified when they are present in a mixture with the other coding oligonucleotides. One particular example of such a characteristic is oligonucleotide length. Another particular example of such a characteristic is oligonucleotide sequence. Additional examples of characteristics that allow oligonucleotides to be distinguished from each other, which may in part be influenced by oligonucleotide length or sequence, include charge, solubility, diffusion rate, and absorption. Still more examples of characteristics include modifications as set forth herein, such as molecular beacons, radioisotopes, fluorescent moieties, and other labels. As discussed, when developing the code, sequencing of the oligonucleotides is not required.

As used herein, the term “specifically detectable,” when referring to coding oligonucleotides, means that the presence of the coding oligonucleotides can be affirmatively established. For example, after coding oligonucleotides have been mixed with or applied to a sample, they are specifically detectable if there are no other nucleic acid sequences present in the sample that are sufficiently similar to the coding oligonucleotides to prevent an accurate assessment of the presence or absence of the coding oligonucleotides.

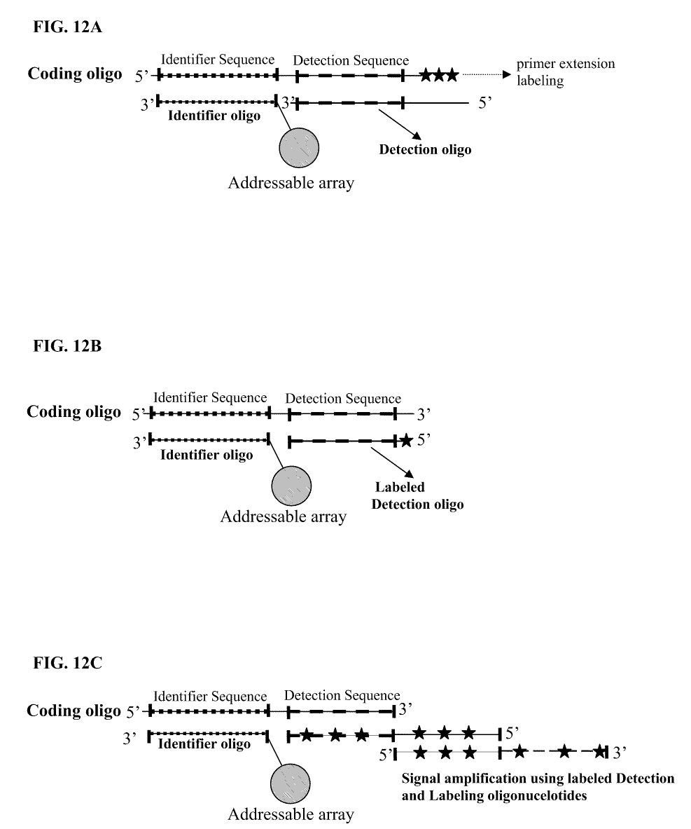

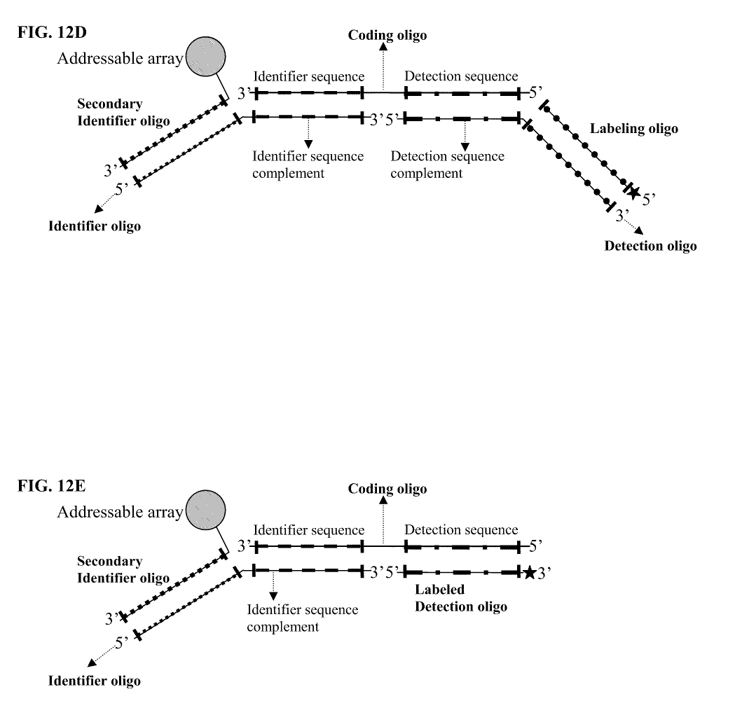

In certain embodiments, coding oligonucleotides of the invention comprise an identifier sequence. As used herein, an “identifier sequence” is a sequence that can assist in the identification of a coding oligonucleotide after it has been mixed with or applied to a sample. The identification will typically comprise a specific binding interaction, such as specific hybridization, between the identifier sequence and a complementary identifier oligonucleotide. Identification can further comprise a specific binding interaction, such as specific hybridization, between the identifier oligonucleotide and a secondary identifier oligonucleotide (e.g., as illustrated in FIGS. 12 D,E). The term “specific hybridization,” when used in reference to oligonucleotide sequences means that the hybridization is selective between the oligonucleotide sequence and the complementary sequence. In other words, the oligonucleotide sequence and the complementary sequence preferentially bind to one another over other nucleic acid sequences that may be present (e.g., other nucleic acids that are part of a coded sample) to the extent that the presence (or absence) of a coding oligonucleotide comprising the oligonucleotide sequence can be affirmatively and reliably established based on the interaction between the oligonucleotide sequence and its complementary sequence. In general, any sequence allowing for specific hybridization (e.g., within the context of a particular predetermined pool of coding oligonucleotides and/or a particular sample to be coded), is suitable as an identifier sequence for the coding oligonucleotides of the invention.

In certain embodiments, the identifier sequence of each coding oligonucleotide in a predetermined pool of coding oligonucleotides is unique. In other words, there is a one-to-one correspondence between coding oligonucleotides in the predetermined pool of coding oligonucleotides and their associated unique identifier sequences. When coding oligonucleotides comprise unique identifier sequences, the identifier sequences are sufficient to distinguish the coding oligonucleotides from other coding oligonucleotides in the same predetermined pool. Unique identifier sequences suitable for use in the coding oligonucleotides of the invention are well-known in the art and include, for example, FlexMAP™ sequences, Illumina VeraCode™ sequences, and Osmetech eSensor™ sequences. Thus, in certain embodiments, the unique identifier sequences are FlexMAP™ sequences. In other embodiments, the unique identifier sequences are Illumina VeraCode™ sequences. In still other embodiments, the unique identifier sequences are Osmetech eSensor™ sequences.

In other embodiments, the identifier sequence of each coding oligonucleotide in a predetermined pool of coding oligonucleotides is not unique. For example, two or more coding oligonucleotides in a predetermined pool may contain the same, otherwise unique identifier sequence. In such embodiments, there will be another characteristic that, either independently or in combination with the identifier sequence, allows the coding oligonucleotides of the predetermined pool to be distinguished from one another. The additional characteristic can be, for example, oligonucleotide length or a unique combination of identifier and detection sequences.

In certain embodiments, the annealing temperatures corresponding to the identifier sequences of coding oligonucleotides from a predetermined pool of coding oligonucleotides are all within the same range. For example, the annealing temperatures can be all around the same temperature. Suitable annealing temperatures for the identifier sequences are between about 25° C. to about 70° C., about 30° C. to about 60° C., about 35° C. to about 45° C., or about 37° C. Accordingly, in certain embodiments, the annealing temperatures corresponding to the identifier sequences of the coding oligonucleotides from a predetermined pool of coding oligonucleotides, or subset thereof, are all between about 25° C. to about 35° C., about 30° C. to about 40° C., about 35° C. to about 45° C., about 40° C. to about 50° C., or about 45° C. to about 55° C. In other embodiments, the annealing temperatures are all between about 30° C. to about 35° C., about 35° C. to about 40° C., about 40° C. to about 45° C., about 45° C. to about 50° C., or about 50° C. to about 55° C.

In certain embodiments, the identifier sequence is about 10 to about 40, about 15 to about 35, about 20 to about 30 bases in length. In certain embodiments, the identifier sequence has a length of 20, 21, 22, 23, 24, 25, 26, 27, 28, 29, or 30 bases.

In certain embodiments, the coding oligonucleotides of the invention comprise a detection sequence. As used herein, a “detection sequence” is a sequence that can assist in the detection of a coding oligonucleotide after it has been mixed with or applied to a sample. The detection will typically comprise a specific binding interaction, such as specific hybridization between the detection sequence and a detection oligonucleotide. Detection can further comprise a specific binding interaction, such as specific hybridization, between the detection oligonucleotide and a secondary detection oligonucleotide (e.g., a signalling oligonucleotide, as illustrated in FIGS. 12 C,D). In general, any sequence allowing for specific hybridization (e.g., within the context of a particular predetermined pool of coding oligonucleotides and/or a particular sample to be coded), is suitable as an detection sequence for the coding oligonucleotides of the invention. Detection sequences suitable for use in the coding oligonucleotides of the invention include, for example, FlexMAP™ sequences, Illumina VeraCode™ sequences, and Osmetech eSensor™ sequences.

In certain embodiments, the detection sequence of each coding oligonucleotide in a predetermined pool of coding oligonucleotides is the same. For example, when coding oligonucleotides comprise a single, common detection sequence, a single detection oligonucleotide can be used to detect all of the coding oligonucleotides in the predetermined pool or any subset thereof. The use of a detection sequence common to each coding oligonucleotide of a predetermined pool necessitates that there be some other distinguishing characteristic of the coding oligonucleotides that allow them to be distinguished. Accordingly, in certain embodiments, the coding oligonucleotides of the invention comprise both an identifier sequence (e.g., a unique identifier sequence) and a detection sequence. Thus, as illustrated in FIG. 12 and set forth in Example 8, identifier sequences and detection sequences can be linked to one another in individual coding oligonucleotides. By using the same general type of sequences for the identifier and detection sequences, such as FlexMAP™, VeraCode™, or eSensor™ sequences, hybridization specificity of the identifier and detection sequences can be ensured.

In certain embodiments, the detection sequences in two or more coding oligonucleotides in a predetermined pool of coding oligonucleotides are different. For example, the predetermined pool of coding oligonucleotides can be divided into different sets wherein the coding oligonucleotides with one set have the same detection sequence, while coding oligonucleotides from different sets have different detection sequences. Use of the same detection sequence in subsets of the coding oligonucleotides can allow different parts of the code to have different functions. Thus, part of the code having oligonucleotides comprising a first detection sequence can be used as a sample identifier, while another part of the code having oligonucleotides comprising a second detection sequence can be used as a source identifier. For example, the source identifier can represent a hospital, military unit, prison, etc. where a sample was collected, while the sample identifier can represent a person in the hospital, military unit, prison, etc. that the sample (e.g., a biological sample) was obtained from. Alternatively, the source identifier can represent a particular storage plate or portion thereof.

In certain embodiments the different detection sequences in two or more coding oligonucleotides in a predetermined pool of coding oligonucleotides can be detected by a common secondary detection oligonucleotide by mean of indirect binding to the detection sequences (e.g. via specific sandwich hybridization involving the detection oligonucleotides, as illustrated in FIG. 12D).

In certain embodiments, the annealing temperatures corresponding to the detection sequences of coding oligonucleotides from a predetermined pool of coding oligonucleotides are all within the same range. For example, the annealing temperatures can be all around the same temperature. In certain embodiments, the annealing temperatures corresponding to the detection sequences of coding oligonucleotides from a predetermined pool of coding oligonucleotides are all within the same range as identifier sequences also present in the coding oligonucleotides. Suitable annealing temperatures for the detection sequences are as discussed above for identifier sequences.

In certain embodiments, the detection sequence is about 10 to about 40, about 15 to about 35, about 20 to about 30 bases in length. In certain embodiments, the detection sequence has a length of 20, 21, 22, 23, 24, 25, 26, 27, 28, 29, or 30 bases.

In certain embodiments, the coding oligonucleotides of the invention comprise an identifier sequence, a detection sequence, and a linker that physically connects the identifier and detection sequences. In certain embodiments, the linker is a nucleic acid sequence. For example, the linker can be a nucleic acid sequence having a length of 1, 2, 3, 4, 5, 6, 7, 8, 9, 10, or more bases. In other embodiments, the linker is a non-nucleic acid sequence, such as a C3 spacer (phosphoramidite), a Photo-Cleavable spacer (a 10-atom spacer arm which can be cleaved by exposure to UV light in the 300-350 nm range), spacer 9 (triethylene glycol), spacer 18 (hexa-ethyleneglycol), and 1′,2′ dideoxyribose. Such spacers are known in the art and are available, e.g., from Integrated DNA Technologies.

In general, the arrangement of the identifier and detection sequences is not critical. Thus, for example, the detection sequence can be linked to the 3′ end of the identifier sequence. Alternatively, the identifier sequence can be linked to the 3′ end of the detection sequence. For non-nucleic acid linkers, other linkage arrangements are also possible.

In certain embodiments, the coding oligonucleotides of the invention comprise an identifier sequence and a detection sequence, wherein the identifier and detection sequences are adjacent to one another. As used herein, in this context, the term “adjacent” means that the identifier and detection sequences are directly connected with one another, with no linker in between (e.g., as shown in FIG. 12 and Example 8). Again, the arrangement of the identifier and detection sequences is not critical. Thus, for example, the detection sequence can be located 3′ to the end of the identifier sequence. Alternatively, the identifier sequence can be located 3′ to the end of the detection sequence.

In certain embodiments, the coding oligonucleotides of the invention further comprise a 5′ leader sequence. In general, the 5′ leader sequence is separate from other defined sequences in the coding oligonucleotide (e.g., hybridizing sequences). In certain embodiments, the 5′ leader sequence is 1, 2, 3, 4, 5, 6, 7, 8, 9, 10, or more bases. One advantage to having a 5′ leader sequence is that it separates hybridizing sequences (e.g., an identifier or detection sequence or a primer hybridization sequence) from the 5′ end of the oligo, thus getting around the problem of n−1 type oligo synthesis failure and ensuring that the hybridizing sequences are completely intact. As a result, coding oligonucleotides comprising a 5′ leader sequence do not need to be purified after synthesis and can be used to code samples in unpurified form. Although not required, the 5′ leader sequence is typically the same for each coding oligonucleotide of a predetermined pool.

In certain embodiments, the coding oligonucleotides comprise one or more (e.g., a pair of) primer hybridization sequences. Characteristics of such hybridization sequences are discussed further below.

In certain embodiments, coding oligonucleotides of the invention lack secondary structure that would otherwise interfere with reading out the code. For example, in certain embodiments, the coding oligonucleotides lack secondary structure that would interfere with hybridization to an identifier oligonucleotide, a detection oligonucleotide, and/or a primer.

As discussed above, in general, coding oligonucleotides are physically or chemically different from each other (e.g., they differ in length and/or sequence). For example, coding oligonucleotides within a set (e.g., a predetermined pool, a subset thereof, a first oligonucleotide set, etc.) can have the same length but different sequences. Alternatively, coding oligonucleotides within a set (e.g., a predetermined pool, a subset thereof, a first oligonucleotide set, etc.) can be different in length and sequence. Coding oligonucleotides that differ in length can differ, e.g., by at least 1, 2, 3, 4, 5, 6, 7, 8, 9, 10, or more bases in length. Coding oligonucleotides that differ in sequence can have some sequence homology or identity (e.g., one or more portions of the coding oligonucleotides can be identical in sequence), providing that the coding oligonucleotides remain distinguishable from one another. Coding oligonucleotides that differ in sequence can have, e.g., different identifier sequences, the same or different detection sequences, the same or different primer hybridization sequences, the same or different leader sequences, the same or different linker sequences, etc

In certain embodiments, coding oligonucleotides have a length from about 10 to about 5000 bases, about 20 to about 3000 bases, about 30 to about 1000 bases, about 32 to about 500 bases, about 34 to about 250 bases, about 36 to about 200 bases, about 38 to about 150 bases, about 40 to about 100 bases, about 42 to about 90 bases, about 44 to about 85 bases, about 46 to about 80 bases, about 48 to about 75 bases, about 50 to about 70 bases, about 52 to about 68 bases, about 54 to about 66 bases, about 56 to about 64, about 58 to about 62, or about 60 bases. In certain embodiments, all of the coding oligonucleotides in a predetermined pool have about the same length. For example, in certain embodiments, the coding oligonucleotides in a predetermined pool all have a length of about 40 to about 45 bases, about 45 to about 50 bases, about 50 to about 55 bases, about 55 to about 60 bases, about 60 to about 65 bases, about 65 to about 70 bases, about 70 to about 75 bases, or about 75 to about 80 bases.

Although typically described herein as single-stranded, coding oligonucleotides of the invention can be single, double or triple strand deoxyribonucleic acid (DNA) or ribonucleic acid (RNA). Accordingly, any description herein referring to one form of nucleic acid, such as single-stranded, is intended to encompass the other forms as well, unless the context indicates otherwise. In certain embodiments, coding oligonucleotides of the invention have a non-naturally occurring sequence. As used herein, a “non-naturally occurring sequence” is a sequence that, in its entirety, is not found in nature. Thus, although fragments of the sequence may be found in nature, such fragments will be juxtaposed in a manner that creates a non-naturally occurring sequence. In other embodiments, coding oligonucleotides of the invention have a naturally occurring sequence.

As used herein, the terms “oligonucleotide,” “oligo,” “nucleic acid,” “polynucleotide,” “primer,” and “gene” include linear oligomers of natural or modified monomers or linkages, including deoxyribonucleotides, ribonucleotides, and α-anomeric forms thereof capable of specifically hybridizing to a target sequence by way of a regular pattern of monomer-to-monomer interactions, such as Watson-Crick type of base pairing, base stacking, Hoogsteen or reverse Hoogsteen types of base pairing. Monomers are typically linked by phosphodiester bonds or analogs thereof to form the polynucleotides. Oligonucleotides can be a synthetic oligomer, a sense or antisense, circular or linear, single, double or triple strand DNA or RNA. Whenever an oligonucleotide is represented by a sequence of letters, such as “ATGCCTG,” the nucleotides are in a 5′ to 3′ orientation from left to right.

Essentially any polymer that has a unique sequence can be used for the code, provided the polymer is detectable and can be distinguished from other polymers present in the code. Polymers include organic polymers or alkyl chains identified by spectroscopy, e.g., NMR and FT-IR. Polymers include one or more amino acids attached thereto, for example, peptides derivatized with ninhydrin or opthaldehyde, which can be detected with a fluorometer. Polymers further include peptide nucleic acid (PNA), which refers to a nucleic acid mimic, e.g., DNA mimic, in which the deoxyribose phosphate backbone is replaced by a pseudopeptide backbone while retaining the natural nucleotides.

In certain embodiments, the coding oligonucleotides comprise one or more modified bases. Such modified bases can serve a variety of purposes. For example, in certain embodiments, the modified bases comprise a label. Labeled bases can be used, e.g., to detect coding oligonucleotides. In other embodiments, the modified bases exhibit improved hybridization characteristics (e.g., linked nucleic acids (LNA)). In still other embodiments, the modified bases increase the stability of the coding oligonucleotides. For example, the modification can result in decreased nuclease degradation.

Coding oligonucleotides therefore include moieties which have all or a portion similar to naturally occurring oligonucleotides but which are non-naturally occurring. For example, coding oligonucleotides may have one or more altered sugar moieties or inter-sugar linkages. Particular examples include phosphorothioate and other sulfur-containing species known in the art. One or more phosphodiester bonds of the oligonucleotide can be substituted with a structure that enhances stability of the oligonucleotide. Particular non-limiting examples of such substitutions include phosphorothioate bonds, phosphotriesters, methyl phosphonate bonds, short chain alkyl or cycloalkyl structures, short chain heteroatomic or heterocyclic structures and morpholino structures (U.S. Pat. No. 5,034,506). Additional linkages include those disclosed in U.S. Pat. Nos. 5,223,618 and 5,378,825.

Accordingly, coding oligonucleotides can include nucleotides that are naturally occurring, synthetic, or combinations thereof. Naturally occurring bases include adenine, guanine, cytosine, thymine, uracil and inosine. Particular non-limiting examples of synthetic bases include xanthine, hypoxanthine, 2-aminoadenine, 6-methyl, 2-propyl and other alkyl adenines, 5-halo uracil, 5-halo cytosine, 6-aza cytosine and 6-aza thymine, pseudo uracil, 4-thiouracil, 8-halo adenine, 8-aminoadenine, 8-thiol adenine, 8-thioalkyl adenines, 8-hydroxyl adenine and other 8-substituted adenines, 8-halo guanines, 8-amino guanine, 8-thiol guanine, 8-thioalkyl guanines, 8-hydroxyl guanine and other substituted guanines, other aza and deaza adenines, other aza and deaza guanines, 5-trifluoromethyl uracil, 5-trifluoro cytosine and tritylated bases.

Coding oligonucleotides can include one or more nucleotides that have been labeled. The labeled nucleotides can be located at the 5′ end, 3′ end, or at one or more internal positions, or any combination thereof. Examples of suitable labels include, but are not limited to, biotin, digoxigenin, and fluorescent dyes. Examples of fluorescent dyes include, but are not limited to, 5-Fluorescein (FITC), 6-Carboxyfluorescein (FAM), Rhodamine Green, 6-tetrachlorofluorescein (TET), CAL Fluor Gold 540, JOE, 6-Hexachlorofluorescein (HEX), CAL Fluor Orange 560, Cy3, TAMRA, Rhodamin ITC, 5(6)-Carboxy-X-Rhodamine (ROX), Texas Red, Cal Fluor Red 610, Cy5, Cy5.5, IRD 700, IRD 800, Cy2, Cy7, WellRED-D2, WellRED-D3, and WellRED-D4.

Coding oligonucleotides can be made nuclease resistant during or following synthesis in order to preserve the code. Coding oligonucleotides can be modified at the base moiety, sugar moiety or phosphate backbone to improve stability, hybridization, or solubility of the molecule. For example, the 5′ end of the oligonucleotide may be rendered nuclease resistant by including one or more modified internucleotide linkages (see, e.g., U.S. Pat. No. 5,691,146). Coding oligonucleotides can have their 3′ end blocked to prevent extension by polymerases to ensure no interference with PCR-based analysis of a coded biological sample that comprises nucleic acid.

The deoxyribose phosphate backbone of coding oligonucleotides can be modified to generate peptide nucleic acids (PNAs) or linked peptide nucleic acids (LNAs). See, e.g., Hyrup et al., Bioorg. Med. Chem. 4:5 (1996); U.S. Pat. No. 6,441,130. The neutral backbone of PNAs allows specific hybridization to DNA and RNA under conditions of low ionic strength. The synthesis of PNA oligomers can be performed using standard solid phase peptide synthesis protocols (see, e.g., Perry-O'Keefe et al., Proc. Natl. Acad. Sci. USA 93:14670 (1996)). PNAs hybridize to complementary DNA and RNA sequences in a sequence-dependent manner, following Watson-Crick hydrogen bonding. PNA-DNA hybridization is more sensitive to base mismatches; PNA can maintain sequence discrimination up to the level of a single mismatch (Ray and Bengt, FASEB J. 14:1041 (2000)). Due to the higher sequence specificity of PNA hybridization, incorporation of a mismatch in the duplex considerably affects the thermal melting temperature. PNA can also be modified to include a label, and the labeled PNA included in the code or used as a primer or probe to detect the labeled PNA in the code. For example, a PNA light-up probe in which the asymmetric cyanine dye thiazole orange (TO) has been tethered. When the light-up PNA hybridizes to a target, the dye binds and becomes fluorescent (Svavnik et al., Analytical Biochem. 281:26 (2000)).

Coding oligonucleotides can also include phosphate backbone modifications such as found in locked nucleic acids (LNAs). See, e.g., Kaur et al., Biochemistry 45 (23): 7347-55 (2006); You et al., Nucleic Acids Res. 34 (8): e60 (2006). The ribose moiety of an LNA nucleotide is modified with an extra bridge connecting the 2′ and 4′ carbons. The bridge “locks” the ribose in the 3′-endo structural conformation, which is often found in the A-form of DNA or RNA. LNA nucleotides can be mixed with DNA or RNA bases in the oligonucleotide whenever desired. The locked ribose conformation enhances base stacking and backbone pre-organization, significantly increasing the thermal stability (melting temperature) of oligonucleotides that comprise such bases.

The number of coding oligonucleotides that may be selected from for producing a coding composition of the invention (i.e., the predetermined pool) may be large enough to account for coding potentially large numbers of samples. Alternatively, the number of coding oligonucleotides in the predetermined pool can be increased as the number of samples coded increases. For example, where there are few samples to be coded, 2 unique oligonucleotides provide 4 unique codes (2²), e.g., in binary form, 00, 01, 10, 11; for 3 unique oligonucleotides 8 unique codes are available (2³), e.g., in binary form, 000, 001, 010, 100, 011, 110, 101, 111; for 4 unique oligonucleotides 16 unique codes are available (2⁴); for 5 unique oligonucleotides 32 unique codes are available (2⁵). To expand the number of available codes, one need only increase the number of different oligonucleotides. For example, for 6 unique oligonucleotides 64 unique codes are available (2⁶); for 7 unique oligonucleotides 128 unique codes are available (2⁷); for 8 unique oligonucleotides there are 256 codes available; for 9 unique oligonucleotides there are 512 codes available; for 10 unique oligonucleotides there are 1,024 codes available; for 11 unique oligonucleotides there are 2,048 codes available; for 12 unique oligonucleotides there are 4,096 codes available; for 13 unique oligonucleotides there are 8,192 codes available; for 14 unique oligonucleotides there are 16,384 codes available; for 15 unique oligonucleotides there are 32,768 codes available; for 16 unique oligonucleotides there are 65,536 codes available; for 17 unique oligonucleotides there are 131,072 codes available; for 18 unique oligonucleotides there are 262,144 codes available; for 19 unique oligonucleotides there are 524,288 codes available; for 20 unique oligonucleotides there are 1,048,576 codes available; for 21 unique oligonucleotides there are 2,097,152 codes available; for 22 unique oligonucleotides there are 4,194,304 codes available; for 23 unique oligonucleotides there are 8,388,608 codes available; for 24 unique oligonucleotides there are 16,777,216 codes available; for 25 unique oligonucleotides there are 33,554,432 codes available; etc. Thus, where the number of samples exceeds the available codes, where there are an unknown number of samples to be coded, or where it is desired that the number of codes available be in excess of the projected number of samples, additional different oligonucleotides may be added to the oligonucleotide pool from which the oligonucleotides are selected for the code, or the coding may employ an initially large number of different oligonucleotides in order to provide an unlimited number of unique oligonucleotide combinations and, therefore, unique codes. For example, 30 different oligonucleotides provides over one billion unique codes (1,073,741,824 to be precise).

Accordingly, in certain embodiments, the number of coding oligonucleotides in the predetermined pool is equal to or greater than 5, 6, 7, 8, 9, 10, 15, 20, 25, 30, 35, 40, 45, 50, 60, 70, 80, 90, or 100. In certain related embodiments, the number of coding oligonucleotides in a coding composition of the invention (e.g., a subset of coding oligonucleotides from a predetermined pool of coding oligonucleotides) is 1 to 5, 5 to 10, 10 to 15, 15 to 20, 20 to 25, 25 to 30, 30 to 40, 40 to 50, 50 to 75, 75 to 100, or more. In certain embodiments, the number of coding oligonucleotides in the subset is less than the number of coding oligonucleotides in the predetermined pool. For example, in certain embodiments, the number of coding oligonucleotides in the subset is an integer number between 1 and n−1, where n is the number of coding oligonucleotides in the predetermined pool.

In certain embodiments, the invention provides compositions including two or more coding oligonucleotides from a predetermined pool of coding oligonucleotides, wherein the coding oligonucleotides are denoted a first oligonucleotide set. The first oligonucleotide set can include coding oligonucleotides having a length from about 8 to 50 Kb nucleotides, wherein coding oligonucleotides of the first oligonucleotide set each have a physical or chemical difference (e.g., a different length and/or sequence) from the other oligonucleotides comprising the first oligonucleotide set, and wherein coding oligonucleotides of the first oligonucleotide set each having a different sequence therein capable of specifically hybridizing to a unique primer pair denoted a first primer set. In certain embodiments, coding oligonucleotides of the first oligonucleotide set are in a unique combination allowing identification of the sample. In certain embodiments, the two oligonucleotides are denoted A and B, and the composition includes A with or without B, or B alone; the three oligonucleotides are denoted A through C and the composition includes A with or without B or C, B with or without A or C, or C with or without A or B; the four oligonucleotides are denoted A through D and the composition includes A with or without B or C or D, B with or without A or C or D, C with or without A or B or D, or D with or without A or B or C; the five oligonucleotides are denoted A through E and the compositions includes A with or without B or C or D or E, B with or without A or C or D or E, C with or without A or B or D or E, D with or without A or B or C or E, or E with or without A or B or C or D; the six oligonucleotides are denoted A through F and the composition includes A with or without B or C or D or E or F, B with or without A or C or D or E or F, C with or without A or B or D or E or F, D with or without A or B or C or E or F, E with or without A or B or C or D or F, or F with or without A or B or C or D or E; the seven oligonucleotides are denoted A through G and the composition includes A with or without B or C or D or E or F or G, B with or without A or C or D or E or F or G, C with or without A or B or D or E or F or G, D with or without A or B or C or E or F or G, E with or without A or B or C or D or F or G, F with or without A or B or C or D or E or G, or G with or without A or B or C or D or E or F. In yet further aspects, the first oligonucleotide set includes a unique combination of two to five, five to ten, 10 to 15, 15 to 20, to 25, 25 to 30, 30 to 40, 40 to 50, 50 to 100, or more coding oligonucleotides.

In accordance with the invention there are further provided compositions including multiple oligonucleotide sets. In one embodiment, the composition comprises coding oligonucleotides denoted a first oligonucleotide set and coding oligonucleotides denoted a second oligonucleotide set, wherein coding oligonucleotides of the first set each have a physical or chemical difference (e.g., a different length and/or sequence) from the other coding oligonucleotides of the first oligonucleotide set, wherein the coding oligonucleotides of the first oligonucleotide set each have a sequence therein capable of specifically hybridizing to a unique primer pair denoted a first primer set; wherein coding oligonucleotides of the second oligonucleotide set each have a physical or chemical difference (e.g., a different length and/or sequence) from other coding oligonucleotides of the second oligonucleotide set, and wherein the coding oligonucleotides of the second oligonucleotide set each having a sequence therein capable of specifically hybridizing to a unique primer pair denoted a second primer set.

In another embodiment, coding compositions of the invention include two oligonucleotide sets and a third oligonucleotide set, wherein the third oligonucleotide set includes coding oligonucleotides each having a physical or chemical difference (e.g., a different length and/or sequence) from the other coding oligonucleotides of the third oligonucleotide set, and wherein each coding oligonucleotide of the third oligonucleotide set has a sequence therein capable of specifically hybridizing to a unique primer pair denoted a third primer set.

In a further embodiment, coding compositions of the invention include three oligonucleotide sets and a fourth oligonucleotide set, wherein the fourth oligonucleotide set includes coding oligonucleotides each having a physical or chemical difference (e.g., a different length and/or sequence) from the other coding oligonucleotides of the fourth oligonucleotide set, and wherein each coding oligonucleotide of the fourth oligonucleotide set has a sequence therein capable of specifically hybridizing to a unique primer pair denoted a fourth primer set.

In an additional embodiment, coding compositions of the invention include four oligonucleotide sets and a fifth oligonucleotide set, wherein the fifth oligonucleotide set includes coding oligonucleotides each having a physical or chemical difference (e.g., a different length and/or sequence) from the other coding oligonucleotides of the fifth oligonucleotide set, and wherein each coding oligonucleotide of the fifth oligonucleotide set has a sequence therein capable of specifically hybridizing to a unique primer pair denoted a fifth primer set. In various embodiment, the coding compositions of the invention including multiple oligonucleotide sets, wherein one or more coding oligonucleotides of the second, third, fourth, fifth, sixth, etc., oligonucleotide set has a physical or chemical characteristic that is the same as one or more oligonucleotides of any other oligonucleotide set (e.g., an identical nucleotide length or hybridization sequence).

Coding compositions of the invention can further comprise one or more identifier oligonucleotides, one or more decoding oligonucleotides, or both. For example, in certain embodiments, a coding composition can comprise all of the identifier oligonucleotides necessary to read the code (e.g., an identifier oligonucleotide corresponding to each coding oligonucleotide in the predetermined pool, or an appropriate subset thereof for the coding composition to be decoded). In certain embodiments, a coding composition can comprise all of the detection oligonucleotides and, optionally, secondary detection oligonucleotides (e.g., signaling oligonucleotides), necessary to read the code. In still other embodiments, a coding composition can comprise all of the identifier and detection oligonucleotides and, optionally, secondary detection oligonucleotides (e.g., signaling oligonucleotides), necessary to read the code. Coding compositions of the invention can further comprise one or more primer pairs.

Coding compositions of the invention can include components or agents that increase stability or inhibit degradation of the oligonucleotides, such as preservatives. In certain embodiments, the preservative is EDTA, EGTA, guanidine thiocyanate, uric acid, or a combination thereof. In other embodiments, single-stranded coding oligonucleotides can be mixed single-strand binding proteins (e.g., when tagging liquid samples).

In another aspect, the invention provides coded compositions (i.e., compositions comprising a sample and any coding composition described herein). For example, in certain embodiments, a coded composition of the invention comprises a subset of coding oligonucleotides (e.g., a subset of coding oligonucleotides from a predetermined pool of coding oligonucleotides) and a sample. Preferably, the coding oligonucleotides of the subset do not specifically hybridize to the sample.

As used herein, the term “sample” means any physical entity, which is capable of being coded (bio-tagged) in accordance with the invention. Samples therefore include any material which is capable of having a code associated with the sample. A sample therefore may include non-biological and biological samples as well as samples suitable for introduction into a biological system, such as prescription or over-the-counter medicines (e.g., pharmaceuticals), cosmetics, perfume, foods or beverages.

Specific non-limiting examples of non-biological samples include documents, such as letters, commercial paper, bonds, stock certificates, contracts, evidentiary documents, testamentary devices (e.g., wills, codicils, trusts); identification or certification means, such as birth certificates, licensing certificates, signature cards, driver's licenses, identification cards, social security cards, immigration status cards, passports, fingerprints; negotiable instruments, such as currency, credit cards, or debit cards. Additional non-limiting examples of non-biological samples include wearable garments such as clothing and shoes; containers, such as bottles (plastic or glass), boxes, crates, capsules, ampoules; labels, such as authenticity labels or trademarks; artwork such as paintings, sculpture, rugs and tapestries, photographs, books; collectibles or historical or cultural artifacts; recording medium such as analog or digital storage medium or devices (e.g., videocassette, CD, DVD, DV, MP3, cell phones); electronic devices such as, instruments; jewelry such as rings, watches, bracelets, earrings and necklaces; precious stones or metals such as diamonds, gold, platinum; and dangerous devices, such as firearms, ammunition, explosives or any composition suitable for preparing explosives or an explosive device.

Specific non-limiting examples of biological samples include foods, such as meat (e.g., beef, pork, lamb, fowl or fish), grains and vegetables; and alcohol or non-alcoholic beverages, such as wine. Non-limiting examples of biological samples also include tissues and whole organs or samples thereof, forensic samples and biological fluids such as blood (blood banks), plasma, serum, saliva, mouth rinse, mouth swab, lavages, sputum, semen, urine, mucus, stool and cerebrospinal fluid. Additional non-limiting examples of biological samples include living and non-living cells (e.g., blood cells, such as red or white blood cells), eggs (e.g., fertilized or unfertilized) and sperm (e.g., animal husbandry or breeding samples), as well as extracts thereof, such as tissue homogenates or cellular lysates (e.g., blood cell lysates, bacterial lysates, plant cell lysates, etc.), nucleic acid extracts (e.g., isolated RNA or DNA), or protein extracts. Further non-limiting examples of biological samples include microorganisms (e.g., bacteria, yeast, mycoplasma, etc.), parasites, viruses, and other pathogens (e.g., smallpox, anthrax), as well as lysates, homogenates, or extracts thereof.

Samples that comprise nucleic acid include mammalian (e.g., human), plant, bacterial, viral, archaea and fungi (e.g., yeast) nucleic acid. As discussed herein, oligonucleotides used to code such nucleic acid samples do not specifically hybridize to the nucleic acid sample to the extent that the hybridization interferes with developing the code and analyzing the tagged sample's nucleic acid. In addition, if the sample comprising nucleic acid is derived from humans, livestock, poultry, fish corn, rice, wheat, and other entities consumed or used by humans, the coding oligonucleotides typically do not specifically hybridize to nucleic acid of pathogens associated with said samples to the extent that the hybridization interferes with detecting and identifying the pathogen nucleic acid. Thus, for example, where the sample is human nucleic acid, the coding oligonucleotides typically do not specifically hybridize to the human nucleic acid or the nucleic acid of human pathogens; where the sample is plant nucleic acid, the coding oligonucleotides typically do not specifically hybridize to the plant nucleic acid or the nucleic acid of plant pathogens; where the sample is livestock nucleic acid, the coding oligonucleotides typically do not specifically hybridize to the livestock nucleic acid or the nucleic acid of livestock pathogens; where the sample is bacterial nucleic acid, the coding oligonucleotides typically do not specifically hybridize to the bacterial nucleic acid; where the sample is viral nucleic acid, the coding oligonucleotides typically do not specifically hybridize to the viral nucleic acid, etc.

The association between the code and the sample is any physical relationship in which the code is able to uniquely identify the sample. The code may therefore be attached to, integrated within, impregnated with, mixed with, or in any other way associated with the sample. The association does not require physical contact between the code and the sample. Rather, the association is such that that the sample is identified by the code, whether the sample and code physically contact each other or not. For example, a code may be attached to a container (e.g., a label on the outside surface of a vial) which contains the sample within. A code can be associated with product packaging within which is the actual sample. A code can be attached to a housing or other structure that contains or otherwise has some association with the sample such that the code is capable of uniquely identifying the sample, without the code actually physically contacting the sample. The code and sample therefore do not need to physically contact each other, but need only have a relationship where the code is capable of identifying the sample.

Coding oligonucleotides can be added to or mixed with the sample and the mixture can be a solid, semi-solid, liquid, slurry, dried or desiccated, e.g., freeze-dried. Coding oligonucleotides can be relatively separable or inseparable from the sample. For example, where the oligonucleotides are mixed with a sample that is a biological sample such as nucleic acid, the oligonucleotides are separable from the sample using a molecular biological or, biochemical or biophysical technique, such as size- or affinity based electrophoresis, column chromatography, hybridization, differential elution, etc.

As set forth herein, coding oligonucleotides can be in a relationship with the sample such that they are easily physically separable from the sample. In the example of a substrate, one or more of the coding oligonucleotides can be easily physically separable from the sample, under conditions where the sample remains substantially attached to the substrate. For example, when the coding oligonucleotides are affixed to a dry solid medium (e.g., a Guthrie card) and the sample is likewise affixed to the same dry solid medium, the two may be affixed at different positions on the medium. By knowing the position of the oligonucleotides or sample, they can be easily physically separated by removing a section of the substrate to which the oligonucleotides or sample are attached (e.g., a punch). In another example, the oligonucleotides may be dispensed in a well of a multi-well plate (e.g., 96 well plate), with other wells of the plate containing sample(s). The oligonucleotides are physically separated from the sample by retrieving them from the well (e.g., with a pipette) into which they were dispensed. In either case, whether oligonucleotides of the code physically contact the sample, or the oligonucleotides of the code are associated with but do not physically contact the sample, the oligonucleotides can be identified in order to develop the code. Thus, the invention is not limited with respect to the nature of the association between the oligonucleotides of the code and the sample that is coded.

In preferred embodiments, coding oligonucleotides of the invention are incapable of specifically hybridizing to a sample. As used herein, the term “incapable of specifically hybridizing to a sample” and grammatical variants thereof, when used in reference to a coding oligonucleotide (or identifier oligonucleotide, detection oligonucleotide, or primer), means that the oligonucleotide (or identifier oligonucleotide, detection oligonucleotide, or primer) does not specifically hybridize to the sample (e.g., a nucleic acid sample) to the extent that any non-specific hybridization occurring between one or more coding oligonucleotides (or identifier oligonucleotides, detection oligonucleotides, or primers) and the nucleic acid sample does not interfere with developing the code. Thus, for example, where a sample is human nucleic acid, typically all or a part of the coding oligonucleotide sequence will be non-human and, optionally, different from that of any human pathogens, such that any non-specific hybridization occurring between one or more coding oligonucleotides and the human nucleic acid does not interfere with oligonucleotide detection/identification, i.e., identifying the code. In certain embodiments, coding oligonucleotides incapable of specifically hybridizing to a sample also do not interfere with analysis of the human nucleic acid (e.g., by PCR) and/or detection of human pathogen nucleic acid.

Accordingly, coding oligonucleotides and identifier oligonucleotides, detection oligonucleotides, or primers that specifically hybridize to each other can be entirely non-complementary to a sample that is nucleic acid, or have some complementarity, provided that any hybridization occurring between the oligonucleotides or identifier oligonucleotides, detection oligonucleotides, or primers and the nucleic acid sample does not interfere with developing the code. Similarly, coding oligonucleotides and identifier oligonucleotides, detection oligonucleotides, or primers that specifically hybridize to each other can be entirely non-complementary to pathogens associated with a sample, or have some complementarity, provided that any hybridization occurring between the oligonucleotides or identifier oligonucleotides, detection oligonucleotides, or primers and the nucleic acid sample does not interfere with developing the code. It is therefore intended that the meaning of “incapable of specifically hybridizing to a sample” used herein includes situations where an oligonucleotide or identifier oligonucleotide, detection oligonucleotide, or primer specifically hybridizes to a sample such hybridization does not interfere with developing the code, analyzing the sample's nucleic acid, and/or detecting pathogen nucleic acid associated with the sample, if applicable. “Incapable of specifically hybridizing” also can be used to refer to the absence of specific hybridization among the different coding oligonucleotides used to code or tag the sample, among identifier oligonucleotides, detection oligonucleotides, or primers used to develop the code, and between identifier oligonucleotides, detection oligonucleotides, or primers and non-target oligonucleotides, to the extent that even if some hybridization occurs, the hybridization does not prevent the code from being developed.

In addition, when there is nucleic acid present in the sample that is ancillary to the sample, that is, for a protein sample or any other non-nucleic acid sample in which nucleic acid happens to be present but is not the sample that is coded, a coding oligonucleotide or identifier oligonucleotide, detection oligonucleotide, or primer may also specifically hybridize to the nucleic acid provided that the hybridization with the nucleic acid sample does not interfere with developing the code. With regard to primers, because the size of any amplified product produced will not have the expected size of the oligonucleotide, such hybridization will rarely if ever interfere with developing the code. Furthermore, in a situation where there is nucleic acid ancillary to the sample, typically the amount of primer(s) is in excess of the nucleic acid such that no interference with developing the code occurs. As for identifier and detection oligonucleotides, solid supports (e.g., beads) and/or labels attached to such oligonucleotides will typically get around the problem of the sample nucleic acid interfering with developing the code.

In particular embodiments of the invention, the coding oligonucleotide or identifier oligonucleotides, detection oligonucleotides, or primers will have less than about 40-50% homology with a sample that is nucleic acid. Similarly, in particular embodiments of the invention, the coding oligonucleotide or identifier oligonucleotides, detection oligonucleotides, or primers will have less than about 40-50% homology with the nucleic acid of any pathogens in said sample, if applicable. In additional specific embodiments, the coding oligonucleotide will have less that about 0.5-50% homology, e.g., 45%, 40%, 35%, 30%, 25%, 20%, 15%, 10%, 5%, 3%, or less homology with a sample that is nucleic acid and/or the nucleic acid of pathogens of said sample, if applicable.

In another aspect, the invention provides containers comprising a coding composition or a coded composition of the invention. The container can be any container into which a coding composition or a coded composition can be placed, including, for example, a tube, bottle, sealable vessel, or well (e.g., a well in a multi-well plate). The container can comprise a sample node (e.g., a discrete sample node). Coding compositions or coded compositions of the invention can be carried by (e.g., absorbed into, surrounded by, or bound to the surface of) such a sample node. In general, a sample node will be removably or reversibly attached to the container. In other words, the sample node can be a physical object that is stably attached to, but separate from, the container such that some sort of force is required to disrupt the attachment and remove the sample node from the container. For example, the attachment between the sample node and container can consist of a compression fitting. The force needed to break such an attachment may be a mechanical force sufficient to overcome the frictional resistance associated with the compression fitting. Alternatively, the force needed to break the attachment may be a mechanical force sufficient to break a seal in the container and/or push the sample node through a membrane or film in the container. Accordingly, in certain embodiments, the container can be a sample carrier that comprises one or more discrete sample nodes, such as described in U.S. Application 2003/0087425, U.S. Application 2003/0087455, and U.S. Application 2004/0101966. Other forms of stable attachment between the sample node and container may be a non-covalent interaction, such as the type that forms when the water in a solution or suspension evaporates and the solutes and/or particles that remain behind become attached to a surface of a container. The force needed to break this type of non-covalent interaction may involve redissolving or resuspending the solute and/or particles and removing (e.g., pipetting) the resulting solution or suspension from the container.

In certain embodiments, the sample node comprises or is formed from a substrate or a sample support medium. Accordingly, the coding composition or coded composition can be carried by (e.g., absorbed into, surrounded by, or bound to the surface of) the sample support medium. As used herein, in the context of sample nodes, the terms “substrate” and “sample support medium” are used interchangeably. The sample support medium can be a porous medium (e.g., a medium have pores of sufficient size to allow biological molecules such as proteins and nucleic acids to permeate into the medium and be stored therein). Suitable sample support media include, but are not limited to, cellulose-containing materials, foams, nanoparticle matrices, and chemical matrices.

Specific examples of cellulose-containing materials suitable as sample support media include Guthrie cards, IsoCode™ paper (Schleicher and Schuell), and FTA™ paper (Whatman). A medium having a mixture of cellulose and polyester is useful in that low molecular weight nucleic acids (e.g., coding oligonucleotides) preferentially bind to the cellulose component and high molecular weight nucleic acids (e.g., genomic DNA fragments) preferentially binds to the polyester component. A specific example of a cellulose/polyester blend is LyPore SC (Lydall), which contains about 10% cellulose fiber and 90% polyester. Washing the dry solid medium with an appropriate liquid or removing a section (e.g., a punch) retrieves the oligonucleotides or sample from the medium, which can subsequently be analyzed to develop the code or to analyze the sample.

Foams suitable as sample support media can be open-cell foam, closed-cell foam, or mixtures thereof. Typically, the foams will be sponge-like or elastomeric in nature. Such foams can be made, for example, from polymers such as polyurethane. Suitable elastomeric substrates have been described, e.g., in U.S. 2006/0014177. In the particular example of a sponge-like absorbent foam having oligonucleotides or sample, the foam can be wet or wetted with an appropriate liquid, and squeezed or centrifuged to release liquid containing the oligonucleotides or sample.

Nanoparticle matrices suitable as sample support media have been described, e.g., in PCT Application WO 2009/002568. Nanoparticles mixed with a sample can be allowed to dry and thereby form a discrete sample node attached to a surface of the container in which they dried. Resuspension with water facilitates removal of the sample node from the container.

Chemical matrices suitable as sample support media can comprise a small inorganic preservative, such as borate or phosphate, and/or a small molecule stabilizer, such as histidine, and, optionally, further comprise a plasticizer such as a poly-alcohol (e.g., glycerol). Like nanoparticle matrices, chemical matrices form discrete sample nodes that attach to a surface of the container upon being dried. Resuspension in, for example, water, dissolves the sample node and breaks the attachment between the sample node and container.

In certain embodiments, the sample node and/or sample support medium is suitable for dry state storage of biological samples or molecules such as nucleic acids or proteins. As used herein, the term “dry state storage” refers to storage where the water in a sample is allowed to evaporate until the water content of the sample is in equilibrium with the humidity in the ambient atmosphere. In certain embodiments, the sample node and/or sample support medium is suitable for long-term storage of biological samples or molecules such as nucleic acids or proteins. Long-term storage can refer to 1, 2, 3, 4, 5, 6, 7, 8, 9, 10, 11, 12, 18 months or longer. Long-term storage can also refer to 2, 3, 4, 5, 6, 7, 8, 9, 10 years or longer.

In another aspect, the invention provides coded storage packages. In its most basic form, a coded storage package comprises a container comprising a coding composition of the invention. Preferably, the container is suitable for sample (e.g., biological sample) storage. For example, the container can comprise a sample node and/or sample support medium suitable for dry storage of biological samples, as discussed above. The coded storage package can further comprise an identifying indicia. Such identifying indicia can identify the code corresponding to the coding composition located in the container or provide information sufficient to identify the code. The identifying indicia can take any form suitable to its function. Accordingly, in certain embodiment, the identifying indicia is a bar code (e.g., a bar code attached to the container). The bar code can correspond directly to the code of the coding composition. Alternatively, the bar code can represent a product number and the code applied to the particular product can be recorded in a retrievable form (e.g., from database or a product insert). In general, the identifying indicia will be attached to the container comprising the coding composition.

Coded storage packages can include a single container, but will often comprise a plurality of containers. Each of the plurality of containers can include a coding composition of the invention. For example, the coded storage package can comprise a multi-well plate wherein individual wells in the plate correspond to individual containers. Alternatively, the coded storage package can comprise a plurality of individual containers (e.g., tubes) that can be used together or separately.

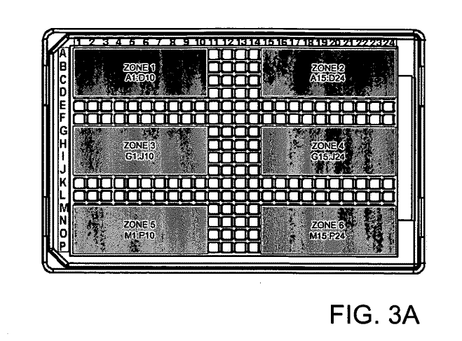

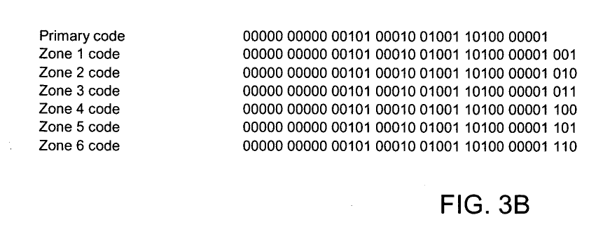

When a coded storage package includes a plurality of containers, each container can carry the same coding composition. Alternatively, at least some of the containers in the plurality can contain different coding compositions (i.e., coding compositions corresponding to different codes). For example, the plurality of containers can be divided into 2, 3, 4, 5, 6, 7, 8, 9, 10, 11, 12, or more groups, wherein each container within the same group comprises the same coding composition and containers in different groups comprise different coding compositions, as described in FIG. 3. In certain embodiments, the coded storage package further comprises an identifying indicia (e.g., bar code or product number) attached to at least one of said plurality of containers. The identifying indicia can be attached to all of the containers. For example, in certain embodiments, the coded storage package comprises a multi-well plate and the identifying indicia is attached to the multi-well plate (e.g., a side, bottom, or top surface of the multi-well plate). The identifying indicia can identify the code corresponding to the coding composition located in one or more of said plurality of containers. For example, the identifying indicia can be a bar code, wherein the numbers of the bar code indicate the presence or absence of specific coding oligonucleotides in the containers of the coded storage package. Alternatively, the identifying indicia can provide information that can be used to identify the code corresponding to the coding composition located in one or more of said plurality of containers. For example, the identifying indicia can be a product number that is associated (e.g., in a database) with the code(s) used in the storage package.

Coded storage packages of the invention can further comprises a sample, such as a biological or non-biological sample, as described herein. The sample can be located in one or more containers of the coded storage package. Typically, the sample will be carried by a sample node removably or reversibly attached to one of said containers. For example, the sample node can comprise a sample support medium that the sample is carried by (e.g., absorbed into, surrounded by, or bound to the surface of).

In another aspect, the invention provides methods for coding a sample. The methods can comprise adding a sample to a coding composition of the invention, or vice versa. For example, the methods can comprise adding a sample to a subset of coding oligonucleotides from a predetermined pool of coding oligonucleotides, wherein the combination of coding oligonucleotides represents the presence and absence of oligonucleotides from said pool and such representation constitutes a code. The coding composition can be carried by a sample node (e.g., by a sample support medium) prior to said addition, and the sample can be applied to the sample node (or sample support medium). For example, the sample can simply be added to a container of the invention and, optionally, the sample can be allowed to dry. As will be readily understood by persons skilled in the art, the order of addition can be switch around such that a sample is applied to a sample node/sample support medium in a container, after which the code is added (either as a mixture or one coding oligonucleotide at a time).

The methods for coding a sample can further comprise selecting a subset of coding oligonucleotides from a predetermined pool of coding oligonucleotides and combining the selected coding oligonucleotides to form a coding composition prior to the addition of the sample. For example, the selected coding oligonucleotides can be applied (e.g., sequentially or as a mixture) to a sample node in a container and, subsequently, the sample is applied to the sample node. As suggested above, selection of the coding oligonucleotides can depend upon the nature of the sample being coded so as to ensure that there is no cross-hybridization with the sample and/or other coding oligonucleotides that might interfere with reading the code.

In one aspect of the methods of producing a coded sample, one or more of the oligonucleotides of the code is physically separated or separable from the sample.

In another aspect, the invention provides samples coded according to the methods of the invention. The samples can be biological or non-biological. Once coded, samples can be stored in an archive (e.g., for short or long-term storage). Accordingly, the invention provides archives of samples coded with one or more coding compositions of the invention. An archive of the invention can comprises one or more containers or coded storage packages of the invention, wherein the coded samples are stored in the one or more containers or coding packages. In certain embodiments, the samples stored in the archive are in a dry state (e.g., desiccated biological samples).

In various aspects, an archive includes 1 to 10, 10 to 50, 50 to 100, 100 to 500, 500 to 1000, 1000 to 5000, 5000 to 10,000, 10,000 to 100,000, or more samples, one or more of which is coded. Thus, two or more samples placed in containers or a storage package of the invention, and then stored, can make up an archive.

In another aspect, the invention provides methods of decoding a sample coded with a coding composition of the invention (i.e., a coded composition). The methods of decoding comprise detecting, in the coded sample, one or more coding oligonucleotides from a predetermined pool of coding nucleotides. The collective result of the presence and absence of the one or more coding oligonucleotides from the predetermined pool is indicative of the code associated with the sample. Typically, the methods comprise detecting in the sample the presence or absence of each coding oligonucleotide in the predetermined pool. However, when it is known that the code will not include certain coding oligonucleotides from the predetermined pool, then it is only necessary to detect in the sample the presence or absence of those coding oligonucleotides that may be present. The methods can further comprise determining the code associated with the sample based upon the coding oligonucleotide detected in the sample.

Coding oligonucleotides can be detected in a number of different ways, and the number of steps involved will depend upon the structure of the coding oligonucleotides. For example, the detecting step can comprise contacting a sample with a set of identifier oligonucleotides and then detecting whether a coding oligonucleotide is bound to each identifier oligonucleotide of the set. As used herein, the term “identifier oligonucleotide” refers to an oligonucleotide that specifically hybridizes to a coding oligonucleotide of the invention, under the conditions of the assay, wherein specific hybridization between an identifier oligonucleotide and an identifier sequence in a coding oligonucleotide facilitates identification of the coding oligonucleotide. A “corresponding” identifier oligonucleotide is an identifier oligonucleotide that is complementary to a specific coding oligonucleotide. The set of identifiers can correspond to all of the coding oligonucleotides in the predetermined pool of coding oligonucleotides used to code the sample, or a subset thereof, as appropriate. The identifier oligonucleotide can be labeled (e.g., fluorescently or by other detectable means) in a manner that allows the identifier oligonucleotides, and any coding oligonucleotides bound thereto, to be identified. For example, in certain embodiments, the identifier oligonucleotides are bound to an addressable array. The addressable array can be, e.g., a microarray or a plurality of solid supports, such as labeled beads. The identifier oligonucleotides can be bound to the addressable array directly (e.g., via a covalent bond, which can be with the array or with a linker attached to the array) or indirectly, e.g., via a secondary identifier oligonucleotide (e.g., another oligonucleotide directly bound to an addressable array and capable of specifically hybridizing with a particular identifier oligonucleotide, as shown in FIGS. 12 D,E). The sequences in the identifier oligonucleotide and the secondary identifier oligonucleotide that bind to one another can be similar to the identifier sequences of the coding oligonucleotides (e.g., in terms of length, annealing temperature, etc.) and can be, for example, FlexMAP™ sequences, Illumina VeraCode™ sequences, or Osmetech eSensor™ sequences.

Thus, the invention additionally provides methods of identifying a sample code using an array or substrate that includes one or more identifier oligonucleotides. In one embodiment, the methods include providing a substrate including two or more identifier oligonucleotides, wherein the number of identifier oligonucleotides are sufficient to specifically hybridize to all oligonucleotides potentially present in a coded sample; contacting the substrate with a coded sample; and detecting specific hybridization between the identifier oligonucleotides and any coding oligonucleotides present in the sample, thereby identifying the coding oligonucleotides present in the sample. Comparing the combination of code oligonucleotides with a database including particular oligonucleotide combinations known to identify particular samples identifies the sample based upon the particular oligonucleotide combination in the database that is identical to the combination of oligonucleotides in the sample. In one aspect, the oligonucleotides of the code are amplified prior to contacting the coded sample with the substrate or array.

When the coding oligonucleotides initially comprise a label, such as a fluorescent label, detecting binding between the identifier oligonucleotides and the coding oligonucleotides can simply involve measuring fluorescence associated with the identifier oligonucleotide. For example, where each identifier oligonucleotide has a specific and unique position on an array, fluorescence associated with each of the identifier oligonucleotide can be measured, and fluorescence sufficiently above background level for a particular identifier oligonucleotide can indicate that the corresponding coding oligonucleotide is present in the sample being tested. For coding oligonucleotides that comprise non-fluorescent labels, such as biotin or digoxigenin, the same process is used, except that there is an added step of reacting any biotin or digoxigenin present in the coding oligonucleotides with a reagent that produces a detectable signal. Persons skilled in the art can readily identify suitable reagents for producing such detectable signals, including, for example, avidin-conjugated fluorophores or fluorescently labeled digoxigenin-specific antibodies.

When coding oligonucleotides do not comprise a label prior to being contacted with identifier oligonucleotides, a label can be added, e.g., following hybridization. The added label can be directly or indirectly added. Typically, addition of label comprises the use of a detection oligonucleotide. As used herein, the term “detection oligonucleotide” refers to an oligonucleotide that specifically hybridizes to a coding oligonucleotide of the invention, under the conditions of the assay, wherein specific hybridization between an detection oligonucleotide and a detection sequence in the coding oligonucleotide facilitates detection of the coding oligonucleotide. Accordingly, the decoding methods of the invention can comprise contacting each coding oligonucleotide in a sample with a corresponding identifier oligonucleotide and a detection oligonucleotide, and detecting a signal (e.g., a fluorescence signal) associated with the detection oligonucleotide. Whether or not the detection oligonucleotide is labeled, in certain embodiments a secondary detection oligonucleotide, such as a labeling oligonucleotide, can be hybridized to the detection oligonucleotide such that the signal associated with the detection oligonucleotide is either provided by the secondary detection oligonucleotide, e.g., as shown in FIG. 12D, or amplified, such as shown in FIG. 12C. The sequences in the detection oligonucleotide and the labeling oligonucleotide that hybridize to one another can be similar to the detection sequences of the coding oligonucleotides (e.g., in terms of length, annealing temperature, etc.) and can be, for example, FlexMAP™ sequences, Illumina VeraCode™ sequences, or Osmetech eSensor™ sequences.

When a detection oligonucleotide is labeled, hybridization between the detection oligonucleotide and the coding oligonucleotide results in the coding oligonucleotide being indirectly labeled. The detection oligonucleotide can be labeled in any manner similar to the direct labeling of coding oligonucleotides described herein. For example, detection oligonucleotides can comprise labeled nucleotides (e.g., labeled with biotin, digoxigenin, fluorophores, etc.). Signals associated with coding oligonucleotides as a result of hybridization to detection oligonucleotides can be detected and analyzed in a manner analogous to how such signal would be detected and analyzed if the label was directly incorporated into the coding oligonucleotide. In lieu of the detection oligonucleotide being directly labeled, or in addition (e.g., to achieve signal amplification), a secondary detection oligonucleotide that is labeled and specifically hybridizes to a portion of the detection oligonucleotide (e.g., a portion other than the sequence that binding to the detection sequence of the coding oligonucleotide) can also be used, as illustrated in FIG. 12C. The secondary detection oligonucleotide can be linear or branched (e.g., to further increase the amount of signal amplification). Branched oligonucleotides are well-known in the art and have been described, e.g., in U.S. Pat. No. 5,849,481.

Label can also be added directly to the coding oligonucleotides during development of the code. For example, a detection oligonucleotide can bind to the 3′ end of the coding oligonucleotide and can further include a 5′ extension capable of serving as a template for enzymatic addition of nucleotides (e.g., labeled nucleotides) to the 3′ end of the coding oligonucleotide. Methods for enzymatic addition of nucleotides to the 3′ end of an oligonucleotide are well known in the art and can be readily adapted for use in the present embodiments of the invention.

The addressable array can also consist of or comprise a set of beads, such as fluorescently labeled beads. For example, Luminex's xMAP technology provides color-coded beads, called microspheres, that come in one of 100 different colors. Subsets of such beads having the same color can comprise identifier oligonucleotides having the same sequence such that there is a one-to-one correspondence between bead color and identifier oligonucleotide. Thus, when a coding oligonucleotide of the invention binds to a corresponding identifier oligonucleotide, the coding oligonucleotide becomes bound to a bead of a particular color and can be identified accordingly. For example, flow cytometry can be used to sort xMAP beads into their different color-designated groups and the association between identifier oligonucleotides and coding oligonucleotides can be assessed to determine the presence or absence of specific coding oligonucleotides in a sample. Hybridization conditions used with xMAP beads and their subsequent analysis by flow cytometry has been described, e.g., in U.S. Pat. No. 7,226,737. Detection of any coding oligonucleotides attached to such beads can be accomplished as discussed above. For example, coding oligonucleotides that already comprise a label can be detected based on the label (e.g., based on fluorescence emitted by a fluorophore label or by a binding agent that binds to a biotin or digoxigenin label); coding oligonucleotides can be hybridized to one or more detection oligonucleotides that comprise a label and/or can bind to a secondary detection oligonucleotide comprising a label (i.e., a labelling oligonucleotide); or new label can be incorporated into the coding oligonucleotides.

Identifier oligonucleotides can be covalently bound to the surface of an xMAP bead or can hybridize to another molecule (e.g., a secondary identifier oligonucleotide) that is covalently attached to the bead. In the latter case, the identifier oligonucleotides will have a sequence, separate from the coding oligonucleotide-binding sequence, that facilitates hybridization to the appropriate beads (see, e.g., FIGS. 12 D,E).

As persons skilled in the art will understand, the hybridization steps involved in forming a complex between coding oligonucleotides and other oligonucleotides such as identifier oligonucleotides and detection oligonucleotides and, optionally, secondary identifier and secondary detection oligonucleotides, do not have to be performed in any particular order so long as a complete complex (complete in the sense that the coding oligonucleotides can be distinguished from one another and that some form of label is associated with the coding oligonucleotides) is allowed to form before the presence or absence of coding oligonucleotides in a sample is assessed. Accordingly, coding oligonucleotides in a sample can be hybridized first to identifier oligonucleotides then to detection oligonucleotides, or vice versa, or the various hybridization steps can be carried out simultaneously. Similarly, detection oligonucleotides can be hybridized first to coding oligonucleotides, then to a secondary detection oligonucleotide (i.e., labeling oligonucleotide), or vice versa, or the hybridization steps can be carried out simultaneously; identifier oligonucleotides can be hybridized first to microspheres (e.g., via secondary identifier oligonucleotides) then to coding oligonucleotides, or vice versa, or the hybridization steps can be carried out simultaneously; etc.

Suitable labels for use in the methods of the invention (e.g., for incorporation into coding oligonucleotides, detection oligonucleotides, or secondary detection oligonucleotides) can therefore include any composition that can be attached to or incorporated into nucleic acid that is detectable by spectroscopic, photochemical, biochemical, immunochemical, electrical, optical or chemical means such that it provides a means with which to identify the oligonucleotide. Useful labels are any label described herein, including biotin for staining with labeled streptavidin conjugate, magnetic beads (e.g., Dynabeads™), fluorescent dyes (e.g., 6-FAM, HEX, TET, TAMRA, ROX, JOE, 5-FAM, R110, fluorescein, texas red, rhodamine, lissamine, phycoerythrin (Perkin Elmer Cetus), Cy2, Cy3, Cy3.5, Cy5, Cy5.5, Cy7, Fluor X (Amersham Biosciences; Genisphere, Hatfield, Pa.), radiolabels, enzymes (e.g., horse radish peroxidase, alkaline phosphatase and others used in ELISA), Alexa dyes (Molecular Probes), Q-dots and calorimetric labels, such as colloidal gold or colored glass or plastic beads (e.g., polystyrene, polypropylene, latex, etc.).

The detecting step can alternatively comprises contacting each of said one or more coding oligonucleotides with a corresponding primer or primer pair. In certain embodiments, said contacting each of said one or more coding oligonucleotides with a corresponding primer or primer pair is followed by PCR. In certain embodiments, detection of the coding oligonucleotides is based upon their ability to be amplified by a particular primer or primer pair and/or their length. When amplification is not used, the primer or primer pairs can correspond to an identifier oligonucleotide or identifier and detection oligonucleotides, respectively.

Unique primer pairs that specifically hybridize to code oligonucleotides, identifier oligonucleotides, and detection oligonucleotides can have the same length, or be shorter or longer than the coding oligonucleotides to which they specifically hybridize. Additionally as with the unique primer pairs, identifier or detection oligonucleotides need only be complementary to at least a portion of the target code oligonucleotide, such that the identifier or detection oligonucleotide specifically hybridizes to code oligonucleotide and the code is developed. Of course, the longer the oligonucleotide sequence, the greater the number of nucleotide mismatches that may be tolerated without affecting specific hybridization between an identifier oligonucleotide and a complementary target code oligonucleotide.

The hybridization is specific in that the primer pair or identifier or detection oligonucleotide does not significantly hybridize to non-target oligonucleotides or non-target identifier or detection oligonucleotide, other primers or a sample that is nucleic acid to an extent that interferes with developing the code. Thus, primer pairs and identifier or detection oligonucleotides can share partial complementary with non-target oligonucleotides because stringency of the hybridization or amplification conditions can be such that the primer pairs or identifier or detection oligonucleotide preferentially hybridize to a target oligonucleotide(s). For example, in the case of a 30 base oligonucleotide, OL1, with 10 base primer pairs (Primers#1 and #2), and a 40 base oligonucleotide, OL2, with 10 base primer pairs (Primers#3 and #4), Primers #1 and #3 and/or Primers #2 and #4 can share sequence identity, for example, from 1 to about 5 contiguous nucleotides may be identical between Primers #1 and #3 and/or Primers #2 and #4 without interfering with developing the code. As length increases the number of contiguous nucleotides of a primer pair or identifier or detection oligonucleotide that may be non-complementary with a target oligonucleotide increases. As length increases the number of contiguous nucleotides of a primer pair or identifier or detection oligonucleotide that may be complementary with a non-target oligonucleotide or another primer likewise increases. Generally, the maximum number of contiguous nucleotides that may be identical between primers or identifier or detection oligonucleotides targeted to different coding oligonucleotides without interfering with developing the code will be about 40-60%. In any event, the primers and identifier oligonucleotides need not be 100% homologous to or have 100% complementary with the target oligonucleotides.

Primer pairs and identifier or detection oligonucleotides can be any length provided that they are capable of hybridizing to the target coding oligonucleotides and, where amplification is used to develop the code, capable of functioning for oligonucleotide amplification. In particular embodiments of the invention, one or more of the primers of the unique primer pairs has a length from about 8 to 250 nucleotides, e.g., a length from about 10 to 200, 10 to 150, 10 to 125, 12 to 100, 12 to 75, 15 to 60, 15 to 50, 18 to 50, 20 to 40, 25 to 40 or 25 to 35 nucleotides. In additional embodiments of the invention, one or more of the primers of the unique primer pairs has a length of about 9/10, ⅘, ¾, 7/10, ⅗, ½, ⅖, ⅓, 3/10, ¼, ⅕, ⅙, 1/7, ⅛, 1/10 of the length of the oligonucleotide to which the primer binds.

Individual primers in a primer pair, primer pairs in a primer set and primers of different sets can have the same or different lengths. In particular embodiments of the invention, each primer of a given unique primer pair, each primer pair in a primer set and primers in different primer sets have the same length or differ in length from about 1 to 500, 1 to 250, 1 to 100, 1 to 50, 1 to 25, 1 to 10, or 1 to 5 nucleotides.

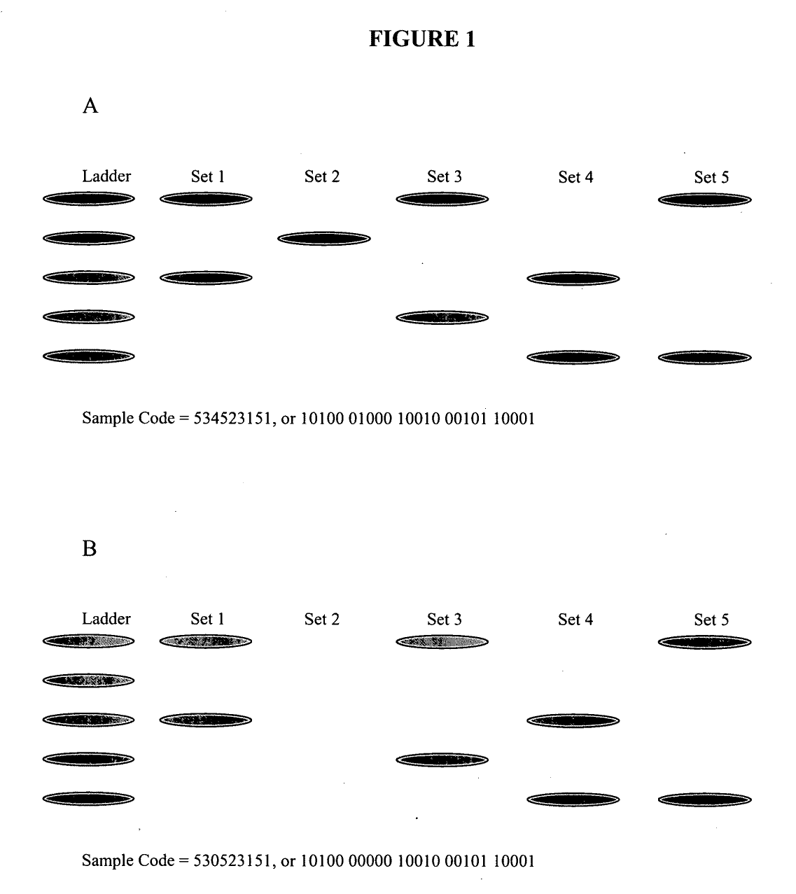

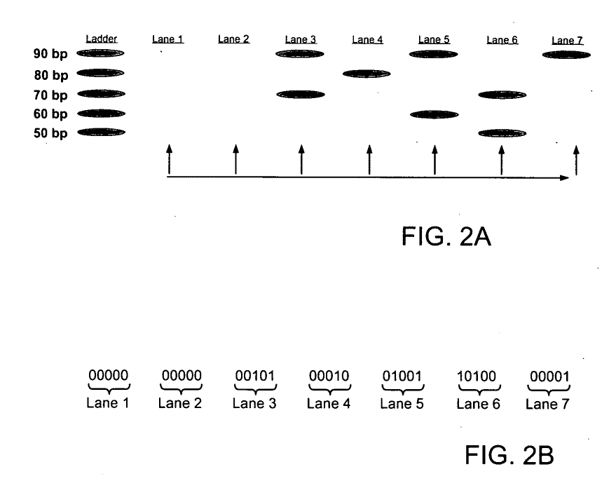

In Example 1 (see also FIG. 1 and FIG. 2), the code is developed by specific hybridization to primers and subsequent amplification and size-fractionation of the oligonucleotides that hybridize to the primers via electrophoresis. In addition to alternative ways of size-fractionation of the oligonucleotides, which include, size-exclusion, ion-exchange, paper and affinity chromatography, diffusion, solubility, adsorption, there are alternative methods of code development. For example, oligonucleotides could be amplified, then subsequently cleaved with an enzyme to produce known fragments with known lengths that could be the basis for a code. Alternatively, if a sufficient amount of oligonucleotide is present, the oligonucleotides may be size-fractionated without hybridization and subsequent amplification and directly visualized (e.g., electrophoretic size fractionation followed by UV fluorescence). Thus, the oligonucleotide(s) can be detected and, therefore, the code developed without hybridization or amplification.

Another way of detecting the oligonucleotides of the code without amplification and, furthermore, without the oligonucleotides having a different length or hybridization sequence, is to physically or chemically modify one or more of the oligonucleotides. For example, oligonucleotides can be modified to include a molecular beacon. One specific example is the stem-loop beacon where in the absence of hybridization, the oligonucleotide forms a stem-loop structure where the 5′ and 3′ termini comprise the stem, and the beacon (fluorophore, e.g., TMR) located at one termini of the stem is close to the quencher (e.g., DABCYL-CPG) located at the other termini of the stem. In this stem-loop configuration the beacon is quenched and, therefore, there is no emission by the oligonucleotide. When the oligonucleotide hybridizes to a complementary nucleic acid the stem structure is disrupted, the fluorophore is no longer quenched and the oligonucleotide then emits a fluorescent signal (see, e.g., Tan et al., Chem. Eur. J. 6:1107 (2000)). Thus, by including different beacons in oligonucleotides having different emission spectrums, each oligonucleotide containing a unique beacon can be identified by merely detecting the emission spectrum, without amplification or size-fractionation. Another specific example is the scorpion-probe approach, in which the stem-loop structure with the beacon and quencher is incorporated into a primer. When the primer hybridizes to the target oligonucleotide and the target is amplified, the primer is extended unfolding the stem-loop and the loop hybridizes intramolecularly with its target sequence, and the beacon emits a signal (see, e.g., Broude, N. E. Trends Biotechnol. 20:249 (2002)). As the number of beacons expands, the number of unique codes available expands. Thus, beacons in oligonucleotides can be used in combination with other oligonucleotides having a physical or chemical difference of the code, such as a different length.

Additional physical or chemical modifications that facilitate developing the code without amplification or fractionation include radioisotope-labeled nucleotides (e.g., dCTP) and fluorescein-labeled nucleotides (UTP or CTP). Detecting the labels indicates the presence of the oligonucleotide so labeled. The labels may be incorporated by any of a number of means well known to those skilled in the art. For example, the oligonucleotides can be directly labeled without hybridization or amplification or during oligonucleotide amplification, in which case the oligonucleotide(s) primer pairs can be labeled before, during, or following hybridization and subsequent amplification. Typically labeling occurs before hybridization. In a particular example, PCR with labeled primers or labeled nucleotides will produce a labeled amplification product.

The invention therefore further provides compositions including a substrate, and a plurality of polynucleotide or polypeptide sequences each immobilized at pre-determined positions on the substrate. In one embodiment, at least two of the polypeptide or polynucleotide sequences are designated as target sequences and are distinct from each other, and at least one polynucleotide sequence is designated as an identifier oligonucleotide that does not specifically hybridize to a nucleic acid that is capable of specifically hybridizing to the target sequences. In another embodiment, at least two polynucleotide sequences, designated as target sequences are distinct from each other, and at least a third polynucleotide sequence designated as an identifier oligonucleotide does not specifically hybridize to a nucleic acid that is capable of specifically hybridizing to the target sequences. In various aspects, the target sequences comprises a library (e.g., a nucleic acid, such as a genomic, cDNA or EST; or a polypeptide library, such as a binding molecule, for example, an antibody, receptor, receptor binding ligand or a lectin, or an enzyme library), for example, a mammalian library having at least 10 to 100, 100 to 1000, 1000 to 10,000, 10,000, to 100,000, or more target sequences.

The number of identifier oligonucleotides can vary and need only be sufficient to identify every oligonucleotide potentially present in a code or bio-tag. Thus, there can be between 2 and 5 identifier oligonucleotides, or more, as appropriate for specific hybridization to the code oligonucleotides, for example, between 5 and 10, 10 and 15, 15 and 20, 20 and 25, 25 and 30, 30 and 50, or more identifier oligonucleotides. When present on a substrate or array, the identifier oligonucleotides typically are patterned, for example, in a column or a row, to permit ease of identification.

As with oligonucleotides of a code or bio-tag, when the sample includes nucleic acid the identifier oligonucleotides are not capable of specific hybridization to the nucleic acid, to the extent that such hybridization prevents the code form being developed. Preferably, the identifier oligonucleotides do not prevent the sample's nucleic acid from being analyzed and, if appropriate, pathogens associated with the sample from being detected. As with code oligonucleotides, such hybridization can be minimized using code and corresponding identifier oligonucleotides that are not derived from the same species, or pathogens associated with the species, if the species is human, livestock, poultry, fish, crops or other species important for humans, as the sample target sequences. For example, where the sample target sequences are human, code oligonucleotides and, therefore, identifier oligonucleotides are not fully human and not fully human pathogen sequences; where the sample target sequences are plant, code oligonucleotides and, therefore, identifier oligonucleotides are not fully plant and not fully plant pathogen sequences; where the sample target sequences are bacterial, code oligonucleotides and, therefore, identifier oligonucleotides are not fully bacterial; where the sample target sequences are viral, code oligonucleotides and, therefore, identifier oligonucleotides are not fully viral; etc.

Samples containing code oligonucleotides can be contacted directly to such substrates or can be processed prior to contacting the substrate. For example, if it is desired to increase the amount of sample or code prior to contact with the substrate, the code or sample can be amplified. Thus, for a nucleic acid sample, if desired, amounts of both the nucleic acid and the code can be increased to increase hybridization sensitivity or hybridization detection and, therefore, detection of low copy number nucleic acid sequences or code oligonucleotides with the substrate.

Substrates can include two- or three-dimensional arrays that include biological molecules or materials, which are referred to herein as “target molecules,” “target sequences,” or “target materials.” Such substrates are useful for sample screening, sequencing, mapping, fingerprinting and genotyping. The particular identity of biological molecules included may be known or unknown. For example, a known nucleic acid sequence will specifically hybridize to a complementary sequence and, therefore, such a sequence has a defined recognition specificity.

Biological molecules may be naturally-occurring or man-made. Biological molecules typically include functional groups that participate in interaction with proteins, particularly hydrogen bonding, and typically include at least an amine, carbonyl, hydroxyl or carboxyl group. Cyclical carbon or heterocyclic structures or aromatic or polyaromatic structures substituted with one or more of the above functional groups may also be included. Thus, a particular example of a biological molecule is a small organic compound having a molecular weight of less than about 2,500 daltons, for example, a drug. Additional particular examples of biological molecules include nucleic acids, proteins (antibodies, receptors, ligands), saccharides, carbohydrates, lectins, fatty acids, lipids, steroids, purines, pyrimidines, derivatives, structural analogs and combinations thereof.

A “probe” is a molecule that potentially interacts with a target molecule, sequence or material, e.g., a query such as a nucleic acid or protein sample. Thus, target molecules, sequences and materials can be referred to as “anti-probes.” As with a target molecule, a probe is essentially any biological molecule or a plurality of such molecules.

Substrates can include any number of biological molecules. For example, arrays with nucleic acid or protein sequences greater than about 25, 50, 100, 1000, 10,000, 100,000, 1,000,000, 10,000,000, 100,000,000, 1,000,000,000, or more are known in the art. Such substrates, also referred to as “gene chips” or “arrays,” can have any nucleic acid or protein density; the greater the density the greater the number of sequences that can be screened on a given chip. Thus, very low density, low density, moderate density, high density, or very high density arrays can be made. Very low density arrays are less than 1,000. Low density arrays are generally less than 10,000, with from about 1,000 to about 5,000 being preferred. Moderate density arrays range from about 10,000 to about 100,000. High density arrays range about 100,000 to about 10,000,000. A typical array density is at least 25 molecules per square centimeter. In some arrays, multiple substrates may be used, either of different or identical biological molecules. Thus, for example, large arrays may comprise a plurality of smaller arrays or substrates.

Arrays typically have a surface with a plurality of biological molecules located at pre-determined or positionally distinguishable (addressable) locations so that any interaction (e.g., hybridization) between a target molecule and a probe can be detected. The biological molecules may be in a pattern, i.e., a regular or ordered organization or configuration, or randomly distributed. An example of a regular pattern are sites located in an X-Y, or “row”×“column” coordinate plane (i.e., a grid pattern). A “pattern” refers to a uniform or organized treatment of substrate, as described above, or a uniform or organized spatial relationship among the target molecules attached to the substrate, resulting in discrete sites.

Appropriate methods to detect interactions depend on the nature of the target and probe. Exemplary methods are known in the art and include, for example, radionuclides, enzymes, substrates, cofactors, inhibitors, magnetic particles, heavy metal and spectroscopic labels. High resolution and high sensitivity detection and quantitation can be achieved with fluorophores and luminescent agents, as set forth herein and known in the art. Hybridization signal detection methods, and methods and apparatus for signal detection and processing of signal intensity data are described, for example, in WO 99/47964 and U.S. Pat. Nos. 5,143,854, 5,547,839, 5,578,832; 5,631,734; 5,800,992, 5,834,758; 5,856,092, 5,902,723, 5,936,324; 5,981,956; 6,025,601; 6,090,555, 6,141,096; 6,185,030; 6,201,639; 6,218,803 and 6,225,625; and U.S. Patent Publication Nos. 20030215841 and 20030073125.

Biological molecules such as nucleic acid or protein (e.g., one or more sample(s)) are typically synthesized on the substrate or are attached to the surface of the substrate (e.g., via a covalent or non-covalent bond or chemical linkage, directly or via an attachment moiety or absorption, or photo-crosslinking) at defined locations (addresses) that are optionally pre-determined. The location of each molecule is typically positionally defined and located at physically discrete individual sites.

The surface of a substrate may be modified such that discrete sites are formed that only have a single type of biological molecule, e.g., a nucleic acid or polypeptide with a particular sequence. For example, the substrate can have a physical configuration such as a wells or small depressions that retain the biological molecule. Wells or small depressions in the substrate surface can be produced using a variety of techniques known in the art, including, for example, photolithography, stamping, molding and microetching techniques.

The substrate may be chemically altered to attach, either covalently or non-covalently, the biological molecules. Exemplary modifications include chemical, electrostatic, hydrophobic and hydrophilic functionalized sites, and adhesives. Chemical modifications include, for example, addition of chemical groups such as amino, carboxy, oxo and thiol groups that can be used to covalently attach biological molecules; addition of adhesive for binding biological molecules; addition of a charged group for the electrostatic attachment of biological molecules; addition of chemical functional groups that renders the sites differentially hydrophobic or hydrophilic so that the substrate associates with the biological molecules on the basis of hydroaffinity.

Array synthesis methods are described, for example, in WO 00/58516, WO 99/36760, and U.S. Pat. Nos. 5,143,854, 5,242,974, 5,252,743, 5,324,633, 5,384,261, 5,405,783, 5,424,186, 5,451,683, 5,482,867, 5,491,074, 5,527,681, 5,550,215, 5,571,639, 5,578,832, 5,593,839, 5,599,695, 5,624,711, 5,631,734, 5,795,716, 5,831,070, 5,837,832, 5,856,101, 5,858,659, 5,936,324, 5,968,740, 5,974,164, 5,981,185, 5,981,956, 6,025,601, 6,033,860, 6,040,193, 6,090,555, 6,136,269, 6,269,846 and 6,428,752; and U.S. Patent Publication Nos. 20040023367, 20030157700 and 20030119011. Nucleic acid arrays useful in the invention are commercially available from Illumina (San Diego, Calif.) and Affymetrix (Santa Clara, Calif.).

Substrates that include a two- or three-dimensional array of biological molecules, such as nucleic acid or protein sequences, and individual nucleic acid or protein sequences therein, may be coded in accordance with the invention. Thus, for example, the substrate itself can be the sample, in which case a substrate containing a plurality of nucleic acid or protein sequences will have a unique code. Alternatively, one or more of each individual nucleic acid or protein sequence on the substrate can have an individual code. For example, a unique oligonucleotide code can be added to one or more samples on the substrate in order to uniquely identify the coded samples.

In another alternative, a substrate can include oligonucleotides, referred to as identifier oligonucleotides, that identify the code in the sample. For example, in micro-array technology, typically a biological sample is contacted with an array that contains target molecules that potentially interact with probe molecules (e.g., protein or nucleic acid) within that sample. A profile of the sample is generated, for example, a gene expression profile, based upon the particular targets that interact with the probes in the sample. Arrays that include identifier oligonucleotides, can determine the code in the sample analyzed with the array. The identifier oligonucleotides are of sufficient number that collectively they are capable of specifically hybridizing to every possible code oligonucleotide that may be present in the sample. Specific hybridization between an identifier oligonucleotide and a code oligonucleotide identifies the oligonucleotides that are present in the code, by producing a signal (e.g., fluorescence, chemiluminescence) that indicates such hybridization. In contrast, identifier oligonucleotides that do not specifically hybridize to any code oligonucleotides do not produce a signal indicative of hybridization, indicating that the corresponding complementary code oligonucleotides are absent from the sample.

Each identifier oligonucleotide is immobilized at a pre-determined location or position on a substrate (e.g., an array). For example, identifier oligonucleotides can be positioned at specified addresses on an array in a pattern or other configuration such as a row or a column, or a section of rows and columns of an array, such as in a “row×column” pattern of 2×2 (4 identifier oligonucleotides), 2×3 or 3×2 (6 identifier oligonucleotides), 3×3 (9 identifier oligonucleotides), 3×4 or 4×3 (12 identifier oligonucleotides), 4×4 (16 identifier oligonucleotides), 4×5 or 5×4 (20 identifier oligonucleotides), 5×5 (25 identifier oligonucleotides), etc. As with the oligonucleotides of the code, the identifier oligonucleotides also do not specifically hybridize to nucleic acids of the sample to the extent that such hybridization interferes with developing the code.

Samples coded with a unique combination of oligonucleotides in accordance with the invention can contact a substrate (e.g., an array) that includes such identifier oligonucleotides. Following contacting with the coded sample, identifier oligonucleotides that specifically hybridize to their complementary code oligonucleotides present in the sample are detected. As before, the code is identified or “decoded” based upon which oligonucleotides are present in the code (positive) and which oligonucleotides are absent (negative). As before, the presence and absence of a given oligonucleotide of the code can optionally be represented for each position as in a bar-code, for example, “1” to indicate hybridization to the particular identifier oligonucleotide, and “0” to indicate the absence of hybridization to the particular identifier oligonucleotide.

Using substrates including such identifier oligonucleotides allows the sample profile to be developed with the sample code, which provides an internal check of sample identity. In other words, the sample code and, therefore, the identity of the sample is permanently linked to and associated with the profile for that sample.

The invention moreover provides methods of producing substrates and arrays capable of identifying a sample code. In one embodiment, a method includes selecting a combination of two or more identifier oligonucleotides to add to a substrate, the identifier oligonucleotides each capable of specifically hybridizing to a corresponding code oligonucleotide; and adding the combination of two or more identifier oligonucleotides to the substrate, wherein the number of identifier oligonucleotides are sufficient to specifically hybridize to all oligonucleotides potentially present in a coded sample. Typically, the identifier oligonucleotides are selected on the basis of the code oligonucleotide sequences in order to ensure specific hybridization and, therefore, code identification.

In various aspects, between 2 and 5, 5 and 10, 10 and 15, 15 and 20, 20 and 25, 25 and 30, 30 and 50, or more identifier oligonucleotides are present on the substrate or array. In additional aspects, the substrate or array includes a check code or another oligonucleotide that provides other information (e.g., the source of the sample, such as the hospital or clinic from which it originated). In yet additional aspects, the identifier oligonucleotides are located in pre-determined positions (addresses) on the array or substrate, for example, in an ordered pattern such as a column or a row.

As described herein, code oligonucleotides can be designed that have a common primer set but differ in the internal sequence between the primer binding sites or the sequence(s) that flank the primer binding sites. In this way, all code oligonucleotides in a sample can be amplified with a single primer set. Since the code oligonucleotide includes a unique sequence, a specifically hybridizing identifier oligonucleotide can be designed which has a sequence that is complementary to the unique sequence of the code oligonucleotide. For example, differing intervening sequences between the primer-binding site of two code oligonucleotides allow them to be distinguished from each other, even though both code oligonucleotide have the same sequences for primer binding. This design can increase the number of codes that can be produced for a given set of primers.

An additional feature of this aspect of the invention is that a code oligonucleotide can be used to provide highly specific information. For example, a code oligonucleotide could be assigned to a particular hospital, clinic, research institution, or any other source from which a sample was obtained. The assigned code would be unique to the source of the sample such that the code positively identifies the sample source (e.g., the particular hospital, clinic, etc., to which the code is assigned). Such a code oligonucleotide would provide a link between the sample and the source thereby providing a means to trace the sample to its source and minimizing sample misidentification. A code oligonucleotide could be used to identify a particular substrate, array or study type. The information that the code provides is therefore not limited to binary information. In addition, the position of an oligonucleotide on a substrate or array could also be used to provide information.

Sample identification afforded by including a unique bio-tag as set forth herein, and optionally including identifier oligonucleotides on an array or substrate that may be used for sample analysis, allows tracking of the sample at any time. The ability to positively identify a sample based upon its unique code prevents errors due to sample mishandling, mislabeling or misidentification that can occur during procedures employing the sample. Positive sample identification is particularly valuable where large numbers of samples are processed, where sample misidentification can lead to erroneous data, and where samples are subject to multiple studies or procedures. For example, genotyping studies typically require analysis of large numbers of samples in order to detect associations between a disease and a gene loci. Positive sample identification is crucial since even low error rates (from 1-2%) can have a significant impact, increasing both Type I (false positives) and Type II (loss of power) errors. Sample swap, in which one sample is mislabeled, misidentified, or mishandled as another sample, is a well-known source of error in genotyping studies. The invention, which, inter alia, provides compositions and methods for producing uniquely identified samples as well as compositions and methods for identifying such samples, can be employed to reduce and eliminate such errors.

The code however may be developed by any other means capable of differentiating between the oligonucleotides comprising the code. For example, the oligonucleotides whether amplified or not may be fractionated by size-exclusion, paper or ion-exchange chromatography, or be separated on the basis of charge, solubility, diffusion or adsorption. Thus, the means of identifying the oligonucleotides of the code include any method which differentiates between oligonucleotides that may be present in the code.

For example, oligonucleotides having a chemical or physical difference that cannot be differentiated by size-fractionation or differential hybridization may be differentiated by other means including modifying the oligonucleotides. As set forth in detail below, oligonucleotides may be labeled using any of a variety of detectable moieties in order to differentiate them from each other. As such, a code may include one or more oligonucleotides that have an identical nucleotide sequence or length but that have some other chemical or physical difference between them that allows them to be distinguished from each other. Accordingly, such oligonucleotides, which may be included in a code as set forth herein, need not be subject to hybridization or subsequent amplification in order to determine their presence and consequently, the code identity.

As used herein, the term “different sequence,” when used in reference to oligonucleotides, means that the nucleotide sequences of the oligonucleotides are different from each other to the extent that the oligonucleotides can be differentiated from each other. The different sequence of an oligonucleotide “capable of specifically hybridizing to a unique primer pair” or an identifier oligonucleotide “capable of specifically hybridizing to a unique oligonucleotide of a code” therefore includes any contiguous sequence that is suitable for primer or identifier oligonucleotide hybridization such that the code oligonucleotide can be differentiated on the basis of differential hybridization from other oligonucleotides potentially present. The oligonucleotides will differ in sequence from each other by at least one nucleotide, but typically will exhibit greater differences to minimize non-specific hybridization, e.g., 2-5, 5-10, 10-20, 20-30, 30-50, 50-100, 100-250, 250-500 or more nucleotides in the oligonucleotides will differ from the other oligonucleotides. The number of nucleotide differences to achieve differential hybridization and, therefore, oligonucleotide differentiation will be influenced by the size of the oligonucleotide, the sequence of the oligonucleotide, the assay conditions (e.g., hybridization conditions such as temperature and the buffer composition), etc. Oligonucleotide sequence differences may also be expressed as a percentage of the total length of the oligonucleotide sequence, e.g., when comparing the two oligonucleotides, the percentage of the nucleotides that are either identical or different from each other. Thus, for example, for a 30 by oligonucleotide (OL1) as little as 20-25% of the sequence need be different from another oligonucleotide sequence (OL2) in order to differentiate between OL1 and OL2, provided that the sequences of OL1 and OL2 that are 75-80% identical do not interfere with developing the code.

The term “different sequence,” when used in reference to oligonucleotides, refers to oligonucleotides in which differential hybridization is used to differentiate among the oligonucleotides comprising the code. This does not preclude the presence of other oligonucleotides in the code where differential primer hybridization is not used to identify them. For example, two or more oligonucleotides of the code can have an identical nucleotide sequence where a primer pair hybridizes. Thus, such oligonucleotides are not distinguished from each other on the basis of length or differential primer hybridization. However, oligonucleotides having the same primer hybridization sequence can have different sequence length, or some other physical or chemical difference such as charge, solubility, diffusion adsorption or a label, such that they can be differentiated from each other. For example, code oligonucleotides having shared primer hybridization sites can be differentiated from each other due to the presence of a different sequence outside of the primer hybridization sites, either a sequence region that flanks a primer binding site or a sequence region that is located between the primer binding sites. Specific hybridization between such a “non-primer binding site” sequence region and a complementary identifier oligonucleotide identifies the particular code oligonucleotide. Accordingly, oligonucleotides of the code can have the same nucleotide sequence where a primer pair hybridizes and as such, a primer pair can specifically hybridize to two or more oligonucleotides of the code.

The oligonucleotide sequence determines the sequence of the primer pairs or identifier or detection oligonucleotides used to detect the oligonucleotides. As disclosed herein, using unique primer pairs or identifier oligonucleotides that specifically hybridize to each of the coding oligonucleotides potentially present in a query sample facilitates detection of all coding oligonucleotides. Typically, the corresponding primer pairs hybridize to a portion of the coding oligonucleotide sequence. Thus, the sequence region to which the primers or identifier oligonucleotides hybridize is the only nucleotide sequence that need be known in order to detect the coding oligonucleotide. In other words, in order to detect or identify any oligonucleotide of the code, only the nucleotide sequence that participates in hybridization needs to be known. Accordingly, nucleotide sequences of an coding oligonucleotide that do not participate in specific hybridization with a primer pair or identifier oligonucleotide can be any sequence or unknown.

Where the primer pairs hybridize at the 5′ or 3′ end of a coding oligonucleotide, the intervening sequence between the hybridization sites can be any sequence or can be unknown. Likewise, for primer pairs that hybridize near the 5′ or 3′ end of a coding oligonucleotide, the intervening sequence between the primer hybridization sites or the sequences that flank the primer hybridization sites can be any sequence or can be unknown. Likewise, for identifier oligonucleotides, the portion that does not hybridize to its corresponding complementary code oligonucleotide can be any sequence or can be unknown. In either case, nucleotides located between or that flank the hybridization sites can be any sequence or unknown, provided that the intervening or flanking sequences do not hybridize to different oligonucleotides, non-target identifier oligonucleotides, non-target primers or to a sample that is nucleic acid to such an extent that it interferes with developing the code.

Since the nucleotide sequence of the coding oligonucleotides to which the primers or identifier oligonucleotides hybridize confer hybridization specificity which in turn indicates the identity of the oligonucleotide (e.g., OL1), nucleotides that do not participate in hybridization may be identical to nucleotides in different oligonucleotides (e.g., OL2) that do not participate in hybridization. For example, if a particular oligonucleotide is 30 nucleotides in length (OL1), a primer or identifier oligonucleotide could be as few as 8 nucleotides meaning that 14 nucleotides in the oligonucleotide are not participating in hybridization. Thus, all or a part of these 14 contiguous nucleotides in OL1 can be identical to one or more of the other oligonucleotides in the same set or in a different set (e.g., OL2, OL3, OL4, OL5, OL6, etc.), provided that the primer pairs or identifier oligonucleotides that specifically hybridize to OL2, OL3, OL4, OL5, OL6, etc., do not also hybridize to this 14 nucleotide sequence to the extent that this interferes with developing the code. Accordingly, nucleotide sequences regions within an oligonucleotide that do not participate in hybridization may be identical to other oligonucleotides, in part or entirely.

The location of the different sequence capable of specifically hybridizing to a unique primer pair in an oligonucleotide will typically be at or near the 5′ and 3′ termini of the oligonucleotide. The location of the different sequence capable of specifically hybridizing to a unique primer pair in the oligonucleotide is influenced by oligonucleotide length. For example, for shorter oligonucleotides the location of the different sequence capable of specifically hybridizing to a unique primer pair is typically at or near the 5′ and 3′ termini. In contrast, with longer oligonucleotides the location of the different sequence capable of specifically hybridizing to a unique primer pair can be further away from the 5′ and 3′ termini. Where oligonucleotide size differences are used for identification, there need only be size differences between the oligonucleotides in the code or in the amplified oligonucleotide products. Thus, if the oligonucleotides are detected in the absence of amplification, the sizes of the oligonucleotides will be different from each other. In contrast, if amplification is used to develop the code as in Example 1 (FIG. 1 and FIG. 2), the primers in a given set need only specifically hybridize to the oligonucleotides in the set (i.e., not at the 5′ and 3′ termini) to produce amplified products having different sizes from each other. In other words, oligonucleotides within a given set can have an identical length provided that the primers specifically hybridize with the oligonucleotide at locations that produce amplified products having a different size. As an example, two oligonucleotides, OL1 and OL2, within a given set each have a length of 50 nucleotides. When developing the code primer pairs that specifically hybridize at the 5′ and 3′ termini of OL1 produce an amplified product of 50 nucleotides, whereas primer pairs that specifically hybridize 5 nucleotides within the 5′ and 3′ termini of OL2 produce an amplified product of 40 nucleotides.

Thus, the location of the different sequence capable of specifically hybridizing to a unique primer pair in an oligonucleotide can, but need not be, at the 5′ and 3′ termini of the oligonucleotide. In one embodiment, the different sequence is located within about 0 to 5, 5 to 10, 10 to 25 nucleotides of the 3′ or 5′ terminus of the oligonucleotide. In another embodiment, the different sequence is located within about 25 to 50 or 50 to 100 nucleotides of the 3′ or 5′ terminus of the oligonucleotide. In additional embodiments, the different sequence is located within about 100 to 250, 250 to 500, 500 to 1000, or 1000 to 5000 nucleotides of the 3′ or 5′ terminus of the oligonucleotide.

As used herein, the term “unique primer pair” means a primer pair that specifically hybridizes to an oligonucleotide target under the conditions of the assay. As disclosed herein, a primer pair may hybridize to two or more oligonucleotides that are potentially present in the code. A unique primer pair need only be complementary to at least a portion of the target oligonucleotide such that the primers specifically hybridize and the code is developed. For example, oligonucleotide sequences from about 8 to 15 nucleotides are able to tolerate mismatches; the longer the sequence, the greater the number of mismatches that may be tolerated without affecting specific hybridization. Thus, an 8 to 15 base sequence can tolerate 1-3 mismatches; a 15 to 20 base sequence can tolerate 14 mismatches; a 20 to 25 base sequence can tolerate 1-5 mismatches; a 25 to 30 base sequence can tolerate 1-6 mismatches, and so forth.

In another aspect, the invention provides kits. The kits can include any composition as set forth herein. Accordingly, the kits can comprise, e.g., a container comprising a coding composition of the invention or a coded storage package of the invention. The coding composition can include a subset of coding oligonucleotides (e.g., two or more oligonucleotides in one or more oligonucleotide sets) from a predetermined pool of coding oligonucleotides.

Kits of the invention can include a set of identifier oligonucleotides. For example, the set of identifier oligonucleotides can be sufficient to decode a coding composition of the invention (e.g., a coding composition contained in a container of the kit or in one or more containers of a coded storage package of the kit). Kits of the invention can include at least one detection oligonucleotide. For example, the at least one detection oligonucleotide can be used in decoding a coding composition of the invention (e.g., a coding composition contained in a container of said kit or in one or more containers of a coded storage package of said kit). Kits of the invention can include both a set of identifier oligonucleotides and at least one detection oligonucleotide. Kits can include primer pair(s) of one or more sets. The identifier oligonucleotides, detection oligonucleotides, and/or primer pairs can be bundled with appropriate coding compositions.

A kit of the invention can further comprise an identifying indicia. The identifying indicia can, for example, identify the code corresponding to a coding composition located in the kit, such as in a container in the kit or in one or more containers of a coded storage package in the kit. Likewise, a kit of the invention can further comprises a label of packaging insert (e.g., instructions) that provides how to use the contents of the kit to encode and/or decode samples (e.g., biological samples or non-biological samples). The instructions can include a listing of the types of samples that can be stored in a container or coded storage package located in the kit.

A kit will typically be packaged into suitable packaging material. The term “packaging material” refers to a physical structure housing the components of the kit. The packaging material can maintain the components sterilely, and can be made of material commonly used for such purposes (e.g., paper, corrugated fiber, glass, plastic, foil, ampoules, etc.). The instructions may be on “printed matter,” e.g., on paper or cardboard within the kit, or on a label affixed to the kit or packaging material, or attached to a vial or tube containing a component of the kit. Instructions may additionally be included on a computer readable medium, such as a disk (floppy diskette or hard disk), optical CD such as CD- or DVD-ROM/RAM, DV, MP3, magnetic tape, electrical storage media such as RAM and ROM and hybrids of these such as magnetic/optical storage media.

Kits of the invention can include each component (e.g., coding compositions) of the kit enclosed within an individual container and all of the various containers can be within a single package. Invention kits can be designed for long-term storage.

It will be appreciated that some or all of the foregoing functional aspects related to creating bio-tagged samples and to “reading” or otherwise interpreting bio-tags to identify specific samples with particularity may be facilitated by one or more automated systems operative under computer or microprocessor control. In that regard, a computer executed method of producing a bio-tag for a sample, as well as a computer executed method of applying a bio-tag to a sample carrier, may generally utilize a processing component having sufficient capabilities and processing bandwidth to enable the functionality set forth below with specific reference to FIGS. 2-5. Such a processing component may be embodied in or comprise a computer, a microcomputer or microcontroller, a programmable logic controller, one or more field programmable gate arrays, or any other individual hardware element or combination of elements having utility in data storage and processing operations as generally known in the art or developed and operative in accordance with known principles.

Specifically, the term “processing component” in this context generally refers to hardware, firmware, software, or more specifically, to some combination thereof, appropriately configured, suitably programmed, and generally operative to execute computer readable instructions encoded on a recording medium and causing an apparatus executing the instructions to create, read, or otherwise to utilize bio-tag codes as set forth with particularity herein. In that regard, a processing component may additionally provide partial or complete instruction sets to various types of automated apparatus, robotic systems, and other computer controllable devices, and may be operative to communicate with, receive feedback from, and dynamically influence operation of independent processing components or electronic elements associated or integrated with such apparatus.

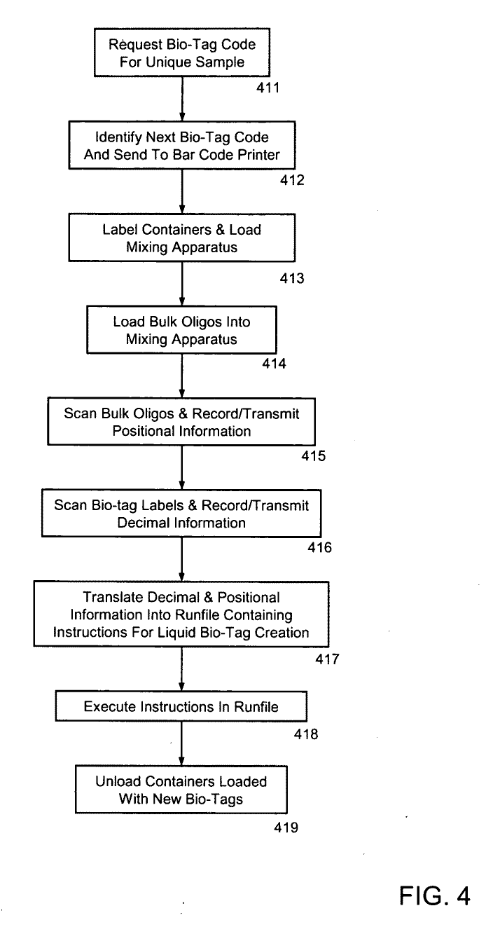

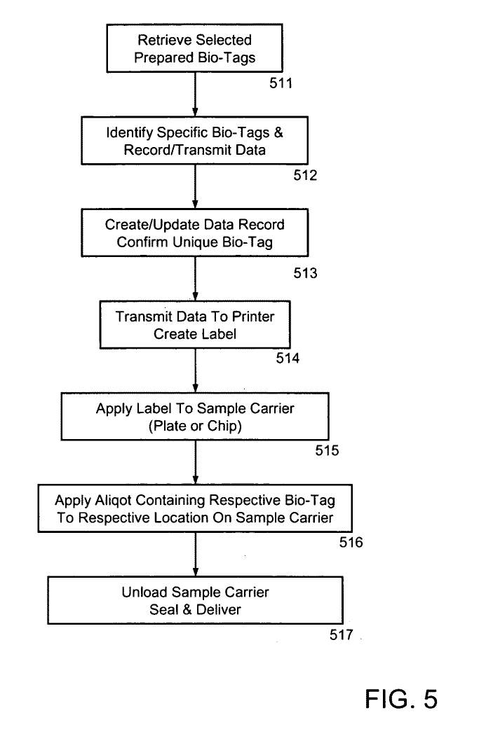

In that regard, it will be appreciated that a computer readable medium encoded with data and instructions for producing a bio-tagged sample may readily cause an apparatus executing the instructions to select a unique combination of oligonucleotides to add to the sample as described in detail below; data records regarding unique combinations of oligonucleotides may be maintained in a database or other data structure accessible by a computer or processing component and may enable the functionality set forth below with specific reference to FIG. 4 and FIG. 5. As described in detail above with specific reference to FIG. 1A and FIG. 1B, the oligonucleotides may be selected such that each is incapable of specifically hybridizing to the sample. Additionally, the oligonucleotides may be selected such that each may have a length from about 8 to about 5000 nucleotides, and each may have certain selected physical or chemical properties; in particular, one or more of the oligonucleotides each have a different sequence therein capable of specifically hybridizing to a unique primer pair or to an identifier oligonucleotide as described above. As set forth in more detail below, computer executable instruction sets may cause automated apparatus or robotic devices to contact a unique combination of oligonucleotides with a sample, or with a specified or predetermined well in, or a specified or predetermined location on, a sample carrier. A specified unique combination of oligonucleotides selected by a processing component may be associated with and identify a specified location on the sample carrier, thereby producing a bio-tagged sample or a bio-tagged location on the sample carrier. Data records associating each unique combination of oligonucleotides with each unique bio-tagged sample or location on the sample carrier may be maintained, for example, in the database or other suitable data structure mentioned above.

Further, a computer readable medium encoded with data and instructions for identifying a bio-tagged sample may enable an apparatus executing the instructions to detect in a sample the presence or absence of two or more oligonucleotides; as contemplated herein, the oligonucleotides may generally be identified based upon a physical or chemical difference. Accordingly, automated apparatus may identify a specific unique combination of oligonucleotides in the sample; this functionality may be embodied in or incorporate various automated detection technologies generally known in the art of sample analysis. The computer readable medium may cause an apparatus to compare the unique combination of oligonucleotides with a database comprising data records of particular oligonucleotide combinations known to identify respective particular samples, and to identify an otherwise unknown sample based upon a comparison of the data records and the unique combination of oligonucleotides in the unknown sample.

In accordance with the detailed description provided above, it will be appreciated that a computer readable medium encoded with data and instructions for producing an archive of bio-tagged samples may cause or enable an apparatus executing the instructions to select a unique combination of oligonucleotides to associate with a sample; the oligonucleotides may be selected automatically by an appropriately programmed processing component, and may be selected in accordance with the structural and chemical considerations set forth above with reference to FIG. 1A and FIG. 1B. Automated devices operating under control of a processing component may contact the unique combination of oligonucleotides with the sample such that the unique combination of oligonucleotides identifies the sample, thereby producing a bio-tagged sample; similarly, automated or semi-automated devices operating under control of the processing component may place the bio-tagged sample in a storage medium archive facility for storing the bio-tagged sample, and may additionally create a data record associating the storage medium and the storage location with the bio-tagged sample.

FIG. 2A is a simplified diagram illustrating a code generated following size-based fractionation via gel electrophoresis and indicating an alternative convention for reading the code. FIG. 2B is a simplified diagram illustrating the binary code read in accordance with the convention indicated in FIG. 2B. Specifically, each lane of the gel represented in FIG. 2A may be read in sequence (i.e., lane 1, followed by lane 2, followed by lane 3, and so forth) and from bottom to top. (i.e., in the direction of increasing base-pair size in FIG. 2A). The binary code in FIG. 2B represents the encoded information extracted when the gel is read in the foregoing manner. Various apparatus and methodologies may be employed for reading results of an electrophoresis gel; the present disclosure is not intended to be limited to any particular technology employed to acquire data from such an electrophoresis operation. Similarly, the conventions employed for encoding data in the gel and for reading or otherwise interpreting same are susceptible of numerous modifications, none of which affect the scope and contemplation of the present disclosure.

As described herein, various systems and methods of spotting, loading, bio-tagging, or otherwise manipulating samples and sample carriers are described. In that regard, FIG. 3A is a simplified diagram illustrating one embodiment of a sample carrier, and FIG. 3B is a simplified diagram illustrating an exemplary code associated with one bio-tag maintained at different locations on the sample carrier of FIG. 3A.

In some embodiments, a sample carrier may generally be embodied in or comprise a multi-well plate. The plate may employ 384 discrete wells, for example, as illustrated in the FIG. 3A implementation; other plate formats, including 96 wells, for example, are also commonly used. In alternative embodiments, a sample carrier may be embodied in or comprise a bio chip, array, or other substrate, for example, and may generally include a grid or similar coordinate system. Whether such a coordinate system comprises, for example, numbered columns and lettered rows of wells as in the FIG. 3A embodiment, or some other coordinate convention used in conjunction with a multi-well plate or with respect to an array, the coordinate system may facilitate organization of a sample carrier and identification of samples by specifying or uniquely designating a plurality of addressable locations, each of which may contain or support a discrete sample.

The sample carrier of FIG. 3A is further organized or sub-divided into six distinct zones: zone 1 comprises wells at grid locations A1 through D10; zone 2 comprises wells at grid locations A15 through D24; and so forth. The represented organization is arbitrary and may be selectively altered to accommodate more or fewer zones as desired, i.e., any number or arrangement of different zones or distinct areas on the sample carrier may be established at any convenient location. Similarly, an array, or even a rack of test tubes, may be selectively sub-divided or otherwise organized into zones as desired or required. As indicated in FIG. 3B, a single bio-tag code (such as that representing the bio-tag considered in FIG. 2A and FIG. 2B, in this example) may be used multiple times and still enable unique identification of a discrete sample where a zone designator code or other indicia is appended to the code. For example, a binary suffix “011” appended to the code may be interpreted as an indication that the bio-tag is associated with or located in zone 3 of the sample carrier, whereas the code for the same bio-tag maintained at or located in zone 4 may include a binary suffix “100.” In the foregoing manner, it is possible to employ a single bio-tag up to six different times in conjunction with the exemplary sample carrier of FIG. 3A while allowing or enabling six distinct codes therefor.

FIG. 4 is a simplified flow diagram illustrating the general operation of one embodiment of a method of producing a bio-tag for use in identifying a sample. In accordance with the exemplary FIG. 4 embodiment, a method of producing a bio-tag for a sample may generally begin with a request that a bio-tag be created for a unique sample as indicated at block 411. As contemplated at block 411, an operator or user may login to a software application (such as a Java script, for example, or such as may be embodied in a commercial or proprietary software program) enabled by or running on a processing component as set forth above. Upon login and appropriate operator authentication procedures (such as are generally known in the art), an operator may request a specific number of bio-tags, each of which may be employed to identify a unique sample.

As indicated at block 412, the next available bio-tag code (such as in a predetermined or prerecorded sequence, for example) may be identified and sent to a barcode label printer; in some implementations using decimal format, code 128 barcodes may be employed. In some embodiments, the operation depicted at block 412 may be executed automatically under control of a processing component as set forth above; in such automated implementations, the foregoing software application may query a database or other data structure (such as an ORACLE™ database or other proprietary data archival mechanism) to retrieve a next unique bio-tag available in a particular reference system or bio-tag code universe. In that regard, it will be appreciated that different entities or different archive systems may have one or more bio-tags in common; in this context, however, such common codes may nevertheless be unique in each individual system. Alternatively, an archive or entity identifier segment or sequence may be appended to each bio-tag created, making even repeated sequences or combinations of bio-tag oligonucleotides distinct between entities or archival systems.

The newly-ascertained unique bio-tag code may be transmitted or otherwise communicated to a conventional barcode printer responsive to appropriate command or control signals issued by the processing component. Alternatively, an operator may consult one or more look-up or reference tables, spreadsheet cells, or other archival records to ascertain which of a plurality of bio-tag codes in a particular reference system have not been used, and may send same to a barcode printer manually, or at least partially in accordance with operator intervention. Specifically, it will be appreciated that the operations at blocks 411 and 412 may be at least partially conducted manually or otherwise in conjunction with operator input. In a fully automated embodiment, the processing component may control all operations; additionally or alternatively, the processing component may work in conjunction with independent processing components or programming instruction sets resident in or associated with, for example, the barcode printing apparatus or other automated devices.

As indicated at block 413, barcode labels may be applied to one or more containers, which may then be loaded into a mixing apparatus. It will be appreciated that the identification functionality contemplated at blocks 412 and 413, while described with reference to barcode labels, may alternatively be implemented in accordance with any of various types of identification methodologies. One- and two-dimensional barcodes may have particular utility in that regard, especially when employed in conjunction with automated optical systems or machine reading apparatus. In accordance with some exemplary embodiments, any type of identifying indicia, including alpha-numeric and other coding schemes, may be employed in addition, or as an alternative, to barcode indicia.

As with the operations at blocks 411 and 412, the functionality illustrated at block 413 may be performed automatically through appropriately manipulated automated or robotic apparatus, for example, under control of a processing component; alternatively, the foregoing functions may be executed partially or entirely manually by an operator. In particular, an operator may apply the barcode labels to empty containers and load labeled containers into a mixing apparatus or other device for receiving bio-tag materials or solutions. With respect to the operation depicted at block 413, “containers” may be embodied in, but are not limited to, for example, test tubes, multi-well plates (such as those containing 96, 384, or any other number of discrete wells), or arrays or other suitable substrates, such as generally known and employed in the art of biological and non-biological sample analysis technologies. In some embodiments, an automated liquid handling device for loading bio-tag materials or solutions into containers or onto container media under control of a processing component may be embodied in or comprise a Microlab Star liquid handler apparatus currently available from Hamilton Company, though other single and multiple arm liquid handling systems are generally known in the art and may be suitably configured and programmed to provide the functionality set forth herein.

As indicated at block 414, bulk oligonucleotides may be loaded into the mixing apparatus. Again, this operation may be executed either by an operator, for instance, or entirely or partially under control of a suitably programmed processing component operative to manipulate automated or robotic handling mechanisms. In that regard, and in accordance with some automated or semi-automated embodiments, each particular bulk oligonucleotide may be uniquely identified by a fixed barcode or other indicia on its container, allowing or enabling precise identification of same by various types of mechanical, optical, or electromechanical devices.

As indicated at block 415, the mixing apparatus may scan each bulk oligonucleotide container and send positional information (for each bulk oligonucleotide) to mixer controlling software. The foregoing scanning operation may be conducted independently by the mixing apparatus; additionally or alternatively, some instructions or a complete instruction set regarding desired scanning procedures or parameters may be transmitted by an independent processing component such as set forth above. Similarly, the aforementioned mixing control software may be resident at the mixing apparatus, for example, or may be dynamically or selectively controlled or otherwise influenced by control signals or command instructions transmitted or otherwise communicated from such an external or independent processing component. As indicated at block 416, the mixing apparatus may additionally scan the bio-tag label or labels, and send decimal information to the mixer controlling software; in this context, the decimal information may generally be related to, or indicative of, the specific container (such as a particular well of a multi-well plate) or medium coordinate location to which each bulk oligonucleotide is intended to be supplied.

As indicated at block 417, the control software, independently or in conjunction with data and instructions received from a processing component, may then translate the decimal and positional information into a runfile containing instructions for generating a particular bio-tag for a particular well, test tube, container, or location on a container medium. In accordance with some exemplary embodiments, and consistent with a computer executed, substantially automated procedure, the runfile may be embodied in or comprise binary data related to both the unique bio-tags generated and the desired or specified locations for the constituent oligonucleotides thereof.

The mixing apparatus may then execute the instructions contained in the runfile as illustrated at block 418. In accordance with the procedure represented at block 418, a specific and unique bio-tag comprising a selected number and combination of oligonucleotides may be created and deposited in a predetermined container or on a predetermined portion of a container substrate or medium. It will be appreciated that each oligonucleotide, in general, and the specific combination of oligonucleotides, in particular, deposited or provided in block 418 may be selected in accordance with the chemical properties and structural considerations set forth above in detail with specific reference to FIG. 1A and FIG. 1B. As indicated at block 419, one or more containers supporting or carrying newly-created bio-tag material may be unloaded from the mixing apparatus and stored, for example, for future use; alternatively, the containers may be used immediately or substantially immediately after bio-tag creation and employed to receive discrete samples as necessary or desired. It will be appreciated that the specific location of each unique bio-tag (i.e., in a particular well of a multi-well plate, for instance, or at a specified coordinate location on an array) may be recorded by the processing component, the mixing apparatus, or both, for future reference and to ensure that a particular sample stored or archived at that location may be properly associated with the bio-tag and later identified substantially as set forth above with particular reference to FIG. 1A and FIG. 1B.

FIG. 5 is a simplified flow diagram illustrating the general operation of one embodiment of a method of applying a bio-tag to a sample carrier. As with the method of FIG. 4, the operations depicted at each functional block depicted in FIG. 5 may be executed, controlled, or facilitated by a computer or other processing component encoded with appropriate data and instructions and operating in conjunction with automated or robotic devices.

As indicated at block 511, a prepared container in which bio-tag material is maintained, or a plurality of such containers, may be selectively retrieved as required or desired. In a semi-manual embodiment, an operator may retrieve one or more pre-mixed bio-tag multi-well plates or test tubes, for example, from an inventory; alternatively, retrieval may be entirely automated and executed responsive to control or command signals from the processing component. One or more retrieved bio-tag containers may be loaded into an appropriate apparatus or device, such as a spotting robot or other suitably programmed or dynamically controllable liquid handling machine. As set forth above, while various alternatives exist or may be developed, a Microlab Star liquid handler currently manufactured by and available from Hamilton Company may have particular utility in some applications.

As indicated at block 512, specific bio-tags may be identified (for example, in accordance with a particular well in a multi-well plate or a particular test tube in a rack or other array) and associated data may be recorded for further use; additionally or alternatively, data may be transmitted to control software or other programming scripts executing at the processing component. In accordance with some embodiments, the spotting robot or other automated liquid handler may scan a label or other identifying indicia on the bio-tag containers to facilitate identification thereof; as noted above with reference to FIG. 4, such indicia may be embodied in or comprise a conventional one- or two-dimensional barcode, though other identification strategies may be employed. In some fully automated implementations, various optical barcode readers or machine reading apparatus currently available may be suitable for such identification procedures.

As indicated at block 513, the control software application or computer readable instruction sets executing at the processing component (or under control thereof) may create a data record, for example, or update a data field in a data structure (such as a database, for example) maintained on a storage medium. Created or updated data records may be related specifically to the unique bio-tag intended to be used, and may accordingly be associated therewith when stored in the data structure. Specifically, the processing component may store or update one or more data records to represent the fact that a particular bio-tag identified (at block 512) is to be spotted (i.e., associated, contacted, attached, or otherwise used in conjunction, with a particular sample supporting medium) in subsequent operations.

In addition to storing data as set forth above, and as further indicated at block 513, the processing component may execute instructions operative to ensure that the bio-tag oligonucleotide combination has not been used before; in accordance with this determination, database records for the particular reference system or bio-tag code universe under consideration may be searched or queried for information regarding the identified bio-tag and its associated oligonucleotide combination. If an identified bio-tag has already been used in the reference system or bio-tag universe, an error message may halt the procedure and the processing component may seek operator input, for example, before proceeding; alternatively, a different or alternative bio-tag may be assigned dynamically by the processing component in sophisticated processing embodiments.

Upon confirmation that the bio-tag has not been used previously, data may be transmitted to a label printer (block 514), for example, or to another selected device depending upon system requirements and desired identification protocols. In accordance with the operation depicted at block 514, a label may be embodied in or comprise a one- or two-dimensional barcode or other identifying indicia specifying the intended respective location of each of a plurality of bio-tags in or on a sample carrier (e.g., a multi-well plate or other container, array, or substrate) to be prepared in subsequent operations. In particular, the label may comprise or incorporate coded data associating each bio-tag identified (block 512) and confirmed as available for use (block 513) with a specific and unique well of a multi-well plate to be spotted with a specific and unique bio-tag oligonucleotide combination, for example; alternatively, the coded data may associate each bio-tag with a specific coordinate location on an array or other substrate.

As indicated at block 515, the label created as set forth above may be applied to a sample carrier (i.e., a multi-well plate, array, or other substrate), either manually or automatically, for example, by a robotic apparatus under control of the processing component. In one exemplary embodiment, a sample carrier may comprise a 384 well plate containing FTA filter elements in each well. It will be readily appreciated that different types of plates (e.g., comprising a different number of wells) may also be used, and that different types of sample support media may be employed in addition to, or in lieu of, FTA filter elements. While the following description addresses a multi-well plate for clarity, a sample carrier may also be embodied in or comprise arrays or other substrates having unique, addressable locations disposed thereon or integrated therewith as described above with reference to FIG. 3A.

It will be appreciated that each well in the plate (containing only unspotted and unused filter elements) may not have been unique prior to application of the label, which associates each respective well with a respective unique bio-tag oligonucleotide combination as set forth above. In accordance with such an embodiment, a respective bio-tag may be associated with each respective (otherwise unused) well in the multi-well plate; samples subsequently added to a specific well may be identified in accordance with the bio-tag associated with the well which also contains the sample. In some alternative embodiments in which each well of the multi-well plate already contains a discrete sample, the bio-tag may be associated with the sample as well as the specific location of the well on the plate.

In accordance with the foregoing, an aliquot (such as a 5 μL volume, for example) containing a respective bio-tag solution or compound (i.e., including a unique oligonucleotide combination) may be applied to the filter element, substrate material, or other sample support media contained in each respective well, or to each respective location on a given sample carrier. This application, indicated at block 516, may be performed by any suitable liquid handling apparatus under control of the processing component. In the case where the sample support media has not been contacted with sample material prior to application of the bio-tag solution or compound, each particular location on the sample carrier may now be coded (i.e., associated with an identifying bio-tag) and ready for reception of a discrete sample. As noted above, if the sample carrier already contained discrete samples at identifiable locations, data associated with each respective sample may further be associated with the bio-tag delivered to each respective well.

As indicated at block 517, the spotted sample carrier may be removed from the liquid handler, sealed to prevent contamination in accordance with system requirements or other handling protocols, and delivered, for example, to an inventory or archive facility for storage. As contemplated herein, the operations depicted at block 517 may be executed or facilitated, in whole or in part, by automated handling apparatus or robotic devices operating under control of the processing component such as set forth above. Additionally or alternatively, the spotted sample carrier (appropriately sealed) may be shipped to a third party for additional operations.

The specific arrangement and organization of functional blocks depicted in FIG. 4 and FIG. 5 are not intended to imply a specific order or sequence of operations to the exclusion of other possibilities. For example, the operations illustrated in blocks 511 and 512 may be reversed, or may be performed substantially simultaneously; similarly, the operations depicted at blocks 413 and 414, as well as those depicted at blocks 515 and 516, may be reversed or performed substantially simultaneously. In some embodiments, some operations from both FIG. 4 and FIG. 5 may be selectively combined or omitted in accordance with desired system functionality; for example, the operations depicted at blocks 418 and 516 may be combined such that selected components of the bio-tag solution or compound may be provided directly to a selected portion of a sample carrier as set forth above. Those of skill in the art will appreciate that the specific sequence of operations may be susceptible of various modifications depending, for example, upon myriad factors including, but not limited to, the following: the capabilities and processing bandwidth of the processing component; sophistication and flexibility of the programming instructions executing at the processing component; capabilities and limitations of the liquid handling apparatus and other automated equipment controlled or influenced by the processing component and system software; specific chemistries of the oligonucleotide combinations; desired throughput rates; and other considerations.

Further, in accordance with some exemplary embodiments described above, identifier oligonucleotides may be employed to facilitate bio-tag coding and identification of samples. In cases where each identifier oligonucleotide is immobilized, for instance, at a predetermined or otherwise known location or position on a substrate (e.g., an array), computer executed methods of identifying samples may have particular utility in conjunction with various techniques employed to detect specific hybridization or otherwise to analyze the substrate. For example, identifier oligonucleotides on an array can have a pattern or a configuration such that hybridization results may readily be employed to ascertain which code oligonucleotides are present in an otherwise unknown bio-tagged sample.

Specifically, samples coded with a unique combination of oligonucleotides may be made to contact a substrate (i.e., an array) that includes such identifier oligonucleotides in particular locations and in a predetermined configuration or arrangement, for example. Following contacting with the coded sample, identifier oligonucleotides that specifically hybridize to their complementary code oligonucleotides present in the sample may be detected at particular locations known to correspond to specific identifier oligonucleotides. In the foregoing manner, the code for the bio-tagged sample may be identified or “decoded” based upon which oligonucleotides are present (i.e., those which hybridize with complementary identifier oligonucleotides) and which oligonucleotides are absent (i.e., those which do not hybridize with complementary identifier oligonucleotides). Automated or computer controlled apparatus may be employed to read or otherwise to acquire data from the substrate such that the bio-tagged sample may be identified as set forth above.

Accordingly, a computer executed method of identifying a bio-tagged sample may generally comprise: detecting specific hybridization between a code oligonucleotide and a respective identifier oligonucleotide maintained at a predetermined location on a substrate (such as, for example, an array or bio chip); identifying one or more code oligonucleotides that are present in the bio-tagged sample in accordance with the detecting; comparing the code oligonucleotides present in the bio-tagged sample to data records associating unique oligonucleotide combinations with unique samples; and identifying the bio-tagged sample responsive to the comparing. In some embodiments, the detecting comprises analyzing a hybridization on a substrate having two or more identifier oligonucleotides immobilized at pre-determined positions thereon, wherein the identifier oligonucleotides each have a sequence that is distinct from a sequence present in all other identifier oligonucleotides, and wherein the identifier oligonucleotides are of sufficient number to specifically hybridize to every code oligonucleotide potentially present in the sample. As described in detail above, a substrate having utility in such applications may comprise a plurality of nucleic acid samples immobilized at predetermined positions on the substrate which do not specifically hybridize to code oligonucleotides to the extent that such hybridization prevents code identification.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described herein.

All publications, patents and other references cited herein are incorporated by reference in their entirety. In case of conflict, the present specification, including definitions, will control.

As used herein, the singular forms “a”, “and,” and “the” include plural referents unless the context clearly indicates otherwise. Thus, for example, reference to “an oligonucleotide or a primer or a sample” includes a plurality of such oligonucleotides, primers and samples, and reference to “an oligonucleotide set” or “a primer set” includes reference to one or more oligonucleotide or primer sets, and so forth.

The invention set forth herein is described with affirmative language. Therefore, even though the invention is generally not expressed herein in terms of what the invention does not include, aspects that are not expressly included in the invention are nevertheless inherently disclosed herein.

A number of embodiments of the invention have been described. Nevertheless, it will be understood that various modifications may be made without departing from the spirit and scope of the invention. Accordingly, the following examples are intended to illustrate but not limit the scope of invention described in the claims.

### EXAMPLES

### Example 1

As a non-limiting illustration of the invention, from a pool of 25 oligonucleotides, each oligonucleotide having a different sequence in order to avoid specific hybridization with other oligonucleotides, and each oligonucleotide having a different length (in this example, five lengths: 60, 70, 80, 90 and 100 nucleotides), nine are added to a sample. The nine oligonucleotides added to the sample (the “code”) are recorded and the code optionally stored in a database. The oligonucleotide code is developed using primer pairs that specifically hybridize to each oligonucleotide that is present. In this particular illustration, there are 25 oligonucleotides possible and 5 sets of primer pairs (denoted primer Sets 1-5). Each set of primer pairs specifically hybridize to 5 oligonucleotides and, therefore, by using 5 primer sets, all 25 oligonucleotides potentially present in the sample are identified. In this illustration, the nine oligonucleotides present in the sample which specifically hybridize to a corresponding primer pair are identified by polymerase chain reaction (PCR) based amplification. In contrast, because the other 16 oligonucleotides are absent from the sample these oligonucleotides will not be amplified by the primers that specifically hybridize to them. Thus, differential primer hybridization among the different oligonucleotides is used to identify which oligonucleotides, among those possibly present, that are actually present in the sample.

Following PCR, the 5 reactions containing amplified products, which in this illustration reflect both the oligonucleotide length and the sequence of the region that hybridizes to the primers, are size-fractionated via gel electrophoresis: each reaction representing one primer set is fractionated in a single lane for a total of 5 lanes (Sets 1-5, which correspond to FIG. 1, lanes 2-6, respectively). The developed “bar-code” in this illustration is the pattern of the fractionated amplified products in each lane. In this illustration, the 60, 70, 80, 90 and 100 base oligonucleotides correspond to code numbers 1, 2, 3, 4 and 5, respectively, and the bar code is read beginning with lane 2, from top to bottom, and each lane thereafter, 534523151 (FIG. 1A). Alternatively, the bar-code may be designated as a binary number, where each of the 25 possible oligonucleotides at the 60, 70, 80, 90 and 100 positions in all 5 lanes is designated by a “1” or a “0” based upon the presence or absence, respectively, of the oligonucleotide (amplified product) at that particular position. Thus, in FIG. 1A the corresponding binary number would read 10100 01000 10010 00101 10001.

In the exemplary illustration (FIG. 1 and FIG. 2) each primer set amplifies at least one oligonucleotide. However, because not all oligonucleotides need be present, oligonucleotides for a given primer set may be completely absent. That is, a code where an oligonucleotide is absent is designated by a “0.” Thus, for example, where there is no oligonucleotide present that specifically hybridizes to a primer pair in primer set #2, the code would read: 530523151 (FIG. 1B), and the corresponding binary number for lane 2 would be “0” at each position, which would read 10100 00000 10010 00101 10001.

In order to develop the “code” in the exemplary illustration (FIG. 1 and FIG. 2), every primer pair that specifically hybridizes to every oligonucleotide from the pool of 25 oligonucleotides is used in the amplification reactions. The initial screen for which oligonucleotides are actually present in the sample is therefore based upon differential primer hybridization and subsequent amplification of the oligonucleotide(s) that hybridizes to a corresponding primer pair. Thus, every one of the 25 oligonucleotides potentially present in the sample can be identified because all primer pairs that specifically hybridizes to all oligonucleotides are used in the screen. In the illustration, five primer sets are used, each primer set containing 5 primer pairs. Five separate reactions were performed with the 5 primer pairs in each primer set to amplify all 25 oligonucleotides. Thus, although primer pair may be present in any given reaction, if the oligonucleotide that specifically hybridizes to the primer pair is absent from that reaction, the oligonucleotide will not be amplified.

Following the reactions, the oligonucleotides (amplified products) are differentiated from each other based upon differences in their length. Thus, in the context of developing the code, oligonucleotides comprising the code need not be subject to sequencing analysis in order to identify or distinguish them from one another. Accordingly, the invention does not require that the oligonucleotides comprising the code be sequenced in order to develop the code.

In the exemplary illustration (FIG. 1 and FIG. 2), the “code” is developed by dividing the sample containing the oligonucleotides into five reactions and separately amplifying the reactions with each primer set. For example, a coded sample that is applied or attached to a substrate (e.g., a small 3 mm diameter matrix) can be divided into 5 pieces and the amplification reactions performed on each of the 5 pieces of substrate, each reaction having a different primer set. Optionally, the oligonucleotides could first be eluted from the substrate and the eluent divided into five separate reactions. As an alternative approach to separate reactions, the substrate can be subjected to 5 sequential reactions with each primer set. For example, if the oligonucleotide code is applied or attached to a substrate the code can be developed by performing 5 sequential amplification reactions on the substrate, and removing the amplified products after each reaction before proceeding to the next reaction. The amplified products from each of the 5 sequential reactions are then fractionated separately to develop the code.

If desired fewer oligonucleotides can be used, optionally in a single dimension. A set of oligonucleotides or amplified products can be fractionated in a single dimension, e.g., one lane. For example, where a large number of unique codes is not anticipated to be needed 2, 3, 4, 5, 6, 7, 8, 9, 10, etc. oligonucleotides can be a code in a single lane format. A corresponding single primer set would therefore include 2, 3, 4, 5, 6, 7, 8, 9, 10, etc. numbers of unique primer pairs in order to detect/identify the 2, 3, 4, 5, 6, 7, 8, 9, 10, oligonucleotides, respectively, that may be present. Given sufficient resolving power of the separation system, essentially there is no upper limit to the number of oligonucleotides that can be separated in one dimension. Thus, there may be 10-15, 15-20, 20-25, 25-30, 30-35, 35-40, 40-45, 45-50, etc., or more oligonucleotides that may be separated in a single dimension. Accordingly, invention compositions can contain unlimited numbers of oligonucleotides in one or more oligonucleotide sets. A given primer set therefore also need not be limited; the number of primer pairs in a primer set will reflect the number of oligonucleotides desired to be amplified, e.g., 10-15, 15-20, 20-25, 25-30, 30-35, 35-40, 40-45, 45-50, etc., or more oligonucleotides.

The coding oligonucleotide sets can be designated according to the primer sets used to amplify them. Thus, in the exemplary illustration (FIG. 1 and FIG. 2), primer set #1 amplifies oligonucleotide set #1; primer set #2 amplifies oligonucleotide set #2; primer set #3 amplifies oligonucleotide set #3; primer set #4 amplifies oligonucleotide set #4; primer set #5 amplifies oligonucleotide set #5; primer set #6 amplifies oligonucleotide set #6; primer set #7 amplifies oligonucleotide set #7; primer set #8 amplifies oligonucleotide set #8, primer set #9 amplifies oligonucleotide set #9; primer set #10 amplifies oligonucleotide set #10, etc.

In this illustration, primer set #1 amplified products (oligonucleotides) are size-fractionated in lane 2, primer set #2 amplified products (oligonucleotides) are size-fractionated in lane 3, primer set#3 amplified products (oligonucleotides) are size-fractionated in lane 4, primer set#4 amplified products (oligonucleotides) are size-fractionated in lane 5, and primer set#5 amplified products (oligonucleotides) are size-fractionated in lane 6 (FIG. 1). However, amplified products need not be fractionated in any particular lane in order to obtain the correct code, provided that the primers used to produce the amplified products are known and the reactions are separately fractionated. That is, by knowing which primers are used in the amplification reaction, e.g., primer set #1 specifically hybridizes to and amplifies oligonucleotides of set #1, the amplified products and, therefore, the oligonucleotides detectable are also known. Thus, amplified products can be fractionated in any order (lane) since the primers that specifically hybridize to particular oligonucleotides are known. For example, if the correct code is obtained by reading the amplified products from primer sets #1-#5 in order, but the primer sets are fractionated out of order, (e.g., primer set #1 is run in lane 2 and primer set #2 is run in lane 1) the code can be corrected by merely reading lane 2 (primer set #1) before lane 1 (primer set #2). Accordingly, amplified products can be fractionated in any order to develop the code because they can be “read” to correspond with the order of the primer set that provides the correct code.

In the exemplary illustration (FIG. 1 and FIG. 2), oligonucleotides amplified with primer sets #1-5 are separately size fractionated in 5 lanes to develop the code (FIG. 1, five lanes, beginning with primer set #1 in lane 2). Even though an invention code can be employed in which oligonucleotides are fractionated in a single lane following amplification with one primer set, using multiple primer sets and fractionating oligonucleotides in multiple lanes provides a more convenient format and expands the number of unique codes available within that format in comparison to fractionating in a single dimension (one lane). The number of different code combinations can be represented as 2^{n(m)}, where “n” represents the number of oligonucleotides per lane and “m” represents the number of lanes. Thus, in this exemplary illustration, 25 oligonucleotides in a 5×5 format (5 oligonucleotides per lane in 5 lanes) provides 2²⁵ different code combinations, or 33,554,432 codes. In contrast, 5 oligonucleotides in a 5×1 format (5 oligonucleotides in one lane) provides 2⁵ different code combinations, or 32 codes.

In the exemplary illustration (FIG. 1 and FIG. 2) the amplified products fractionated in a single lane (one set of oligonucleotides corresponding to one primer set) are physically or chemically different from each other (e.g., have a different length, charge, solubility, diffusion rate, adsorption, or label) in order to be distinguished from each other. Thus, in addition to increasing the number of available codes, an advantage of fractionating in multiple lanes is that the oligonucleotides or amplified products fractionated in different lanes can have one or more identical physical or chemical characteristics yet still be distinguished from each other. For example, using two dimensions allows oligonucleotides in different sets to have the same length since each set is separately fractionated from the other set(s) (e.g., each set is fractionated in a different lane). Furthermore, each oligonucleotide can have the same sequence. As the number of oligonucleotides fractionated in a given lane increase, a broader size range for the oligonucleotides in order to fractionate them and, consequently, greater resolving power of the fractionation system may be needed in order to develop the code. Thus, where length is used to distinguish between the oligonucleotides within a given set, because the oligonucleotides in different sets can have identical lengths, the oligonucleotides used for the code can have a narrower size range and be fractionated with comparatively less resolving power. The use of multiple dimensions for size fractionation is also more convenient than one dimension since fewer primers are present in a given reaction mix.

A third dimension could be added in order to expand the code. Adding a third dimension would expand the number of codes available to 2^{(m)n(p)}, where “p” represents the third dimension. Thus, adding a third dimension to a 5×5 format as in the exemplary illustration (FIG. 1 and FIG. 2), 2^{25(p)} different unique codes are available. One example of a third dimension could be based upon isoelectric point or molecular weight. For example, a unique peptide tag could be added to one or more of the oligonucleotides and the code fractionated using isoelectric focusing or molecular weight alone, or in combination, e.g. 2D gel electrophoresis.

The code can include additional information. For example, a code can include a check code. By using the number of oligonucleotides in each lane a check can be embedded with the code. For example, in FIG. 1A, lanes 2-6 have 2, 1, 2, 2 and 2 oligonucleotides, respectively. The check code in this case would be 21222. For FIG. 1B, the check code would be 20222.

The code output can be “hashed,” if desired, so that the code loses any characteristics that would allow it to be traced back to the original sample or the patient that provided the sample. For example, each number in 534523151 could be increased or decreased by one, 645634262 and 423-412040, respectively.

Suitable positive and negative controls, for example, target and non-target oligonucleotides or other nucleic acid can be tested for amplification with a particular primer pair to ensure that the primer pair is specific for the target oligonucleotide. Thus, the target oligonucleotide, if present, is amplified by the primer pair whereas the non-target oligonucleotides, non-target primers or other nucleic acid are not amplified to the extent they interfere with developing the code. False negatives, i.e., where an oligonucleotide of the code is present but not detected following amplification, can be detected by correlating the oligonucleotides of the code that are detected with the various codes that are possible. For example, a gel scan of the correct code(s) can be provided to the end user in order to allow the user to match the code detected with one of the gel scan codes. Where the end user is dealing with a limited number of codes, even if one or a few oligonucleotides are not detected, the correct code can readily be identified by matching the detected code with the gel scan of the possible codes that may be available, particularly where the number of available codes possible is large. More particularly for example, an end user requests 10 coded samples from an archive for sample analysis. The coded samples are retrieved from the archive and forwarded to the end user who subsequently analyzes the samples. In order to ensure that a particular sample subsequently analyzed corresponds to the sample received from the archive, the end user then wishes to determine the code for that sample. However, one of the oligonucleotides of the code in that sample is not detected during the analysis of the code, producing an incomplete code. Because the codes for all samples forwarded to the end user are known, the incomplete code can be fully completed based on the code to which the incomplete code most closely corresponds. Alternatively, all codes received by the end user could be developed and, by a process of elimination the incomplete code is developed.

Exemplary PCR conditions used for specific hybridization and subsequent amplification for developing the exemplary code (FIG. 1 and FIG. 2) are as follows: Buffer (1×): 16 mM (NH₄)₂SO₄, 67 mM Tris-HCl (pH 8.8 at 25 C.), 0.01% Tween 20, 1.5 mM MgCl₂; dNTP: 200 μM each; primer concentration: 62.5 mM of each primer (all 5 primer pairs present in each reaction); enzyme: 2 units of Biolase (Taq; Bioline, Randolph, Mass.); PCR cycling conditions: 93° C. for 2 minutes, 55° C. for 1 minute, 72° C. for 2 minutes, followed by 29 cycles of 93° C. for 30 seconds, 55° C. for 30 seconds, 72° C. for 45 seconds. Conditions that vary from the exemplary conditions include, for example, primer concentrations from about 20 mM to 100 nM; enzyme from about 1 unit to 4 units; PCR Cycling conditions, annealing temperatures from about 49° C.-59° C., and denaturing, annealing, and elongation time from about 30 seconds-2 minutes. Of course, the skilled artisan recognizes that the conditions will depend upon a number of factors including, for example, the number of oligonucleotides and primers used, their length and the extent of complementarity. Those skilled in the art can determine appropriate conditions in view of the extensive knowledge in the art regarding the factors that affect PCR (see, e.g., Molecular Cloning: A Laboratory Manual 3.sup.rd ed., Joseph Sambrook, et al., Cold Spring Harbor Laboratory Press; (2001); Short Protocols in Molecular Biology 4.sup.th ed., Frederick M. Ausubel (ed.), et al., John Wiley & Sons; (1999); and PCR (Basics: From Background to Bench) 1^{st} Ed., M. J. McPherson et al., Springer Verlag (2000)).

### Example 2

This example describes an exemplary code using 50, 75 and 100 base oligonucleotides in a single set. Oligonucleotides comprising the code and corresponding primers were designed by selecting a non-human gene from Genbank—Arabidopsis thaliana lycopene beta cyclase, accession number U50739, and using the Primer 3 (available from the Human Genome Project) with default settings. In order to multiplex the primers in one reaction, the primer pairs were selected from the output of Primer 3 to have a similar melting temperature. To ensure that the sequences selected do not have a significant match to the reported human genes and EST sequences, a Blast (available from NCBI) comparison was preformed against Genbank's non-redundant (nr) database. Oligonucleotide and primer sequences were as follows:

50 bp oligonucleotide
PCR primer #1

(SEQ ID NO: 1)

5′ TCCATCTCCATGAAGCTACT 3′
PCR primer #2

(SEQ ID NO: 2)

5′ ATGAACGAAGACCACAAAAC 3′
Oligonucleotide sequence

(SEQ ID NO: 3)

5′ CCATCTCCATGAAGCTACTGCTTCTGGGTAAGTTTTGTGGTCTTCGT
TCAT 3′
75 bp oligonucleotide
PCR primer #1

(SEQ ID NO: 4)

5′ GTGTCAAGAAGGATTTGAGC 3′
PCR primer #2

(SEQ ID NO: 5)

5′ TTTCTGAAGCATTTTGGATT 3′
Oligonucleotide sequence

(SEQ ID NO: 6)

5′ GTGTCAAGAAGGATTTGAGCCGGCCTTATGGGAGAGTTAACCGGAAA
CAGCTCAAATCCAAAATGCTTCAGAAA 3′
100 bp oligonucleotide
PCR primer #1

(SEQ ID NO: 7)

5′ TCTGAAGCTGGACTCTCTGT 3′
PCR primer #2

(SEQ ID NO: 8)

5′ AATCCATAGCCTCAAACTCA 3′
Oligonucleotide sequence

(SEQ ID NO: 9)

5′ TCTGAAGCTGGACTCTCTGTTTGTTCCATTGATCCTTCTCCTAAGCT
CATATGGCCTAACAATTATGGAGTTTGGGTTGATGAGTTTGAGGCTATGG
ATT 3′

The oligonucleotides were applied to the media in solution. A solution is made up of the desired combination of oligonucleotides at a concentration of 0.1 uM each. Three microliters of the solution is then applied to the media (FTA or Iso-Code) and allowed to dry, either at room temperature or in a desiccator at room temperature.

PCR was performed on different mixtures of the 50 bp, 75 bp, and 100 by oligonucleotides. The PCR reaction mixture contained: 16 mM (NH₄)₂SO₄, 67 mM Tris-HCl (pH 8.8 at 25 C), 0.01% Tween 20, 1.5 mM MgCl₂, 200 μM each dNTP (Bioline, Randolph, Mass.), 0.1 μM of each primer (all three primer pairs were present in each reaction), and 2 units of Biolase (Bioline, Randolph, Mass.). The PCR cycling conditions were as follows: 93° C. for 2 minutes, 55° C. for 1 minute, 72° C. for 2 minutes, followed by 25 cycles of 93° C. for 30 seconds, 55° C. for 30 seconds, 72° C. for 45 seconds.

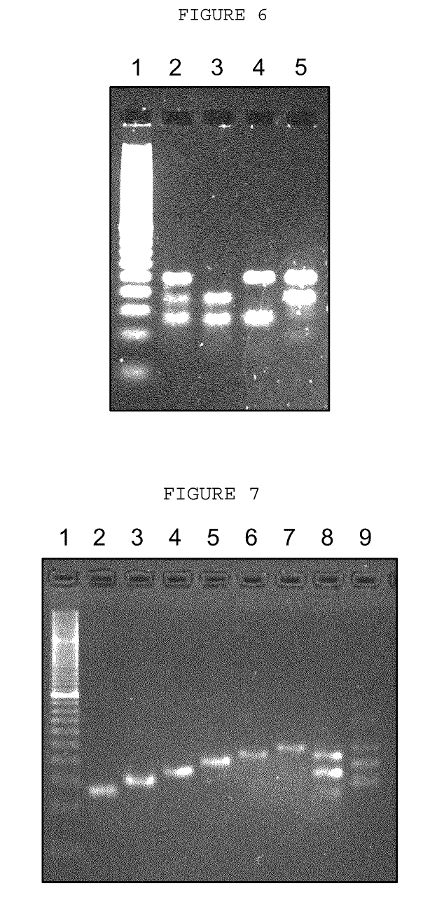

The PCR products were analyzed on a 3% agarose gel in 1×TBE, run for 1 hour at 150V. An image of the resulting gel is shown in FIG. 6. Lane 1 is 20 by ladder by Apex (DocFrugal Scientific, La Jolla, Calif.); lane 2 contains 0.1 μM of each of the three oligonucleotides; lane 3 contains 0.1 μM of the 50 by and 75 by oligonucleotides; lane 4 contains 0.1 μM of the 50 by and 100 by oligonucleotides; and lane 5 contains 0.1 μM of the 75 by and 100 by oligonucleotides.

An oligonucleotide set having 50, 60, 70, 80, 90, and 100 base oligonucleotides was also designed. Oligonucleotide and primer sequences were as follows (the 50 and 100 base oligonucleotides and corresponding primers were as described above):

60 bp oligonucleotide
PCR primer #1

(SEQ ID NO: 10)

5′ GGCTATTGTTGGTGGTGGTC 3′
PCR primer #2

(SEQ ID NO: 11)

5′ TCCAGCTTCAGAAACCTGCT 3′
Oligonucleotide sequence

(SEQ ID NO: 12)

5′ GCTATTGTTGGTGGTGGTCCTGCTGGTTTAGCCGTGGCTCAGCAGGT
TTCTGAAGCTGGA 3′
70 bp oligonucleotide
PCR primer #1

(SEQ ID NO: 13)

5′ CAAACTCCACTGTGGTCTGC 3′
PCR primer #2

(SEQ ID NO: 14)

5′ AACCCAGTGGCATCAAGAAC 3′
Oligonucleotide sequence

(SEQ ID NO: 15)

5′ AAACTCCACTGTGGTCTGCAGTGACGGTGTAAAGATTCAGGCTTCCG
TGGTTCTTGATGCCACTGGGTT 3′
80 bp oligonucleotide
PCR primer #1

(SEQ ID NO: 16)

5′ TGGTGTTCATGGATTGGAGA 3′
PCR primer #2

(SEQ ID NO: 17)

5′ GAACGTTGGGATCTTGCTGT 3′
Oligonucleotide sequence

(SEQ ID NO: 18)

5′ TGGTGTTCATGGATTGGAGAGACAAACATCTGGACTCATATCCTGAG
CTGAAGAACGGAACAGCAAGATCCCAACGTTC
90 bp oligonucleotide
PCR primer #1

(SEQ ID NO: 19)

5′ GGGGATCAATGTGAAGAGGA 3′
PCR primer #2

(SEQ ID NO: 20)

5′ CCACAACCCGTTGAGGTAAG 3′
Oligonucleotide sequence

(SEQ ID NO: 21)

5′ GGGGATCAATGTGAAGAGGATTGAGGAAGACGAGCGTTGTGTGATCC
CGATGGGCGGTCCTTTACCAGTCTTACCTCAACGGGTTGTGG 3′

This additional set of oligonucleotides was analyzed by PCR as described above and the results are shown in FIG. 7. Lane 1 is the 20 by ladder by Apex (DocFrugal Scientific, La Jolla, Calif.); lane 2 contains 0.1 μM of a 50 by oligonucleotide; lane 3 contains 0.1 μM of a 60 by oligonucleotide; lane 4 contains 0.1 μM of a 70 by oligonucleotide; lane 5 contains 0.1 μM of a 80 by oligonucleotide; lane 6 contains 0.1 μM of a 90 by oligonucleotide; lane 7 contains 0.1 μM of a 100 by oligonucleotide; lane 8 contains 0.1 μM of each of the 50, 70, and 90 by oligonucleotides; and lane 9 contains 0.1 μM of each of the 60, 80, and 100 by oligonucleotides.

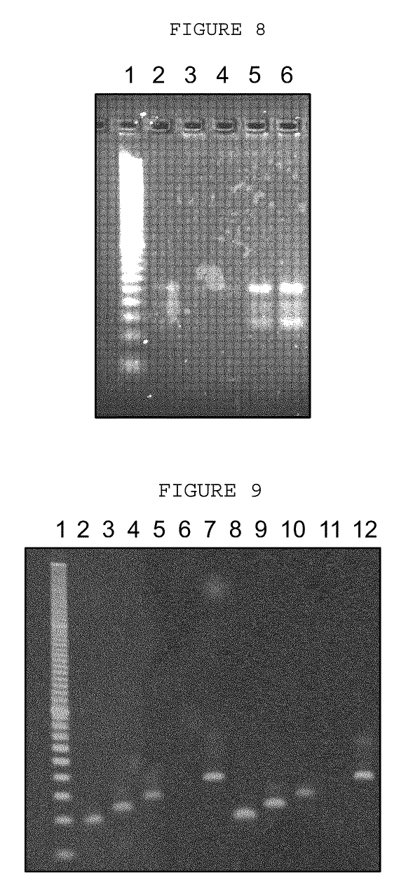

The 50, 75, 100 base oligonucleotide set was also analyzed by PCR after being mixed with human blood on FTA™ paper and Iso-Code™ paper, as shown in FIG. 8. Lane 1 is the 20 by ladder by Apex (DocFrugal Scientific, La Jolla, Calif.). Lanes 2-6 are 10 μL of a PCR reaction containing the three primer pairs. Lane 2 is a no template control. The templates for the remaining lanes are as follows: lane 3 is a 3 mm circle of FTA™ paper that contains human blood; lane 4 is a 3 mm circle of Iso-Code™ paper that contains human blood; lane 5 is a 3 mm circle of FTA™ paper that contains both human blood and 50, 75, and 100 by oligonucleotides; and lane 6 is a 3 mm circle of FTA™ paper that contains both human blood and 50, 75, and 100 by oligonucleotides.

### Example 3

This example describes an exemplary code using 50, 60, 70, 80, 90 and 100 base oligonucleotides in two sets. Set #2 was designed from the Arabidopsis thaliana At3g59020 mRNA sequence, while set #3 was designed from the Arabidopsis thaliana At5g18620 mRNA sequence. Oligonucleotide and primer sequences were as follows:

Set #2
50 bp oligonucleotide
PCR primer #1

(SEQ ID NO: 22)

5′ GCACCCATTCACCGAGTAGT 3′
PCR primer #2

(SEQ ID NO: 23)

5′ ATGTTCAACAGGTGGGGAAA 3′
Oligonucleotide sequence

(SEQ ID NO: 24)

5′ GCACCCATTCACCGAGTAGTCGAGGAGACTTTTCCCCACCTGTTGAA
CAT 3′
60 bp oligonucleotide
PCR primer #1

(SEQ ID NO: 25)

5′ CAGTTTTTGCTTTGCGTTCA 3′
PCR primer #2

(SEQ ID NO: 26)

5′ CTGGGCGGATTTCATCTAAA 3′
Oligonucleotide sequence

(SEQ ID NO: 27)

5′ CAGTTTTTGCTTTGCGTTCATTTATTGAAGCCTGCAAAGATTTAGAT
GAAATCCGCCCAG 3′
70 bp oligonucleotide
PCR primer #1

(SEQ ID NO: 28)

5′ TCAAGTGCCTTCTGGTTGAA 3′
PCR primer #2

(SEQ ID NO: 29)

5′ AGTATGCCAAGTGCCAAAGG 3′
Oligonucleotide sequence

(SEQ ID NO: 30)

5′ TCAAGTGCCTTCTGGTTGAAGTGGTTGCAAATGCCTTTTACTACAAT
ACCCCTTTGGCACTTGGCATACT 3′
80 bp oligonucleotide
PCR primer #1

(SEQ ID NO: 31)

5′ TCGACACTGACAACGGTGAT 3′
PCR primer #2

(SEQ ID NO: 32)

5′ GGTACTGATGGCACGGAGAC 3′
Oligonucleotide sequence

(SEQ ID NO: 33)

5′ TCGACACTGACAACGGTGATGATGAAACTGATGATGCTGGTGCATTG
GCTGCAGTGGGATGTCTCCGTGCCATCAGTACC 3′
90 bp oligonucleotide
PCR primer #1

(SEQ ID NO: 34)

5′ CGAGTCTCGTCGATTTCCTC 3′
PCR primer #2

(SEQ ID NO: 35)

5′ TTAAAGCGAGGCTAGGCAGA 3′
Oligonucleotide sequence

(SEQ ID NO: 36)

5′ CGAGTCTCGTCGATTTCCTCCGGGAGGAGACTTGAAATTCGTGACTT
TCCGATTGTGAATTCCCCGATGGATCTGCCTAGCCTCGCTTTAA 3′
100 bp oligonucleotide
PCR primer #1

(SEQ ID NO: 37)

5′ GTCTCCGTGCCATCAGTACC 3′
PCR primer #2

(SEQ ID NO: 38)

5′ AGCATTTTCCGCATTATTGG 3′
Oligonucleotide sequence

(SEQ ID NO: 39)

5′ GTCTCCGTGCCATCAGTACCATTCTTGAATCTATCAGTGTCTCCCTC
ATCTTTATGGTCAGATTGAACCACAGTTACTGCCAATAATGCGGAAAATG
CT 3′
Set #3
50 bp oligonucleotide
PCR primer #1

(SEQ ID NO: 40)

5′ TGTCTCTGACGACGAGGTTG 3′
PCR primer #2

(SEQ ID NO: 41)

5′ CGTCCTCTTCAGCGTCATCT 3′
Oligonucleotide sequence

(SEQ ID NO: 42)

5′ TGTCTCTGACGACGAGGTTGTCCCCGTAGAAGATGACGCTGAAGAGG
ACG 3′
60 bp oligonucleotide
PCR primer #1

(SEQ ID NO: 43)

5′ GGAGAACGCAAACGTCTGTT 3′
PCR primer #2

(SEQ ID NO: 44)

5′ AAGGGTGATTGCAGCATTTC 3′
Oligonucleotide sequence

(SEQ ID NO: 45)

5′ GGAGAACGCAAACGTCTGTTGAACATAGCAATGCATTGCGGAAATGC
TGCAATCACCCT 3′
70 bp oligonucleotide
PCR primer #1

(SEQ ID NO: 46)

5′ AGGAACCCTCGATTCGATCT 3′
PCR primer #2

(SEQ ID NO: 47)

5′ TCGAAGCTCTAGCCATCGAC 3′
Oligonucleotide sequence

(SEQ ID NO: 48)

5′ AGGACCCTCGATTCGATCTCTCAGACGAAATCAGGATTCGTAGAGGC
GCGTCGATGGCTAGAGCTTCGA 3′
80 bp oligonucleotide
PCR primer #1

(SEQ ID NO: 49)

5′ CCCTCGATTCGATCTCTCAG 3′
PCR primer #2

(SEQ ID NO: 50)

5′ GAAGAAACTTCCCGCTTCG 3′
Oligonucleotide sequence

(SEQ ID NO: 51)

5′ CCTCGATTCGATCTCTCAGACGAAATCAGGATTCGTAGAGGCGCGTC
GATGGCTAGAGCTCGAAGCGGGAAGTTTCTTC 3′
90 bp oligonucleotide
PCR primer #1

(SEQ ID NO: 52)

5′ CAGCAAACGTGAGAAGGCTA 3′
PCR primer #2

(SEQ ID NO: 53)

5′ TGGAAGCATTTTGGGAGTCT 3′
Oligonucleotide sequence

(SEQ ID NO: 54)

5′ CAGCAAACGTGAGAAGGCTAGACTCAAAGAAATGCAGAAGATGAAGA
AGCAGAAAATTCAGCAAATCTTAGACTCCCAAAATGCTTCCA 3′
100 bp oligonucleotide
PCR primer #1

(SEQ ID NO: 55)

5′ GCCGATTTTGTCCTGTCCT 3′
PCR primer #2

(SEQ ID NO: 56)

5′ ATGTCGAATTTCCCTGCAAC 3′
Oligonucleotide sequence

(SEQ ID NO: 57)

5′ GCCGATTTTGTCCTGTCCTGCGTGCTGTGAAATTTCTCGGTAATCCC
GAGGAAAGAAGACATATTCGTGAAGAACTGCTAGTTGCAGGGAAATTCGA
CAT 3′

The oligonucleotides of Set #2 and Set #3 were amplified by PCR. With each set of primers being separated by 10 bases, a 6% polyacrylamide gel was employed (Invitrogen, Carlsbad). The PCR reaction conditions and the amount of oligonucleotide were as described above. The corresponding PCR primer concentration was reduced from 0.1 uM per reaction to 0.05 uM. The results for Set #2 are shown in FIG. 9. Lane 1 is the 20 by ladder by Apex (DocFrugal Scientific, La Jolla, Calif.). Lanes 2-7 each contain all 5 primer pairs from Set #2 but only 1 of the oligonucleotides from the set. Lanes 8-12 each contain only 1 set of primer pairs from Set #2, but all 5 of the Set #2 oligonucleotides.

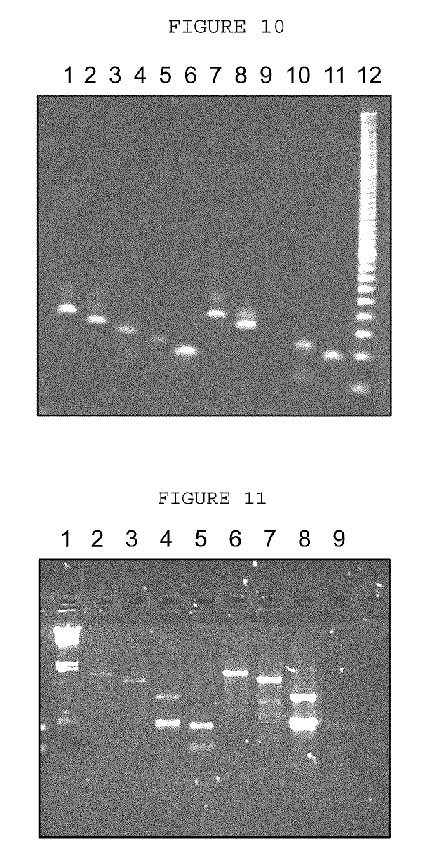

Likewise, the results for Set #3 are shown in FIG. 10. Lane 1 is the 20 by ladder by Apex (DocFrugal Scientific, La Jolla, Calif.). Lanes 7-11 each contain all 5 primer pairs from Set #3 but only 1 of the oligonucleotides from the set. Lanes 1-6 each contain only 1 set of primer pairs from Set #3, but all 5 of the Set #3 oligonucleotides.

### Example 4

### Enhancement of PCR with the Presence of the Bio-Tag

The addition of oligonucleotides to the matrix prior to the addition of blood enhances the amount of PCR yield. The oligonucleotide code is applied to the matrix and allowed to dry completely prior to the addition of blood. FIG. 11 shows the results of β-actin amplification from blood samples applied to matrix alone or matrix that had oligonucleotides pre-applied. PCR was performed and analyzed as described above, using the β-actin primers described below. The PCR cycling conditions were: 93° C. for 2 minutes, 55° C. for 1 minute, 72° C. for 2 minutes, followed by 25 cycles of 93° C. for 45 seconds, 55° C. for 45 seconds, 72° C. for 2 minutes. Lane 1 is a HindIII ladder (New England Biolabs, MD). Lanes 2 and 6 contain 10 μM of each of the full β-actin primers (2 kb). Lanes 3 and 7 contain 10 μM of each of the 1.5 kb β-actin primers. Lanes 4 and 8 contain 10 μM of each of the 1.0 kb β-actin primers. Lanes 5 and 9 each contain 10 μM of each of the 500 by β-actin primers. Lanes 2-4 do not contain any oligonucleotides; and lanes 5-9 contain 0.1 μM of the 50, 75, and 100 by oligonucleotides.

| | |
|---|---|
| β-actin Primers | |
| All reactions used the same #1: | |
| 5′ agcacagagcctcgccttt 3′ | (SEQ ID NO: 58) |
| 2 kb primer #2 | |
| 5′ GGTGTGCACTTTTATTCAACTGG 3′ | (SEQ ID NO: 59) |
| 1.5 kb primer #2 | |
| 5′ AGAGAAGTGGGGTGGCTTTT 3′ | (SEQ ID NO: 60) |
| 1.0 kb primer #2 | |
| 5′ AGGGCAGTGATCTCCTTCTG 3′ | (SEQ ID NO: 61) |
| 0.5 kb primer #2 | |
| 5′ AGAGGCGTACAGGGATAGCA 3′ | (SEQ ID NO: 62) |

### Example 5

This example describes particular inherent properties of certain embodiments of the invention. Inherent in the invention is the difficulty with which counterfeiters could identify and, therefore, reproduce the code. When using multiple (e.g., two or more) sets of oligonucleotides in which there is at least one oligonucleotide from the two sets having an identical length, it is impossible to reproduce the specific banding pattern created by the code without knowing the primers that specifically hybridize to the oligonucleotides. For example, although there are technologies that could provide the requisite sensitivity and resolution needed to visualize the bio-code on a gel without amplifying the oligonucleotides, this data would be worthless since there are at least two oligonucleotides having the same size in the code, which could not be size-differentiated in one dimension. Furthermore, although random primed PCR could be attempted to clone and sequence the oligonucleotides comprising the code, this would simply generate a ladder up to the largest oligonucleotide present in the particular mixture, not the correct code pattern. When the oligonucleotides comprising the code are single strand, there is no practical way to clone single strand sequences into vectors to try and duplicate the combination of oligonucleotides comprising the code. Thus, in contrast to computer based encoding, electronic based authenticating markers, or watermarks which can eventually be duplicated with ever advancing computing capabilities, the code is not easily identified and, therefore, cannot be reproduced without knowing the sequences of the primers.

### Example 6

This example describes various non-limiting specific applications of the bio-code.

Forensic Chain of Evidence Assurance: Forensic samples such as blood and body fluids or tissues that are collected at the scene of a crime or from a suspect using evidence collection kits based upon paper, or treated papers such as FTA™ (Whatman) or IsoCode™ (Schleicher and Schuell). A bar-coded card is used to write down date, time, location, collector and other relevant information so that it stays with the collection card. When analysis of the sample on the collection card (e.g., nucleic acid) is desired, a 1 or 2 mm punch is taken from the portion of the collection card with the forensic sample, e.g., where the sample was collected. The nucleic acid is subsequently identified using commercially available human ID kits such as are provided by Promega and other commercial sources. These kits provide a buffer for washing the cellular debris and proteins from the nucleic acid purifying it for subsequent multiplex PCR for human identification.

A series of 25 different oligonucleotides chosen to avoid sequence commonality with the human genome are used to generate a unique bio-barcode similar to the exemplary illustration (FIGS. 1 and 2) described herein. The unique code at a concentration set to provide a total of 5 ng/cm² is added to the card and allowed to dry. When the forensic sample is analyzed, for example, to ID the human based upon the DNA present, five additional PCR reactions are included to develop the bio-barcode. When the PCR reactions are fractionated via gel electrophoresis, the additional five lanes appear as barcode which is directly linked with the human ID information and with the sample on the original collection card. This method is advantageous because the means to develop the code are the same as that used to analyze the genetic material of the sample. Accordingly, the code directly links the ID of the individual to the information on the card used to collect the sample. Even though a punch might be initially mis-identified by a laboratory technician, all ambiguity is removed as soon as the bar-code of the punched section is developed. An additional feature is that a scan or digital image of the gel with both the nucleic acid sample and the bar-code will contain not only the identification information for the individual but also the direct link to the evidence, ensuring a rigid chain of custody to the location where the forensic sample was collected.

High Value Documents: Paper documents such as commercial paper, bonds, stocks, money, etc. can be ensured to be authentic by implanting upon the paper and valid copies, a unique combination of oligonucleotides providing a barcode. If the validity of the document is in question, a sample of the paper is taken and the code developed, for example, via PCR amplification and subsequent gel electrophoresis. If the barcode is absent or does not match the expected code, then the item is counterfeit. Similarly, by the attachment of a small swatch of paper or fabric to any high value item, authenticity of the item can be ensured.

Again, the use of 25 primer pairs that specifically hybridize to 25 oligonucleotides in a binary (present or not present) code can be use to uniquely identify over 34 million different documents. By using 30 oligonucleotides and six lanes of 5 primer pairs each, the system can be used to uniquely identify over one billion different documents. Cost per document can be as low as a few cents or less if the code material is placed in a specific location on the document such as part of the letterhead or a designated area of the print information on the document. A wax or other seal (organic or inorganic) could also be placed over the code material to protect against possible loss or degradation.

Sample Storage/Archiving: In an automated sample store (i.e., archive), study assembly consists of selecting multiple samples from the archive and assembling them into a daughter plate (typically a lab microplate consists of 100 to 1000 wells, each capable of containing a distinct sample). Clinical samples of this type are typically valued at about $100 each, so mistakes in sample assembly or a mishap during or after sample retrieval resulting in the samples being scrambled would be extremely costly. Although some of this risk can be avoided through careful package and process design (i.e., sample storage, retrieval and tracking), a code for each sample when the sample is introduced into the archive so that the sample can be distinguished from others and traced back to their original source provides additional protection.

One can code every sample that enters the sample store. However, it is not necessary to code every sample. For example, samples can be coded upon retrieval from the store, which is more economical since fewer codes are required and because the coding expense is incurred only for those samples that leave the archive rather than for every sample that enters the archive. In any event, the oligonucleotide code can be added to or mixed with every sample introduced into the store or only those samples that leave the store.

### Example 7

This example describes an exemplary application of a microarray that includes identifier oligonucleotides, which are used to develop the code present in a sample.

Illumina Gene Expression Profiling: A sample having a code is applied to an array in which a portion of the array has identifier oligonucleotides that can be used to specifically hybridize to all oligonucleotides of the code. As an example, an Illumina array could have part of one row or column of the array with identifier oligonucleotides, each at pre-determined positions, to develop the sample code. Alternatively, the array could be set up to use a 5×6 section (30 identifier oligonucleotides) to present the same image as the gel electrophoresis scans (2-D bar-code, see FIG. 1). Since the Illumina system is based upon 50mers, the identifier oligonucleotides can be easily included in the array.

An Illumina Sentrix® Array matrix has 96 array clusters. Each array cluster in each multi-sample platform can query over 700 genes, with two 50-mer probes per gene. The array matrix can be pre-prepared with customer-specified oligonucleotides to identify specific DNA sequences, including the oligonucleotides of the code. DNA samples greater than 50 ng can be directly applied to the array to detect specific hybridization between the sample DNA and the oligonucleotides of the array, and the code oligonucleotides and the identifier oligonucleotides. A positive hybridization signal for a code oligonucleotide would represent a 1 and a lack of response a 0, providing a binary number identifying the code and, therefore, the sample. Where the sample was from a GenVault plate, the binary number would also represent the plate type, plate number and a check code to verify a good read.

More particularly, a sample of nucleic acid containing a bio-tag from an appropriate source, such as a GenVault DNA storage plate, is eluted as purified dsDNA. After preparation, such as concentration of the sample, typically the amount of eluted DNA will be less than 50 ng. The DNA is subsequently amplified using a highly multiplexed PCR process to provide a sufficient quantity of nucleic acid for hybridization and detection. The multiplex PCR includes primer pairs that specifically hybridize to the code oligonucleotides, as well as other DNA sequences of interest. Following PCR, the mixture of amplified sample nucleic acid and code oligonucleotides is cleaned up to remove excess primers and, if necessary, provide a suitable buffer for array hybridization. The amplified mixture is contacted to the array under conditions allowing specific hybridization to occur. Upon development of the array, both the identity of the sample via the unique combination of oligonucleotides in the code and the presence, or absence, of target sequences of interest become readily apparent. A digital record of the developed array and sample identification, which resides on the array, provides a direct link between the identity of the sample and the array data for the sample.

As set forth above, a bio-tag may generally be associated with information regarding the sample identity, source, patient data, etc. By including the bio-tag in the sample itself (i.e., by co-locating the unique combination of oligonucleotides with the sample material), an internal sample identification check is possible prior to, at the time of the “read” process, and later in reviewing a record of array data. Additionally, by reading the bio-tag code associated with the sample, as well as a container barcode or other indicia (for example, associated with a particular sample carrier such as a multi-well plate) into a computer or other processing component and associating the bio-tag with the container or sample carrier code, an irrevocable link between sample identification, patient data, and any other information desired allows any particular sample to be tracked through data linking that sample with a container or sample carrier having a unique code. In some embodiments, for example, a container code such as mentioned above may be represented as a decimal version of the binary bio-tag code associated with a sample, and may be used to link a bio-tagged sample with a particular sample carrier or location thereon for traceability or tracking purposes. Specifically, container information and other data may be encoded in a label bearing a barcode or other indicia substantially as set forth above; such a label may be affixed to the sample carrier, and may also include additional information, for instance, identifying the type of sample carrier, the number of samples remaining, and so forth. Such data may be employed by software or automated apparatus operative to retrieve or otherwise to handle sample carriers and sample material extracted or removed therefrom.

Additionally, a check code may readily be implemented to verify a good read on the bio-tag code for a particular sample. By using, for example, part of an Illumina array for oligonucleotide identifiers of the code, a code may be generated for patient A nucleic acid, a different code may be generated for patient B nucleic acid, and so forth. In the foregoing manner, confirmation may be made of the correctness of the read. In that regard, if a bio-tag read indicates that a sample is from patient A, but the check code indicates otherwise, an error in the read may be the cause for such a discrepancy. Alternatively, where the check code and the bio-tag code are consistent, an accurate read can be confirmed. A check code in this context may be embodied in or comprise a set oligonucleotides (e.g., approximately five oligonucleotides), the presence or absence of which may be a function of the other oligonucleotides that make up the bio-tag. In some embodiments, the bio-tag code and the check code may be combined, for example, or otherwise integrated to serve as a unique identifier for a particular sample.

By way of example, and not by way of limitation, a 5-bit CRC (Cycle Redundancy Check) algorithm may be implemented to determine the check code; CRC's are generally known in the art, and have utility in check code applications for binary data transmission (i.e., sending electronic data). A 5-bit CRC may readily identify false negatives/positives in resolving the code, and are sufficient to identify lane swaps or errors in reading the data out of order; this may be appropriate in instances where a configuration containing 5-bit lanes such as indicated in FIG. 2A is employed. Alternatively, more processor intensive CRC's may be implemented in accordance with generally known principles and in accordance with system hardware configurations and desired system performance.

A personalized code may be employed to identify a given sample with even more particularity or granularity. For example, a personalized or institutional code may be embodied in or comprise any of various other suitable algorithms or identifiers that a particular institution desired to use; in some embodiments, such a personalized code may be used in addition to, or in lieu of, the CRC check code described above. In the foregoing manner, hospitals, clinics, research and other laboratories, or any other entity may use a field for a “personalized code” unique to the particular institution. This would function as an internal check on the accuracy of the identification of the sample as well as a check on “wayward” samples.

Affymetrix GeneChip® Arrays: GeneChip® arrays contain hundreds of thousands of oligonucleotide probes at extremely high densities. The probes allow discrimination between specific and background signals, and between closely related target sequences. GeneChip® arrays, which have been used for a wide variety of DNA and mRNA analyses, can include identifier oligonucleotides in accordance with the invention in order to identify a code present in a sample.

A sample of purified dsDNA, containing an oligonucleotide sequence code is prepared via a modified Affymetrix protocol, and applied to the GeneChip®. Optionally, PCR of the sample using biotinylated nucleic acids can be performed to increase the amount of DNA or the amount of code oligonucleotides present in the sample. As in the Illumina example, the coded sample is applied to the GeneChip®. The absence or presence of a code oligonucleotide in the sample is determined by the absence or presence of a detectable signal at the specific position on the GeneChip® having the identifier oligonucleotide that specifically hybridizes to the code oligonucleotide. Simultaneous conventional nucleic acid hybridization between the sample and the oligonucleotide probes of the GeneChip® array detects the presence of selected SNPs or heterozygous sequence changes in the dsDNA sample.

### Example 8

As an alternative to a microarray, beads can be used as the addressable array. For example, Luminex microspheres provide a suitable array for use in decoding samples coded according to the methods of the invention. This example describes an exemplary code using 25 coding oligonucleotides, each comprising a unique Identifier sequence and a common Detection sequence, wherein the Identifier and Detection sequences are selected from the Luminex FlexMAP (aka, xTAG) sequences. In this example all coding oligonucleotides are 60 bases long. They have a common 5′ leader and 3′ trailing sequences. Furthermore, the identifier and detection sequences are not separated by a linker region.

18 different combinations of coding oligonucleotides were assembled in duplicate mixes from a predetermined pool of 25 coding oligonucleotides and the resulting code determined by means of hybridization to a set of 25 xMAP beads, each coupled to a different identifier oligonucleotide complementary to the identifier sequence present on the 25 coding oligonucleotides. Hybridization was performed under the conditions described in the Luminex protocol: Sample Protocol for Hybridization to FlexMAP (xTAG) Universal Array Microspheres Washed Assay Format. See also U.S. Pat. No. 7,226,737 (Pankcoska et al.). Hybridization detection was performed as illustrated in FIG. 12B with the Detection oligonucleotide being biotinylated. The sequence of the relevant oligonucleotides was as follows:

Coding oligonucleotide 1

(SEQ ID NO: 63)

5′ TCCATCTCCACTTTATCAATACATACTACAATCACTATCTTTAAACT
ACAAATCTAACAA-3′
Coding oligonucleotide 2

(SEQ ID NO: 64)

5′ TCCATCTCCATACACTTTATCAAATCTTACAATCCTATCTTTAAACT
ACAAATCTAACAA-3′
Coding oligonucleotide 3

(SEQ ID NO: 65)

5′ TCCATCTCCATACATTACCAATAATCTTCAAATCCTATCTTTAAACT
ACAAATCTAACAA-3′
Coding oligonucleotide 4

(SEQ ID NO: 66)

5′ TCCATCTCCATCAACAATCTTTTACAATCAAATCCTATCTTTAAACT
ACAAATCTAACAA-3′
Coding oligonucleotide 5

(SEQ ID NO: 67)

5′ TCCATCTCCACAATTCATTTACCAATTTACCAATCTATCTTTAAACT
ACAAATCTAACAA-3′
Coding oligonucleotide 6

(SEQ ID NO: 68)

5′ TCCATCTCCAAATCCTTTTACATTCATTACTTACCTATCTTTAAACT
ACAAATCTAACAA-3′
Coding oligonucleotide 7

(SEQ ID NO: 69)

5′ TCCATCTCCATAATCTTCTATATCAACATCTTACCTATCTTTAAACT
ACAAATCTAACAA-3′
Coding oligonucleotide 8

(SEQ ID NO: 70)

5′ TCCATCTCCAATCATACATACATACAAATCTACACTATCTTTAAACT
ACAAATCTAACAA-3′
Coding oligonucleotide 9

(SEQ ID NO: 71)

5′ TCCATCTCCACAATAAACTATACTTCTTCACTAACTATCTTTAAACT
ACAAATCTAACAA-3′
Coding oligonucleotide 10

(SEQ ID NO: 72)

5′ TCCATCTCCACTACTATACATCTTACTATACTTTCTATCTTTAAACT
ACAAATCTAACAA-3′
Coding oligonucleotide 11

(SEQ ID NO: 73)

5′ TCCATCTCCAATACTTCATTCATTCATCAATTCACTATCTTTAAACT
ACAAATCTAACAA-3′
Coding oligonucleotide 12

(SEQ ID NO: 74)

5′ TCCATCTCCACTTTAATCCTTTATCACTTTATCACTATCTTTAAACT
ACAAATCTAACAA-3′
Coding oligonucleotide 13

(SEQ ID NO: 75)

5′ TCCATCTCCATCAAAATCTCAAATACTCAAATCACTATCTTTAAACT
ACAAATCTAACAA-3′
Coding oligonucleotide 14

(SEQ ID NO: 76)

5′ TCCATCTCCATCAATCAATTACTTACTCAAATACCTATCTTTAAACT
ACAAATCTAACAA-3′
Coding oligonucleotide 15

(SEQ ID NO: 77)

5′ TCCATCTCCACTTTTACAATACTTCAATACAATCCTATCTTTAAACT
ACAAATCTAACAA-3′
Coding oligonucleotide 16

(SEQ ID NO: 78)

5′ TCCATCTCCAAATCCTTTCTTTAATCTCAAATCACTATCTTTAAACT
ACAAATCTAACAA-3′
Coding oligonucleotide 17

(SEQ ID NO: 79)

5′ TCCATCTCCAAATCCTTTTTACTCAATTCAATCACTATCTTTAAACT
ACAAATCTAACAA-3′
Coding oligonucleotide 18

(SEQ ID NO: 80)

5′ TCCATCTCCACTTTTCAATTACTTCAAATCTTCACTATCTTTAAACT
ACAAATCTAACAA-3′
Coding oligonucleotide 19

(SEQ ID NO: 81)

5′ TCCATCTCCACTACAAACAAACAAACATTATCAACTATCTTTAAACT
ACAAATCTAACAA-3′
Coding oligonucleotide 21

(SEQ ID NO: 82)

5′ TCCATCTCCATACACAATCTTTTCATTACATCATCTATCTTTAAACT
ACAAATCTAACAA-3′
Coding oligonucleotide 22

(SEQ ID NO: 83)

5′ TCCATCTCCATACATCAACAATTCATTCAATACACTATCTTTAAACT
ACAAATCTAACAA-3′
Coding oligonucleotide 23

(SEQ ID NO: 84)

5′ TCCATCTCCATCATCAATCTTTCAATTTACTTACCTATCTTTAAACT
ACAAATCTAACAA-3′
Coding oligonucleotide 24

(SEQ ID NO: 85)

5′ TCCATCTCCACAATATACCAATATCATCATTTACCTATCTTTAAACT
ACAAATCTAACAA-3′
Coding oligonucleotide 25

(SEQ ID NO: 86)

5′ TCCATCTCCATCATTTCAATCAATCATCAACAATCTATCTTTAAACT
ACAAATCTAACAA-3′
Coding oligonucleotide 26

(SEQ ID NO: 87)

5′ TCCATCTCCACTACTTCATATACTTTATACTACACTATCTTTAAACT
ACAAATCTAACAA-3′
Identifier oligonucleotide 1

(SEQ ID NO: 88)

5′ TGATTGTAGTATGTATTGATAAAG-3′
Identifier oligonucleotide 2

(SEQ ID NO: 89)

5′ GATTGTAAGATTTGATAAAGTGTA-3′
Identifier oligonucleotide 3

(SEQ ID NO: 90)

5′ GATTTGAAGATTATTGGTAATGTA-3′
Identifier oligonucleotide 4

(SEQ ID NO: 91)

5′ GATTTGATTGTAAAAGATTGTTGA-3′
Identifier oligonucleotide 5

(SEQ ID NO: 92)

5′ ATTGGTAAATTGGTAAATGAATTG-3′
Identifier oligonucleotide 6

(SEQ ID NO: 93)

5′ GTAAGTAATGAATGTAAAAGGATT-3′
Identifier oligonucleotide 7

(SEQ ID NO: 94)

5′ GTAAGATGTTGATATAGAAGATTA-3′
Identifier oligonucleotide 8

(SEQ ID NO: 95)

5′ TGTAGATTTGTATGTATGTATGAT-3′
Identifier oligonucleotide 9

(SEQ ID NO: 96)

5′ TTAGTGAAGAAGTATAGTTTATTG-3′
Identifier oligonucleotide 10

(SEQ ID NO: 97)

5′ AAAGTATAGTAAGATGTATAGTAG-3′
Identifier oligonucleotide 11

(SEQ ID NO: 98)

5′ TGAATTGATGAATGAATGAAGTAT-3′
Identifier oligonucleotide 12

(SEQ ID NO: 99)

5′ TGATAAAGTGATAAAGGATTAAAG-3′
Identifier oligonucleotide 13

(SEQ ID NO: 100)

5′ TGATTTGAGTATTTGAGATTTTGA-3′
Identifier oligonucleotide 14

(SEQ ID NO: 101)

5′ GTATTTGAGTAAGTAATTGATTGA-3′
Identifier oligonucleotide 15

(SEQ ID NO: 102)

5′ GATTGTATTGAAGTATTGTAAAAG-3′
Identifier oligonucleotide 16

(SEQ ID NO: 103)

5′ TGATTTGAGATTAAAGAAAGGATT-3′
Identifier oligonucleotide 17

(SEQ ID NO: 104)

5′ TGATTGAATTGAGTAAAAAGGATT-3′
Identifier oligonucleotide 18

(SEQ ID NO: 105)

5′ TGAAGATTTGAAGTAATTGAAAAG-3′
Identifier oligonucleotide 19

(SEQ ID NO: 106)

5′ TTGATAATGTTTGTTTGTTTGTAG-3′
Identifier oligonucleotide 21

(SEQ ID NO: 107)

5′ ATGATGTAATGAAAAGATTGTGTA-3′
Identifier oligonucleotide 22

(SEQ ID NO: 108)

5′ TGTATTGAATGAATTGTTGATGTA-3′
Identifier oligonucleotide 23

(SEQ ID NO: 109)

5′ GTAAGTAAATTGAAAGATTGATGA-3′
Identifier oligonucleotide 24

(SEQ ID NO: 110)

5′ GTAAATGATGATATTGGTATATTG-3′
Identifier oligonucleotide 25

(SEQ ID NO: 111)

5′ ATTGTTGATGATTGATTGAAATGA-3′
Identifier oligonucleotide 26

(SEQ ID NO: 112)

5′ TGTAGTATAAAGTATATGAAGTAG-3′
Detection oligonucleotide

(SEQ ID NO: 113)

5′ Biotin-GTTAGATTTGTAGTTTAAAGATAG-3′

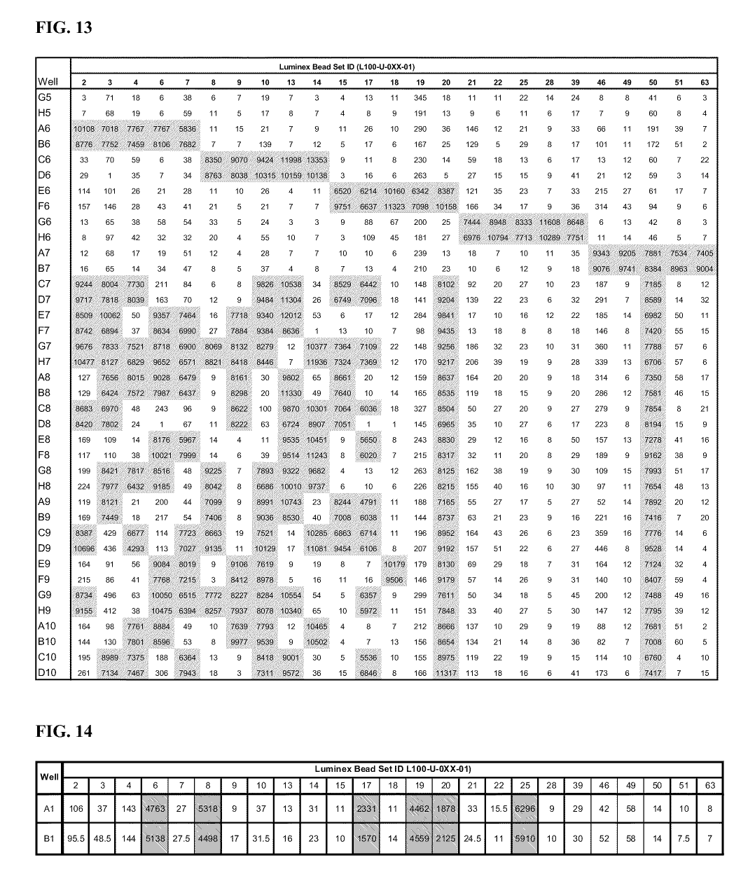

The results of FIG. 13 demonstrate successful decoding of the various coding oligonucleotide combinations. In all cases the presence of the appropriate coding oligonucleotides is indicated by high fluorescent signals (shaded data points in FIG. 13). Coding oligonucleotides that are supposed to be missing are marked by background fluorescence. The same coding oligonucleotide pattern is observed for each duplicate mix analyzed (wells: A6,B6; C6,D6; E6,F6; G6,H6; A7,B7; C7,D7, etc.).

### Example 9

This example describes an exemplary code using sandwich hybridization for capture and detection as illustrated in FIG. 12D. Duplicate mixes of 6 coding oligonucleotides are hybridized to the set of 25 xMAP beads, described above, in the presence of the appropriate sandwich oligonucleotides and a biotinylated labeling oligonucleotide (SEQ ID NO:113). Hybridization detection was done as described above. The sequence of the relevant oligonucleotides was as follows (Coding oligonucleotide 1 is SEQ ID NO:18, Coding oligonucleotide 2 is SEQ ID NO:24, and the labeling oligonucleotide is SEQ ID NO:113):

Coding oligonucleotide 3

(SEQ ID NO: 114)

5′ TGATGCCCCTCTGCTAGAATATAACATCAACGGTACTCATCAAGAGG
ACGATGTTGTCA-3′
Coding oligonucleotide 4

(SEQ ID NO: 115)

5′ TTGATGCTGACGACCTTGAGAGACGGATGTGGAAAGATCGTGTCAGG
CTTAAAAGAATCAAAGAGCGACAAAAAGCTGG-3′
Coding oligonucleotide 5

(SEQ ID NO: 116)

5′ GTGAAACTCGGTCTGCCTAAAAGCCAGAGTCCTCCTTACCGAAAACC
TCATGATCTCAAGAAGATGTGGAAGGTTGGAGTTTTAACGGC-3′
Coding oligonucleotide 6

(SEQ ID NO: 117)

5′ ACTTTGGATGACGGGATTTGCAGTTCAGGCTTTACTAGCAAGTGATC
CACGCGATGAAACCTATGACGTGC-3′
Identifier oligonucleotide 1

(SEQ ID NO 118)

5′ TCAACAATCTTTTACAATCAAATCGAACGTTGGGATCTTGCTGT-3′
Identifier oligonucleotide 2

(SEQ ID NO 119)

5′ AATCCTTTTACATTCATTACTTACATGTTCAACAGGTGGGGAAA-3′
Identifier oligonucleotide 3

(SEQ ID NO 120)

5′ CTTTAATCCTTTATCACTTTATCATCGACAACATCGTCCTCTTG-3′
Identifier oligonucleotide 4

(SEQ ID NO 121)

5′ TCAATCAATTACTTACTCAAATACCCAGCTTTTTGTCGCTCTTT-3′
Identifier oligonucleotide 5

(SEQ ID NO 122)

5′ CTTTTACAATACTTCAATACAATCTGCCGTTAAAACTCCAACCT-3′
Identifier oligonucleotide 6

(SEQ ID NO 123)

5′ CTTTTCAATTACTTCAAATCTTCAGCACGTCATAGGTTTCATCG-3′
Detection oligonucleotide 1

(SEQ ID NO 124)

5′ TCCGTTCTTTCAGCTCAGGATctcctCTATCTTTAAACTACAAATCT
AACAA-3′
Detection oligonucleotide 2

(SEQ ID NO 125)

5′ AGTCTCCTCGACTACTCGGTctcctCTATCTTTAAACTACAAATCTA
ACAA-3′
Detection oligonucleotide 3

(SEQ ID NO 126)

5′ ATGAGTACCGTTGATGTTATATTctcctCTATCTTTAAACTACAAAT
CTAACAA-3′
Detection oligonucleotide 4

(SEQ ID NO 127)

5′ GATTCTTTTAAGCCTGACACGctcctCTATCTTTAAACTACAAATCT
AACAA-3′
Detection oligonucleotide 5

(SEQ ID NO 128)

5′ TCCACATCTTCTTGAGATCATGctcctCTATCTTTAAACTACAAATC
TAACAA-3′
Detection oligonucleotide 6

(SEQ ID NO 129)

5′ CGTGGATCACTTGCTAGTAAActcctCTATCTTTAAACTACAAATCT
AACAA-3′

The results of FIG. 14 demonstrate successful decoding of the duplicate oligo mixes using sandwich hybridization for capture and detection. Positive signals are observed for coding oligonucleotides included in the mix (shaded data points in FIG. 14). All other coding oligonucleotides produced background signals.

What is claimed:

1. A coded storage package comprising:
a container containing a subset of coding oligonucleotides from a predetermined pool of coding oligonucleotides, and
an identifying indicia attached to said container
wherein the coding oligonucleotides of said pool each comprise a unique identifier sequence, wherein the combination of oligonucleotides represents the presence and absence of oligonucleotides from said pool and such representation constitutes a code, and wherein said identifying indicia identifies the code represented by said subset of coding oligonucleotides.

2. The coded storage package of claim 1, wherein each coding oligonucleotide of said subset has a non-naturally occurring sequence.

3. The coded storage package of claim 1, wherein each coding oligonucleotide of said subset comprises one or more modified bases.

4. The coded storage package of claim 1, wherein said subset of coding oligonucleotides comprises 2, 3, 4, 5 or more coding oligonucleotides from said pool.

5. The coded storage package of claim 1, wherein each coding oligonucleotide of said subset comprises a detection sequence.

6. The coded storage package of claim 1, wherein each coding oligonucleotide of said subset comprises a 5′ leader sequence, wherein said leader sequence is not part of an identifier sequence or a detection sequence.

7. The coded storage package of claim 1, wherein each coding oligonucleotide of said subset comprises a detection sequence and a 5′ leader sequence.

8. The coded storage package of claim 1, wherein each coding oligonucleotide of said subset is 40 to 70 bases long.

9. The coded storage package of claim 1, wherein each coding oligonucleotide of said subset is labeled.

10. The coded storage package of claim 1, further comprising a plurality of said containers.

11. The coded storage package of claim 10, wherein the plurality of said containers are wells in a multi-well plate.

12. The coded storage package of claim 10, wherein each container of said plurality has the same code.

13. The coded storage package of claim 10, wherein the plurality of said containers is divided into 2, 3, 4, 5, 6 or more groups, and wherein each container in the same group has the same code.

14. The coded storage package of claim 1, wherein said container comprises a sample node, and wherein said sample node carries said subset of coding oligonucleotides.

15. The coded storage package of claim 14, wherein said sample node comprises a sample support medium, and wherein said sample support medium carries said subset of coding oligonucleotides.

16. The coded storage package of claim 14, wherein said sample node comprises a porous material.

17. The coded storage package of claim 14, wherein said sample node comprises cellulose or an elastomeric foam.

18. The coded storage package of claim 1, further comprising a biological sample.

19. The coded storage package of claim 18, wherein each coding oligonucleotide of said subset is incapable of specifically hybridizing to said biological sample or to pathogens associated with said biological sample.

20. An archive of biological samples, wherein each sample is stored in a container of claim 1.

21. A method for coding a sample comprising adding said sample to a container of claim 1.

22. A method for coding a sample comprising:
adding a subset of coding oligonucleotides to said sample,
wherein said subset is from a predetermined pool of coding oligonucleotides, wherein the coding oligonucleotides of said pool are different from each other, and wherein the combination of oligonucleotides represents the presence and absence of oligonucleotides from said pool and such representation constitutes a code.

23. The method of claim 22, further comprising selecting said subset of coding oligonucleotides from said predetermined pool of coding oligonucleotides prior to said adding.

24. A coded sample made according to the method of claim 22.

25. A method of decoding a coded sample, wherein the code comprises a subset of coding oligonucleotides from a predetermined pool of coding oligonucleotides, and wherein the coding oligonucleotides of said pool are different from each other, the method comprising:
detecting one or more coding oligonucleotides of said pool in said sample,
wherein a collective result of the presence and absence of said one or more oligonucleotides of said pool in said sample is indicative of a code associated with said sample.

26. The method of claim 25, comprising detecting the presence and absence of each coding oligonucleotide of said pool in said sample.

27. The method of claim 25, further comprising determining the code of said coded sample based upon said detecting.

28. The method of claim 25, wherein said detecting comprises contacting each of said one or more coding oligonucleotides with an identifier oligonucleotide corresponding to each coding oligonucleotide of said pool, wherein each identifier oligonucleotide is bound to an addressable array.

29. The method of claim 25, wherein said detecting comprises contacting each of said one or more coding oligonucleotides with a detection oligonucleotide, and an identifier oligonucleotide corresponding to each coding oligonucleotide of said pool, wherein each identifier oligonucleotide is bound to an addressable array.

30. The method of claim 25, wherein said detecting comprises contacting each of said one or more coding oligonucleotides with an identifier oligonucleotide corresponding to each coding oligonucleotide of said pool, wherein each identifier oligonucleotide is indirectly bound to an addressable array.

31. The method of claim 25, wherein said detecting comprises contacting each of said one or more coding oligonucleotides with a detection oligonucleotide and an identifier oligonucleotide corresponding to each coding oligonucleotide of said pool, wherein each identifier oligonucleotide is indirectly bound to an addressable array.

32. The method of claim 25, wherein said detecting comprises contacting each of said one or more coding oligonucleotides with a detection oligonucleotide, a labeling oligonucleotide, and an identifier oligonucleotide corresponding to each coding oligonucleotide of said predetermined pool, wherein each identifier oligonucleotide is indirectly bound to an addressable array, and wherein each detection oligonucleotide is bound to a labeling oligonucleotide.

33. The method of claim 25, wherein said detecting comprising detecting a label incorporated into each of said one or more coding oligonucleotides.

34. The method of claim 29, wherein said detecting comprises detecting a label associated with said detection oligonucleotide.

35. The method of claim 31, wherein said detecting comprises detecting a label associated with said detection oligonucleotide.

36. The method of claim 32, wherein said detecting comprises detecting a label associated with said detection oligonucleotide.

37. A kit comprising:
a container containing a substrate for biological molecule storage and a subset of coding oligonucleotides from a predetermined pool of coding oligonucleotides, wherein the oligonucleotides of said pool are different from each other, and wherein the combination of oligonucleotides represents the presence and absence of oligonucleotides from said pool and such representation constitutes a code.

38. The kit of claim 37, further comprising identifying indicia, wherein said identifying indicia identifies the code represented by said subset of coding oligonucleotides.

39. The kit of claim 37, further comprising a set of identifier oligonucleotides, wherein said set of identifier oligonucleotides can be used to decode the code contained in said container.

40. The kit of claim 37, further comprising a set of identifier oligonucleotides and a corresponding set of secondary identifier oligonucleotides, wherein said set of identifier oligonucleotides and said set of corresponding secondary identifier oligonucleotides can be used to decode the code contained in said container.

41. The kit of claim 37, further comprising a set of identifier oligonucleotides and at least one detection oligonucleotide, wherein said set of identifier oligonucleotides and said at least one detection oligonucleotide can be used to decode the code contained in said container.

42. The kit of claim 37, further comprising a set of identifier oligonucleotides, a set of corresponding secondary identifier oligonucleotides and at least one detection oligonucleotide, wherein said set of identifier oligonucleotides, said set of secondary identifier oligonucleotides and said at least one detection oligonucleotide can be used to decode the code contained in said container.

43. The kit of claim 37, further comprising a set of identifier oligonucleotides, a set of corresponding secondary identifier oligonucleotides, at least one detection oligonucleotide and corresponding signaling oligonucleotides, wherein said set of identifier oligonucleotides, said set of secondary identifier oligonucleotides, said at least one detection oligonucleotide and corresponding labeling oligonucleotides can be used to decode the code contained in said container.

44. The kit of claim 37, wherein said substrate is suitable for long-term storage of biological molecules.
